(19) United States
(12) Patent Application Publication
(10) Pub. No.: US 2026/0179964 A1
(43) Pub. Date: Jun. 25, 2026

(54) CURRENT COLLECTOR ASSEMBLY AND SECONDARY BATTERY

(71) Applicants: MURATA MANUFACTURING CO., LTD., Kyoto (JP); THE BOARD OF TRUSTEES OF THE LELAND STANFORD JUNIOR UNIVERSITY, Stanford, CA (US)

(72) Inventors: Yi CUI, Redwood City, CA (US); Yusheng YE, Redwood City, CA (US); Yuri NAKAYAMA, Kyoto (JP); Yasuyuki MASUDA, Kyoto (JP); Takahiro YUUKI, Kyoto (JP)

(21) Appl. No.: 19/542,334

(22) Filed: Feb. 17, 2026

Related U.S. Application Data
(63) Continuation of application No. PCT/JP2024/028796, filed on Aug. 9, 2024.
(60) Provisional application No. 63/533,319, filed on Aug. 17, 2023.

(51) Int. Cl. H01M 4/66; H01M 4/02; H01M 4/04; H01M 4/80; H01M 50/586

(52) U.S. Cl. CPC H01M 4/66; H01M 4/0404; H01M 4/80; H01M 50/586; H01M 2004/021

(57) ABSTRACT

A current collector assembly includes an insulating substrate having a first main surface and a second main surface on the opposite side to the first main surface, a cathode current collector provided on the first main surface, and an anode current collector provided on the second main surface, in which the insulating substrate, the cathode current collector, and the anode current collector are porous bodies.

### CROSS-REFERENCE TO RELATED APPLICATION(S)

This present application is a continuation of PCT patent application no. PCT/JP2024/028796, filed on Aug. 9, 2024, which claims priority to U.S. Patent No. 63/533,319 filed on Aug. 17, 2023, the entire contents of which are incorporated herein by reference.

### BACKGROUND

The present disclosure relates to a current collector assembly and a secondary battery.

It is disclosed that thickening an electrode of a secondary battery increases the active material ratio in the battery, whereby the battery capacity and the energy density can be improved.

It is disclosed that thickening an electrode of a secondary battery makes the diffusion distance of carrier ions longer, which makes it difficult to cause a large current to flow.

As a result, there is a possibility that the capacity at a high rate with a large current decreases.

### SUMMARY

The present disclosure relates to a current collector assembly and a secondary battery.

According to the present disclosure in an embodiment, a current collector assembly including: an insulating film having a first main surface and a second main surface on an opposite side to the first main surface; a cathode current collector provided on the first main surface; and an anode current collector provided on the second main surface, wherein the insulating film, the cathode current collector, and the anode current collector are porous bodies.

According to the present disclosure in an embodiment, a secondary battery is provided.

The secondary battery including: an insulating film having a first main surface and a second main surface on an opposite side to the first main surface; a cathode provided on the first main surface; and an anode provided on the second main surface, wherein the cathode includes a cathode current collector and a cathode active material layer, the anode includes an anode current collector and an anode active material layer, the insulating film is a porous body, and the cathode current collector and the anode current collector are porous bodies or porous plates.

### BRIEF DESCRIPTION OF THE FIGURES

FIG. 1 is a cross-sectional view illustrating an example of a secondary battery according to an embodiment;

FIG. 2 is an enlarged cross-sectional view illustrating a part of a cross section of an electrode body in FIG. 1;

FIG. 3 is an enlarged cross-sectional view illustrating a current collector assembly in FIG. 2;

FIG. 4 is a diagram illustrating manufacturing steps of the current collector assembly according to an embodiment;

FIG. 5 is an enlarged cross-sectional view illustrating a part of a cross section of an electrode body of a secondary battery according to Comparative Example 1;

FIG. 6 is a graph illustrating transition of the area capacity of secondary batteries of Comparative Example 1 and Example 1;

FIG. 7 is a graph illustrating the capacity with respect to the rate of the secondary batteries of Comparative Example 1 and Example 1;

FIG. 8A is a graph illustrating charge and discharge curves of the secondary battery of Comparative Example 1;

FIG. 8B is a graph illustrating charge and discharge curves of the secondary battery of Example 1;

FIG. 9 is a cross-sectional view illustrating an example of an electrode body of a secondary battery according to an embodiment;

FIG. 10 is an enlarged view of a cathode current collector according to an embodiment;

FIG. 11 is a cross-sectional view illustrating an example of an electrode body of a secondary battery according to an embodiment;

FIG. 12 is a cross-sectional view illustrating an example of an electrode body of the secondary battery according to an embodiment;

FIG. 13 is a diagram illustrating a cathode current collector according to Example 4;

FIG. 14 is a diagram illustrating an anode current collector according to Example 4;

FIG. 15 is a graph illustrating the result of a first charge and discharge test according to Example 2;

FIG. 16 is a graph illustrating the result of a second charge and discharge test according to Example 2 and Example 3;

FIG. 17 is a graph illustrating the result of a third charge and discharge test according to Example 4;

FIG. 18A is a diagram illustrating the design principle of a porous current collector in a battery;

FIG. 18B is a diagram illustrating the design principle of the porous current collector in the battery;

FIG. 18C is a diagram illustrating the design principle of the porous current collector in the battery;

FIG. 19A is a diagram illustrating numerical simulation results of batteries each having one of TCC and PCC;

FIG. 19B is a diagram illustrating numerical simulation results of the batteries each having one of TCC and PCC;

FIG. 19C is a diagram illustrating numerical simulation results of the batteries each having one of TCC and PCC;

FIG. 19D is a diagram illustrating numerical simulation results of the batteries each having one of TCC and PCC;

FIG. 19E is a graph illustrating numerical simulation results of the batteries each having one of TCC and PCC;

FIG. 19F is a graph illustrating numerical simulation results of the batteries each having one of TCC and PCC;

FIG. 19G is a graph illustrating numerical simulation results of the batteries each having one of TCC and PCC;

FIG. 19H is a graph illustrating numerical simulation results of the batteries each having one of TCC and PCC;

FIG. 20A is a diagram illustrating the main design concept of PCC and characteristics thereof;

FIG. 20B is a diagram illustrating the main design concept of PCC and characteristics thereof;

FIG. 20C is a diagram illustrating the main design concept of PCC and characteristics thereof;

FIG. 20D is a diagram illustrating the main design concept of PCC and characteristics thereof;

FIG. 20E is a diagram illustrating the main design concept of PCC and characteristics thereof;

FIG. 20F is a diagram illustrating the main design concept of PCC and characteristics thereof;

FIG. 20G is a diagram illustrating the main design concept of PCC and characteristics thereof;

FIG. 20H is a diagram illustrating the main design concept of PCC and characteristics thereof;

FIG. 20I is a graph illustrating the main design concept of PCC and characteristics thereof;

FIG. 20J is a graph illustrating the main design concept of PCC and characteristics thereof;

FIG. 21A is a graph illustrating electrochemical performance of multilayer pouch batteries each having one of TCC and PCC;

FIG. 21B is a graph illustrating electrochemical performance of the multilayer pouch batteries each having one of TCC and PCC;

FIG. 21C is a graph illustrating electrochemical performance of the multilayer pouch batteries each having one of TCC and PCC;

FIG. 21D is a graph illustrating electrochemical performance of the multilayer pouch batteries each having one of TCC and PCC;

FIG. 21E is a graph illustrating electrochemical performance of the multilayer pouch batteries each having one of TCC and PCC;

FIG. 21F is a graph illustrating electrochemical performance of the multilayer pouch batteries each having one of TCC and PCC;

FIG. 21G is a graph illustrating electrochemical performance of the multilayer pouch batteries each having one of TCC and PCC;

FIG. 22A is a diagram illustrating differential pressure sensing indicating deposition of Li⁰ during quick charging;

FIG. 22B is a diagram illustrating differential pressure sensing indicating deposition of Li⁰ during quick charging;

FIG. 22C is a diagram illustrating differential pressure sensing indicating deposition of Li⁰ during quick charging;

FIG. 22D is a diagram illustrating differential pressure sensing indicating deposition of Li⁰ during quick charging;

FIG. 22E is a diagram illustrating differential pressure sensing indicating deposition of Li⁰ during quick charging;

FIG. 22F is a diagram illustrating differential pressure sensing indicating deposition of Li⁰ during quick charging;

FIG. 22G is a diagram illustrating differential pressure sensing indicating deposition of Li⁰ during quick charging;

FIG. 23A is a diagram illustrating lithium concentration distribution of NMC|graphite multilayer pouch batteries including TCC at a high NMC areal loading of 3 mAh/cm² and an N/P ratio of 1.1;

FIG. 23B is a diagram illustrating lithium concentration distribution of NMC|graphite multilayer pouch batteries including PCC at the high NMC areal loading of 3 mAh/cm² and the N/P ratio of 1.1;

FIG. 24A is a diagram illustrating lithium concentration distribution of NMC|graphite multilayer pouch batteries including TCC at a high NMC areal loading of 9 mAh/cm² and the N/P ratio of 1.1;

FIG. 24B is a diagram illustrating lithium concentration distribution of NMC|graphite multilayer pouch batteries including PCC at the high NMC areal loading of 9 mAh/cm² and the N/P ratio of 1.1;

FIG. 25A is a diagram illustrating spatial distribution of the graphite anode potential by TCC at a charge rate of 4 C (15 minutes charge);

FIG. 25B is a diagram illustrating spatial distribution of the graphite anode potential by PCC at the charge rate of 4 C (15 minutes charge);

FIG. 26A is a diagram explaining electrochemical stability of a porous Kevlar (registered trademark) film in a battery;

FIG. 26B is a graph explaining electrochemical stability of the porous Kevlar (registered trademark) film in a battery;

FIG. 27A is a diagram illustrating an SEM image of a Celgard 2500 separator before being coated with Cu metal;

FIG. 27B is a diagram illustrating an SEM image of a Celgard 2500 separator after being coated with Cu metal;

FIG. 28A is a diagram illustrating a cross-sectional SEM image of PCC at a low magnification;

FIG. 28B is a diagram illustrating a cross-sectional SEM image of PCC at a high magnification;

FIG. 29A is a graph illustrating lithium distribution in a PCC cell at different porosities;

FIG. 29B is a graph illustrating lithium distribution in a PCC cell at different porosities;

FIG. 29C is a graph illustrating lithium distribution in a PCC cell at different porosities;

FIG. 29D is a graph illustrating lithium distribution in a PCC cell at different porosities;

FIG. 30 is a diagram illustrating mechanical performance of PCC tested with Instron 5565;

FIG. 31A is a diagram for explaining a four point probe method for measuring electron conductivity of TCC and PCC;

FIG. 31B is a diagram for explaining the four point probe method for measuring the electron conductivity of TCC;

FIG. 31C is a diagram for explaining the four point probe method for measuring the electron conductivity of PCC;

FIG. 32A is a diagram for explaining batteries having different tab structures and their current collector resistances;

FIG. 32B is a diagram for explaining batteries having different tab structures and their current collector resistances;

FIG. 32C is a diagram for explaining batteries having different tab structures and their current collector resistances;

FIG. 33 is a diagram for explaining the arrangement in a blocking cell for an ion conductivity test;

FIG. 34 is a diagram illustrating the wettability of PCC with an electrolytic solution as compared with the wettability of Celgard 2325 by contact angle measurement;

FIG. 35A is a diagram illustrating alternative manufacturing of a three-layer polymer matrix as a candidate for a PCC host;

FIG. 35B is a diagram illustrating alternative manufacturing of a three-layer polymer matrix as a candidate for the PCC host;

FIG. 35C is a diagram illustrating alternative manufacturing of a three-layer polymer matrix as a candidate for the PCC host;

FIG. 35D is a diagram illustrating alternative manufacturing of a three-layer polymer matrix as a candidate for the PCC host;

FIG. 35E is a diagram illustrating alternative manufacturing of a three-layer polymer matrix as a candidate for the PCC host;

FIG. 36 is a diagram illustrating stability of thick electrodes each using one of carbon black and a separated Tuball carbon nanotube mesh structure as a conductive additive;

FIG. 37A is a diagram illustrating preparation of an electrode using a Tuball carbon nanotube;

FIG. 37B is a diagram illustrating preparation of an electrode using the Tuball carbon nanotube;

FIG. 37C is a diagram illustrating preparation of an electrode using the Tuball carbon nanotube;

FIG. 37D is a diagram illustrating preparation of an electrode using the Tuball carbon nanotube;

FIG. 37E is a diagram illustrating preparation of an electrode using the Tuball carbon nanotube;

FIG. 37F is a diagram illustrating preparation of an electrode using the Tuball carbon nanotube;

FIG. 38 is a diagram illustrating calendaring and alignment of an electrode to PCC;

FIG. 39A is a diagram illustrating differential pressure sensing indicating Li⁰ deposition during quick charging of TCC;

FIG. 39B is a diagram illustrating differential pressure sensing indicating Li⁰ deposition during quick charging of TCC;

FIG. 39C is a diagram illustrating differential pressure sensing indicating Li⁰ deposition during quick charging of TCC;

FIG. 40A is a graph illustrating the dP/|dQ| curve of a pouch battery having PCC at 4 C;

FIG. 40B is a graph illustrating the dP/|dQ| curve of a pouch battery having PCC at 5 C;

FIG. 40C is a graph illustrating the dP/| dQ| curve of a pouch battery having PCC at 10 C;

FIG. 41A is a graph illustrating electrochemical performance of batteries each having one of PCC and TCC;

FIG. 41B is a graph illustrating electrochemical performance of batteries each having one of PCC and TCC;

FIG. 42A is a diagram illustrating a TCC cell configuration;

FIG. 42B is a diagram for explaining the PCC cell configuration in a case where a separator is included;

FIG. 42C is a diagram for explaining the PCC cell configuration without a separator;

FIG. 42D is a graph for explaining that the PCC cell configuration without a separator has an effect of lowering the PCC current density;

FIG. 43A is a diagram illustrating the configuration of a multilayer pouch cell including TCC;

FIG. 43B is a diagram illustrating the configuration of a multilayer pouch cell including PCC;

FIG. 44A is a diagram illustrating manufacturing of a proof-of-concept PCC prepared by UV laser cutting;

FIG. 44B is a diagram illustrating a proof-of-concept PCC prepared by UV laser cutting;

FIG. 44C is a diagram illustrating a proof-of-concept PCC prepared by UV laser cutting;

FIG. 44D is a diagram illustrating a proof-of-concept PCC prepared by UV laser cutting;

FIG. 44E is a diagram illustrating a proof-of-concept PCC prepared by UV laser cutting;

FIG. 44F is a graph illustrating the performance of a proof-of-concept PCC prepared by UV laser cutting;

FIG. 44G is a graph illustrating performance of a proof-of-concept PCC prepared by UV laser cutting;

FIG. 45A is a diagram illustrating a porous stainless-steel (SS) mesh;

FIG. 45B is a diagram illustrating a porous stainless-steel (SS) mesh;

FIG. 45C is a diagram illustrating a porous copper (Cu) mesh;

FIG. 45D is a diagram illustrating a porous copper (Cu) mesh;

FIG. 45E is a diagram illustrating a PCC design with a porous stainless-steel (SS) mesh and a porous copper (Cu) mesh; and

FIG. 45F is a graph illustrating verification of the PCC design by a porous stainless-steel (SS) mesh and a porous copper (Cu) mesh.

### DETAILED DESCRIPTION

The present disclosure will be described in further detail according to an embodiment. Note that the present disclosure is not limited thereby.

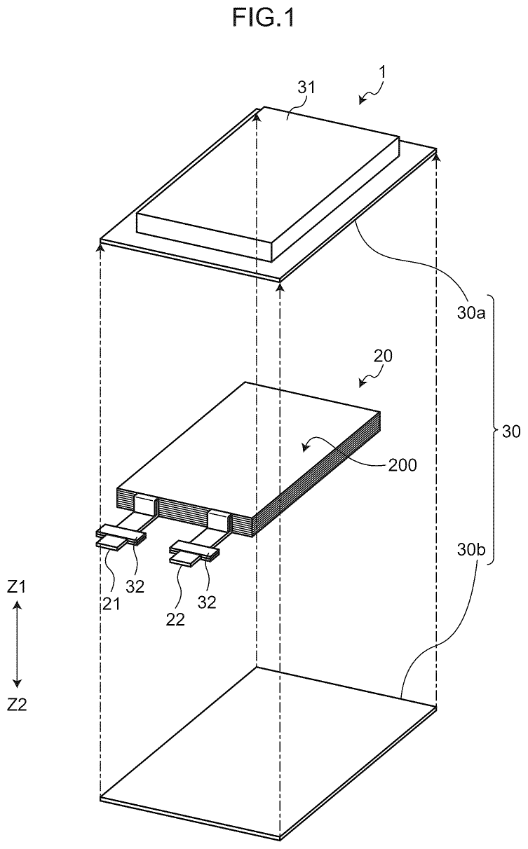

FIG. 1 is a cross-sectional view illustrating an example of a secondary battery according to a first embodiment. A secondary battery 1 illustrated in FIG. 1 is a laminated lithium-ion secondary battery. As illustrated in FIG. 1, the secondary battery 1 includes a battery element 20, an exterior member 30, and adhesive materials 32.

The battery element 20 is provided inside the exterior member 30. As illustrated in FIG. 1, the battery element 20 includes an electrode body 200, a cathode lead 21, and an anode lead 22. The cathode lead 21 is a terminal drawn out from a cathode current collector 212 described later to the outside of the exterior member 30. That is, the cathode lead 21 is a terminal serving as a cathode of the secondary battery 1. In FIG. 1, the cathode lead 21 is provided on an end surface of the electrode body 200. The anode lead 22 is a terminal drawn out from the inside of an anode current collector 213 to be described later to the outside of the exterior member 30. That is, the anode lead 22 is a terminal serving as an anode of the secondary battery 1. In FIG. 1, the anode lead 22 is provided on the end surface of the electrode body 200. Details of the electrode body 200 will be described later.

The exterior member 30 is a case in which the battery element 20 is housed. The exterior member 30 includes two exterior sheets 30a and 30b. The exterior sheets 30a and 30b each include an insulating layer, a metal layer, and an outermost layer. In the example of FIG. 1, a recess 31 is formed in exterior sheet 30a. As a result, the battery element 20 is housed in the recess 31, and the peripheral edge portions of the exterior sheets 30a and 30b are bonded to each other, whereby the battery element 20 is housed in the exterior member 30.

The exterior sheets 30a and 30b each have a structure in which an insulating layer, a metal layer, and an outermost layer are stacked in this order from the inside, namely, from the side where the battery element 20 is provided, and are bonded by lamination or the like. The insulating layers of exterior sheets 30a and 30b are made of, for example, a resin such as polyolefin resin containing polyethylene, polypropylene, modified polyethylene, modified polypropylene, ethylene or propylene as a monomer. As a result, the exterior sheets 30a and 30b can lower the moisture permeability of the secondary battery 1, whereby the airtightness can be improved. The metal layers of the exterior sheets 30a and 30b are metal plate materials such as aluminum, stainless steel, nickel, or iron, or a foil material. The outermost layer may be any material, but is preferably made of a material having high strength against breakage, piercing, or the like, such as a resin similar to that of the insulating layer or nylon.

An adhesive material 32 is a member for making the exterior member 30 airtight. The adhesive material 32 is provided between the exterior member 30 and the cathode lead 21 and the anode lead 22. The material of the adhesive material 32 preferably has adhesion to the cathode lead 21 and the anode lead 22. For example, in a case where the cathode lead 21 and the anode lead 22 are made of a metal material, a polyolefin resin such as polyethylene, polypropylene, modified polyethylene, or modified polypropylene is used for the adhesive material 32. As a result, the adhesive material 32 can seal a gap between the exterior member 30 and the cathode lead 21 and the anode lead 22, whereby the interior of the exterior member 30 can be made airtight.

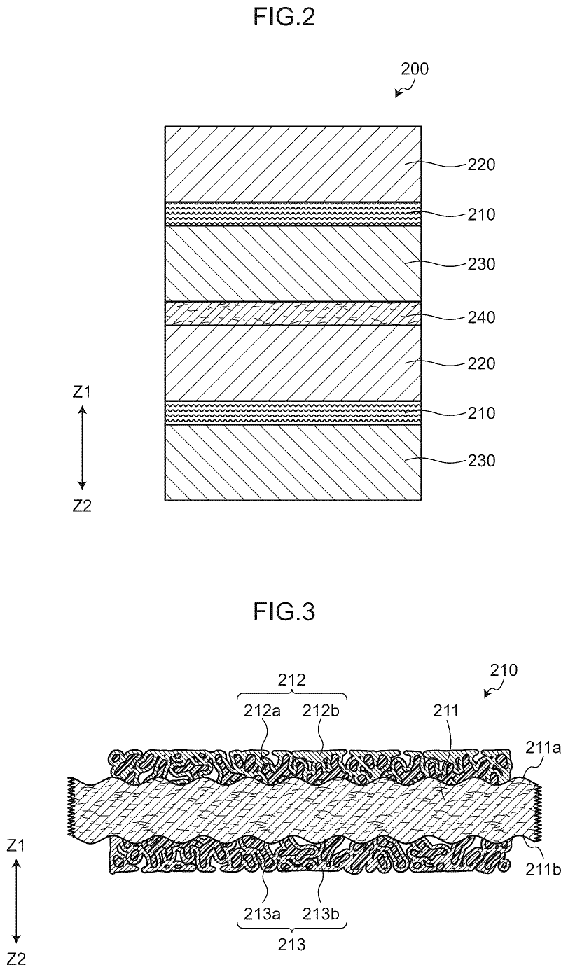

FIG. 2 is an enlarged cross-sectional view illustrating a part of the cross section of the electrode body in FIG. 1. More specifically, FIG. 2 is a cross-sectional view illustrating a part of two sets of a cathode and an anode in the electrode body 200. As illustrated in FIG. 2, the electrode body 200 includes a current collector assembly 210, a cathode active material layer 220, an anode active material layer 230, and a separator 240. In the secondary battery 1, the electrode body 200 has a structure in which a cathode active material layer 220, a current collector assembly 210, an anode active material layer 230, a separator 240, a cathode active material layer 220, a current collector assembly 210, and an anode active material layer 230 are stacked in this order. The cathode active material layers 220 and the anode active material layers 230 included in the electrode body 200 are layered members for charge and discharge reactions of the secondary battery according to the first embodiment. In the following description, one side in the thickness direction of the electrode body 200 may be referred to as a Z1 direction, and the other side in the thickness direction of the electrode body 200 may be referred to as a Z2 direction.

FIG. 3 is an enlarged cross-sectional view illustrating the current collector assembly in FIG. 2. As illustrated in FIG. 3, a current collector assembly 210 includes an insulating film 211, a cathode current collector 212, and an anode current collector 213.

The insulating film 211 is a film having an insulating property. In the present disclosure, having an insulating property means being made of a material having an electrical conductivity of less than or equal to 10⁻⁶ S/m. This makes it possible to suppress a short circuit between the cathode current collector 212 and the anode current collector 213. The insulating film 211 is porous. In the present disclosure, a porous body refers to a material having a porosity of greater than or equal to 10%. As a result, carrier ions of the secondary battery 1, such as lithium-ions, can pass through the insulating film 211 in the thickness direction. The porosity of the insulating film 211 is preferably greater than or equal to 40%. As a result, the strength of the insulating film 211 can be increased, and both electrochemical stability and good mechanical characteristics of the secondary battery 1 can be achieved. The average pore diameter of the insulating film 211 is preferably within a range of 10 nm to 50 μm, and more preferably, the insulating film 211 is made of a nanoporous material. In this example, the nanoporous material refers to a material having an average pore diameter in a mesopore range, namely, in a range of 10 nm to 50 nm. As a result, lithium-ion permeability is excellent. The insulating film 211 contains, for example, a polymer material. The insulating film 211 preferably contains at least one of polyolefin, polyimide, polyamide, polyester, cellulose, glass, or metal oxide, and particularly preferably contains polyparaphenylene terephthalamide. In this example, an example of the insulating film 211 containing glass is glass filter paper such as GC-50 manufactured by ADVANTEC CO., LTD. An example of the insulating film 211 containing a metal oxide is a porous alumina film. As a result, the strength of the insulating film 211 can be increased, and both electrochemical stability and good mechanical characteristics of the secondary battery 1 can be achieved. In the present disclosure, the average pore diameter refers to a value of 4 V/A obtained by dividing a total pore volume V calculated by a BJH method from a pore analysis obtained by a gas adsorption method by a specific surface area A and multiplying the result by 4. In the present disclosure, the porosity refers to the ratio of the total pore volume V to the bulk volume, which can be calculated by: porosity (%)=total pore volume V/bulk volume×100. The bulk volume can be calculated on the basis of dimensions such as the thickness or the area.

The cathode current collector 212 is stacked on a first main surface 211a which is a surface of the insulating film 211 in the Z1 direction. The cathode current collector 212 is a porous body. The cathode current collector 212 includes a cathode porous body 212a and a cathode conductive layer 212b.

The cathode porous body 212a is a porous body stacked on the first main surface 211a of the insulating film 211. The average pore diameter of the cathode porous body 212a is preferably greater than or equal to 10 nm. As a result, even in a case where the cathode conductive layer 212b is formed in the pores of the cathode porous body 212a, excellent lithium-ion permeability is obtained. The average pore diameter of the cathode porous body 212a is more preferably greater than or equal to 1 μm. This makes it possible to suppress the pores of the cathode porous body 212a from being blocked by the cathode conductive layer 212b even in a case where the cathode conductive layer 212b having a sufficient thickness is used for obtaining sufficient conductivity. The cathode porous body 212a preferably contains at least one of polyolefin, polyimide, polyamide, polyester, cellulose, glass, or a metal oxide, and contains, for example, a polymer such as polyimide or poly(vinylidene-co-hexafluoropropene). In the present disclosure, polyimide refers to a polymer containing an imide bond. An example of the cathode porous body 212a containing glass is glass filter paper such as GC-50 manufactured by ADVANTEC CO., LTD. An example of the cathode porous body 212a containing a metal oxide is a porous alumina film. As a result, the strength of the cathode porous body 212a can be increased, and both electrochemical stability and good mechanical characteristics of the secondary battery 1 can be achieved.

The cathode conductive layer 212b is a conductive film that covers the surfaces of pores of the cathode porous body 212a. In the present disclosure, being conductive means being made of a material having an electrical conductivity of greater than or equal to 10⁴ S/m. The cathode conductive layer 212b includes a conductor such as aluminum or stainless steel. The thickness of the cathode conductive layer 212b is preferably greater than or equal to 100 nm, and more preferably greater than or equal to 1 μm. As a result, the electrical conductivity can be improved, and the internal resistance of the secondary battery 1 can be reduced. The thickness of the cathode conductive layer 212b is preferably less than or equal to 10 μm, and preferably less than or equal to 2 μm. As a result, the pores of the cathode porous body 212a can be suppressed from being blocked by the cathode conductive layer 212b, and the permeability of an electrolyte can be improved. In this example, the thickness of the cathode conductive layer 212b refers to an average thickness of the cathode conductive layer 212b in the normal direction of surfaces of pores of the cathode porous body 212a. The thickness of the cathode conductive layer 212b can be measured with a scanning electron microscope.

The anode current collector 213 is a porous body. The anode current collector 213 includes an anode porous body 213a and an anode conductive layer 213b. The anode current collector 213 is stacked on a second main surface 211b which is a surface of the insulating film 211 in the Z2 direction.

The anode porous body 213a is a porous body stacked on the second main surface 211b of the insulating film 211. The average pore diameter of the anode porous body 213a is preferably greater than or equal to 10 nm. As a result, even in a case where the anode conductive layer 213b is formed in the pores of the anode porous body 213a, excellent lithium-ion permeability is obtained. The average pore diameter of the anode porous body 213a is preferably greater than or equal to 1 μm. This makes it possible to suppress the pores of the anode porous body 213a from being blocked by the anode conductive layer 213b even in a case where the anode conductive layer 213b having a sufficient thickness is used for obtaining sufficient conductivity. The anode porous body 213a preferably contains at least one of polyolefin, polyimide, polyamide, polyester, cellulose, glass, or a metal oxide, and contains, for example, a polymer such as polyimide or poly(vinylidene-co-hexafluoropropene). In this example, an example of the anode porous body 213a containing glass is glass filter paper such as GC-50 manufactured by ADVANTEC CO., LTD. An example of the anode porous body 213a containing a metal oxide is a porous alumina film. As a result, the strength of the anode porous body 213a can be increased, and both electrochemical stability and good mechanical characteristics of the secondary battery 1 can be achieved.

The anode conductive layer 213b is a conductive film that covers the surfaces of pores of the anode porous body 213a. The anode conductive layer 213b includes a conductor such as copper or stainless steel. The thickness of the anode conductive layer 213b is preferably greater than or equal to 100 nm, and more preferably greater than or equal to 1 μm. As a result, the electrical conductivity can be improved, and the internal resistance of the secondary battery 1 can be reduced. The thickness of the anode conductive layer 213b is preferably less than or equal to 10 μm, and more preferably less than or equal to 2 μm. As a result, the pores of the anode porous body 213a can be suppressed from being blocked by the anode conductive layer 213b, and the permeability of an electrolyte can be improved. In this example, the thickness of the anode conductive layer 213b refers to an average thickness of the anode conductive layer 213b in the normal direction of surfaces of pores of the anode porous body 213a. The thickness of the anode porous body 213a can be measured with a scanning electron microscope.

The cathode active material layer 220 contains one or more types of cathode active materials capable of occluding and releasing lithium. Note that the cathode active material layer 220 may further contain one or more other materials such as a cathode binding agent or a cathode conductive agent. The method for forming the cathode active material layer 220 is not particularly limited, and may be specifically a coating method or the like.

The type of the cathode active material is not particularly limited, and is specifically lithium-containing compounds or the like. The lithium-containing compounds are compounds containing lithium and one or more types of transition metal elements as constituent elements. The lithium-containing compounds may further contain one or more other elements as constituent elements. The types of the other elements are not particularly limited as long as the element is other than lithium or a transition metal element, and specific examples of the other elements include an element belonging to any one of the groups 2 to 15 in the long-form periodic table.

The type of the lithium-containing compounds is not particularly limited, and specific examples of the lithium-containing compounds include oxides, phosphate compounds, silicic acid compounds, and boric acid compounds. Specific examples of the oxides include LiNiO₂, LiCoO₂, LiCo_{0.98}Al_{0.01}Mg_{0.01}O₂, LiNi_{0.5} Co_{0.2}Mn_{0.3}O₂, LiNi_{0.8} Co_{0.15}Al_{0.05}O₂, LiNi_{0.33} Co_{0.33}Mn_{0.33}O₂, Li_{1.2}Mn_{0.52} Co_{0.175}Ni_{0.1}O₂, Li_{1.15}Mn_{0.65}Ni_{0.22} Co_{0.13}O₂, and LiMn₂O₄. Specific examples of the phosphate compounds include LiFePO₄, LiMnPO₄, LiFe_{0.5}Mn_{0.5}PO₄, and LiFe_{0.3}Mn_{0.7}PO₄.

The cathode binding agent contains one or more types of synthetic rubber, polymer compounds, and the like. Specific examples of the synthetic rubber include styrene butadiene-based rubber, fluorine-based rubber, and ethylene propylene diene. Specific examples of the polymer compounds include polyvinylidene fluoride, polyimide, and carboxymethyl cellulose.

The cathode conductive agent contains one or more types of conductive materials such as a carbon material. Specific examples of the carbon material include graphite, carbon black, acetylene black, and Ketjen black. However, the conductive material may be a metal material, a polymer compound, or the like.

The anode active material layer 230 contains one or more types of anode active materials capable of occluding and releasing lithium. Note that the anode active material layer 230 may further contain one or more other materials such as an anode binding agent or an anode conductive agent. Note that the method for forming the anode active material layer 230 is not particularly limited, and may be specifically any one or more of a coating method, a gas phase method, a liquid phase method, a thermal spraying method, a baking method (sintering method), and the like.

The type of the anode active material is not particularly limited, and is specifically one or both of a carbon material and a metal-based material. This makes it possible to obtain a high energy density. Specific examples of the carbon material include graphitizing carbon, non-graphitizing carbon, and graphite such as natural graphite and artificial graphite. The metal-based material is a material containing, as a constituent element, an element capable of forming an alloy with lithium, the element being one or more types of a metal element and a metalloid element, and specific examples of the element include silicon and tin. The metal-based material may be one or more of a simple substance, an alloy, and a compound, or may be a mixture or a material containing two or more phases. Specific examples of the metal-based material include TiSi₂ and SiOₓ (0<x≤2).

As the anode binding agent, a similar material to that of the cathode binding agent can be used. Likewise, as the anode conductive agent, a similar material to that of the cathode conductive agent can be used.

The separator 240 is a film that insulates the cathode active material layer 220 from the anode active material layer 230. The separator 240 is provided between a main surface of the cathode active material layer 220 and a main surface of the anode active material layer 230 so that the cathode active material layer 220 and the anode active material layer 230 are not in direct contact with each other. In the example of FIG. 1, the shape of the separator 240 is a rectangular sheet in plan view in the thickness direction.

The material of the separator 240 is preferably electrically stable, chemically stable with respect to the cathode active material, the anode active material, and the electrolytic solution, and has an insulating property. As the separator 240, for example, a layer containing at least one type of polymer nonwoven fabrics, porous films, glass, and ceramic fibers can be used. The material of the separator 240 more preferably includes a porous polyolefin film. This makes it possible to improve the safety of the battery by the short circuit preventing effect and the shutdown effect.

Note that the separator 240 is not an essential component. The separator 240 may be replaced with, for example, a current collector assembly 210.

The insulating film 211 and the separator 240 are impregnated with the electrolytic solution. In the example of FIG. 1, a space in the exterior member 30 is filled with the electrolytic solution. The electrolytic solution is a nonaqueous electrolytic solution containing an electrolyte salt and a solvent that dissolves the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

The solvent is, for example, a nonaqueous solvent including a lactone-based solvent such as γ-butyrolactone, γ-valerolactone, δ-valerolactone, or ε-caprolactone, a carbonate-based solvent such as ethylene carbonate, propylene carbonate, butylene carbonate, vinylene carbonate, dimethyl carbonate, ethyl methyl carbonate, or diethyl carbonate, an ether-based solvent such as 1,2-dimethoxyethane, 1-ethoxy-2-methoxyethane, 1,2-diethoxyethane, tetrahydrofuran, or 2-methyltetrahydrofuran, a nitrile-based solvent such as acetonitrile, a sulfolane-based solvent, phosphoric acids, a phosphoric acid ester solvent, pyrrolidones, or the like.

The electrolytic solution preferably contains at least one of a fluorinated carboxylic acid ester, a sulfonic acid ester, a sulfonic acid anhydride, and a carboxylic acid anhydride as an additive. As a result, generation of a solid electrolyte interphase (SEI) having a small resistance is promoted, and thus charge load characteristics can be improved. Examples of the fluorinated carboxylic acid ester include fluoroethylene carbonate (FEC). Examples of the sulfonic acid anhydride include propanedisulfonic acid anhydride (PSAH). Examples of the sulfonic acid ester include 1,3-propanesultone. Examples of the carboxylic acid anhydride include 1,4-dioxane-2,6-dione.

Note that the current collector assembly according to the first embodiment is not limited to those described above, and may be those according to modifications described below.

A current collector assembly according to a first modification is different from the current collector assembly 210 in FIG. 3 in not including the cathode porous body 212a nor the anode porous body 213a. In the first modification, a cathode current collector is a cathode conductive layer provided on surfaces of pores in a first main surface 211a of an insulating film 211. In the first modification, an anode current collector is an anode conductive layer provided on surfaces of pores in a second main surface 211b of the insulating film 211. Even in this case, since carrier ions such as lithium-ions can pass in the stacking direction of the current collector assembly, the charge-discharge behavior at a high rate can be improved.

The current collector assembly according to the second modification is different from the current collector assembly 210 in FIG. 3 in that the cathode conductive layer and the anode conductive layer are provided to some of pores of each of the cathode porous body 212a and the anode porous body 213a. In the second modification, the cathode conductive layer and the anode conductive layer are formed in, for example, a mesh shape in plan view in the Z direction. In this case, even in a case where the pore diameters of the cathode porous body 212a and the anode porous body 213a are further reduced, the pores are not blocked by the cathode conductive layer or the anode conductive layer, and thus the strength can be improved.

In addition, the secondary battery according to the first embodiment is not limited to the secondary battery described above, and may be a secondary battery according to modifications described below.

The secondary battery according to the third modification is different from the secondary battery having the electrode body 200 in FIG. 2 in that a current collector assembly 210 is provided instead of the separator 240. As a result, the length of an electron conduction pathway between the cathode current collector 212 and the anode current collector 213 via the cathode active material layer 220 or the anode active material layer 230 can be further shortened, whereby the current density can be reduced.

As described above, the current collector assembly 210 according to the first embodiment includes the insulating film 211 having the first main surface 211a and the second main surface 211b on the opposite side to the first main surface 211a, the cathode current collector 212 provided on the first main surface 211a, and the anode current collector 213 provided on the second main surface 211b. The insulating film 211, the cathode current collector 212, and the anode current collector 213 are porous bodies.

This allows carrier ions, such as lithium-ions, to pass in the stacking direction of the current collector assembly 210. That is, at the time of charging and discharging of the secondary battery 1, the carrier ions can move between the cathode active material layer 220 and the anode active material layer 230 not only through a pathway via the separator 240 but also through a pathway via the current collector assembly 210. Therefore, the diffusion distance of the carrier ions in the charge and discharge reactions can be shortened, which allows a larger current to flow under diffusion resistance control. As a result, even in a case where charging and discharging are performed at a high rate with a large current, it is possible to suppress the concentration of lithium-ions from being biased between the cathode and the anode, and thus, it is possible to suppress generation of irreversible capacity due to generation of metal lithium or the like. Therefore, the current collector assembly 210 according to the first embodiment can improve charge-discharge behavior at a high rate.

As a desirable aspect, the average pore diameter of the cathode current collector 212 is within a range of 10 nm to 50 μm. The average pore diameter of the anode current collector 213 is within the range of 10 nm to 50 μm. This makes it possible to suppress the pores of the cathode porous body 212a and the anode porous body 213a from being blocked by the cathode conductive layer 212b and the anode conductive layer 213b, respectively, even in a case where the cathode conductive layer 212b and the anode conductive layer 213b having a sufficient thickness are used for obtaining sufficient conductivity.

As a desirable aspect, the average pore diameter of the insulating film 211 is within the range of 10 nm to 50 μm. This makes it possible to achieve both the lithium-ion permeability of the insulating film 211 and the mechanical strength of the current collector assembly 210.

As a more desirable aspect, the insulating film 211 includes at least one of polyolefin, polyimide, polyamide, polyester, cellulose, glass, or a metal oxide. As a result, the strength of the insulating film 211 can be increased, and both electrochemical stability and good mechanical characteristics of the secondary battery 1 can be achieved.

As a desirable aspect, the cathode current collector 212 includes a cathode porous body 212a and a cathode conductive layer 212b provided on surfaces of pores of the cathode porous body 212a. The anode current collector 213 includes an anode porous body 213a and an anode conductive layer 213b provided on surfaces of pores of the anode porous body 213a. This allows carrier ions to pass through the cathode current collector 212 and the anode current collector 213 in the thickness direction, and as a result, the diffusion distance of the ions can be halved as compared with that in the related art.

As a more desirable aspect, the thickness of the cathode conductive layer 212b is within a range of 100 nm to 10 μm. The thickness of the anode conductive layer 213b is within the range of 100 nm to 10 μm. As a result, the electrical conductivity can be improved, the pores of the cathode porous body 212a and the anode porous body 213a can be suppressed from being blocked by the cathode conductive layer 212b and the anode conductive layer 213b while reducing the internal resistance of the secondary battery 1, and the permeability of the electrolyte can be improved.

As a more desirable aspect, the cathode porous body 212a includes at least one of polyolefin, polyimide, polyamide, polyester, cellulose, glass, or a metal oxide. The anode porous body 213a includes at least one of polyolefin, polyimide, polyamide, polyester, cellulose, glass, or a metal oxide. As a result, the strength of the cathode porous body 212a and the anode porous body 213a can be increased, and both electrochemical stability and good mechanical characteristics of the secondary battery 1 can be achieved.

As described above, the secondary battery 1 according to the first embodiment includes the insulating film having the first main surface 211a and the second main surface 211b on the opposite side to the first main surface 211a, the cathode provided on the first main surface 211a, and the anode provided on the second main surface 211b. The cathode includes the cathode current collector 212 and the cathode active material layer 220. The anode includes the anode current collector 213 and the anode active material layer 230. The insulating film 211 is a porous body. The cathode current collector 212 and the anode current collector 213 are a porous body or a porous plate. As a result, since carrier ions such as lithium-ions can pass in the stacking direction of the current collector assembly 210, the charge-discharge behavior at a high rate can be improved.

As a desirable aspect, the cathode current collector 212 is a porous body provided on the first main surface 211a and having the cathode porous body and the cathode conductive layer provided on surfaces of the pores of the cathode porous body. The anode current collector 213 is a porous body provided on the second main surface 211b and having the anode porous body and the anode conductive layer provided on surfaces of the pores of the anode porous body. This makes it possible to improve the charge-discharge behavior at a high rate.

As a more desirable aspect, there are provided a plurality of current collector assemblies each including the insulating film 211, the cathode current collector 212 provided on the first main surface 211a, and the anode current collector 213 provided on the second main surface 211b. A separator 240 is further included. The separator 240 is stacked between a cathode active material layer 220 provided on a first current collector assembly 210 and an anode active material layer 230 provided on a second current collector assembly 210. This makes it possible to improve the charge-discharge behavior at a high rate.

As a more desirable aspect, there are provided a plurality of current collector assemblies each including the insulating film 211, the cathode current collector 212 provided on the first main surface 211a, and the anode current collector 213 provided on the second main surface 211b. The first current collector assembly 210 and the second current collector assembly 210 are stacked with a cathode active material layer 220 or an anode active material layer 230 interposed therebetween. This makes it possible to improve the charge-discharge behavior at a high rate.

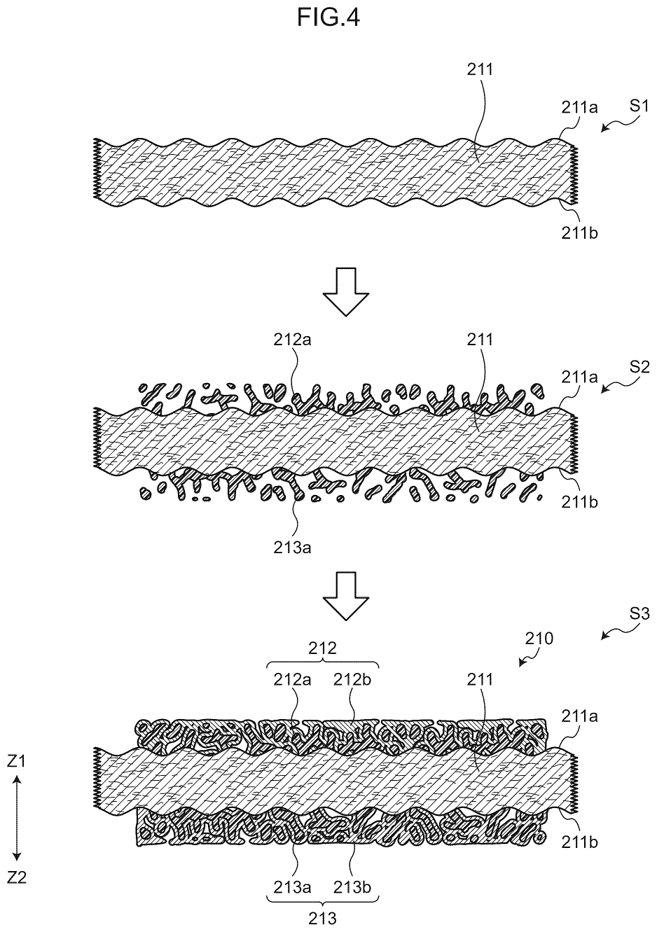

Hereinafter, a manufacturing method of the current collector assembly according to the first embodiment will be described. FIG. 4 is a diagram illustrating manufacturing steps of the current collector assembly according to the first embodiment. As illustrated in FIG. 4, the manufacturing steps of the current collector assembly according to the first embodiment include a step of preparing the insulating film 211 (step S1), a step of forming the cathode porous body 212a and the anode porous body 213a (step S2), and a step of forming the cathode conductive layer 212b and the anode conductive layer 213b (step S3).

In the step of preparing the insulating film 211 (step S1), a sheet of an insulating material is cut out to prepare the insulating film 211.

In the step of forming the cathode porous body 212a and the anode porous body 213a (step S2), the cathode porous body 212a and the anode porous body 213a are formed on the first main surface 211a and the second main surface 211b of the insulating film 211, respectively. Specifically, for example, pyromellitic dianhydride (PMDA) and 4,4′-oxydianiline (ODA) are stirred and to cause reaction to obtain a slurry of a microporous polyimide precursor. Then, the first main surface 211a and the second main surface 211b of the insulating film are coated with the obtained slurry, immersed in a mixed solution of ethanol and water, and then dried at room temperature to obtain a composite. Then, the obtained composite is heated in a box furnace. As a result, as the cathode porous body 212a and the anode porous body 213a, polyimide layers of a porous body can be formed on the insulating film 211.

In the step of forming the cathode conductive layer 212b and the anode conductive layer 213b (step S3), the cathode conductive layer 212b and the anode conductive layer 213b are formed on the surfaces of the pores of the cathode porous body 212a and the anode porous body 213a, respectively. Specifically, for example, the cathode conductive layer 212b can be formed on the surfaces of the pores of the cathode porous body 212a by performing pulsed DC magnetron sputtering on the cathode porous body 212a using the material of the cathode conductive layer 212b as a target. Similarly, the anode conductive layer 213b can be formed on the surfaces of the pores of the anode porous body 213a by performing pulsed DC magnetron sputtering on the anode porous body 213a using the material of the anode conductive layer 213b as a target.

Note that the manufacturing method described above is an example, and it is not limited thereto. For example, the step of forming the cathode porous body 212a and the anode porous body 213a (step S2) may be the following step. Poly(vinylidene-co-hexafluoropropene) (PVDF-HFP) having a molecular weight of about 455000 is dissolved in acetone and added with water to prepare a precursor slurry. Next, the slurry is applied to the first main surface 211a and the second main surface 211b of the insulating film at room temperature and dried in a vacuum oven to form the cathode porous body 212a and the anode porous body 213a.

Examples will be described below according to an embodiment. Note that the current collector assembly and the secondary battery according to the first embodiment are not limited to the following examples.

A current collector assembly according to Example 1 was prepared by the following method.

In the step of preparing the insulating film, a porous aramid film (Kevlar (registered trademark), manufactured by DuPont) having a thickness of 15 μm and a porosity of 65% was prepared as the insulating film.

In the step of forming the cathode porous body 212a and the anode porous body 213a (step S2), the cathode porous body 212a was formed on the first main surface 211a of the insulating film 211 and the anode porous body 213a was formed on the second main surface 211b of the insulating film 211 by the following method. First, a mixture obtained by mixing pyromellitic dianhydride (PMDA) and 4,4′-oxydianiline (ODA) as precursor raw materials at a molar ratio of 1:1.02 was added to dimethylformamide while stirring to prepare a honey-like slurry. Then, the honey-like slurry was applied to the first main surface 211a and the second main surface 211b of the insulating film 211, immersed in a solution obtained by mixing ethanol and water at a volume ratio of 1:1, and dried at room temperature to obtain a composite. The obtained composite was heated in a box furnace at the following temperature settings (1) to (7) to be imidized. As a result, an insulating film 211 in which porous polyimide was formed on both sides as the cathode porous body 212a and the anode porous body 213a was obtained.
(1) Raise temperature (ramp-up) from 25° C. to 100° C. at 3° C. min⁻¹.
(2) Leave at 100° C. for 30 minutes.
(3) Ramp up to 200° C. at 3° C. min⁻¹.
(4) Leave at 200° C. for 30 minutes.
(5) Ramp up to 300° C. at 3° C. min⁻¹.
(6) Leave at 300° C. for 30 minutes.
(7) Cool to room temperature.

In the step of forming the cathode conductive layer 212b and the anode conductive layer 213b (step S3), the cathode conductive layer 212b and the anode conductive layer 213b were formed on the surfaces of the pores of the cathode porous body 212a and the anode porous body 213a, respectively, in the following method. First, the surface of the cathode porous body 212a was pretreated with oxygen plasma for 5 minutes. Thereby, the surface adhesiveness of the cathode conductive layer 212b was improved. Then, an Al film was formed as the cathode conductive layer 212b by pulsed DC magnetron sputtering using argon as a protective gas at a pressure of less than or equal to 10⁶ Torr (1.3×10⁸ Pa). Similarly, the surface of the anode porous body 213a was pretreated with oxygen plasma for 5 minutes. Thereby, the surface adhesiveness of the anode conductive layer 213b was improved. Then, a Cu film was formed as the anode conductive layer 213b by pulsed DC magnetron sputtering using argon as a protective gas at a pressure of less than or equal to 10⁶ Torr (1.3×10⁸ Pa).

In addition, a secondary battery of Example 1 was prepared by the following method.

A cathode active material layer of Example 1 was prepared by the following method. As a cathode active material, LiNi_{0.5}Mn_{0.3} Co_{0.2}O₂(NMC, Toda America, Inc.), a segregated carbon nanotube (CNT) dispersion, and carbon black (Timcal C45 carbon) were cast into butyl benzyl phthalate (santicizer (registered trademark)) and mixed to prepare a cathode slurry. In this example, the segregated CNT dispersion is a dispersion of N-methyl-2 pyrrolidone containing 0.4 wt % of single wall Carbon Nanotube (SWCNT) and 2 wt % of a binder (polyvinylidene difluoride). The amounts of raw materials of the cathode slurry were adjusted such that the mass ratio of NMC, SWCNT, carbon black, and the binder was 92:1:2:5. Next, the obtained cathode slurry was applied to the PET side of a PET/Al composite film, and then dried in an oven at 70° C., subsequently dried in a vacuum at 60° C., and then dried in the oven at 120° C. to remove the solvent. Then, the cathode slurry was peeled off from the PET/Al film to obtain a cathode active material layer.

The anode active material layer of Example 1 was prepared by the following method. As an anode active material, a graphite powder (Superior Graphite SLC1506T), a segregated carbon nanotube (CNT) dispersion, and carbon black (Timcal C45 carbon) were cast into butyl benzyl phthalate (santicizer (registered trademark)) and mixed to prepare an anode slurry. In this example, the segregated CNT dispersion is the same dispersion as the segregated CNT dispersion used in preparation of the cathode active material layer of Example 1. The amounts of raw materials of the anode slurry were adjusted such that the mass ratio of the graphite, SWCNT, carbon black, and the binder was 86:2:2:10. Next, the obtained anode slurry was applied to the PET side of a PET/Al composite film, and then dried in an oven at 70° C., subsequently dried in a vacuum at 60° C., and then dried in the oven at 120° C. to remove the solvent. Then, the anode slurry was peeled off from the PET/Al film to obtain an anode active material layer.

A secondary battery of Example 1 was assembled by the following method. The cathode active material layer, the cathode current collector layer of the current collector assembly, the insulating film, the anode current collector, the anode active material layer, and the separator were stacked in this order to produce an electrode body. A cathode conductor coating was connected to a 1 cm wide Al foil strip and then to an Al tab, and an anode coating was connected to a 1 cm wide Cu foil strip with a welder and then to a nickel tab. As the separator, a porous film (Celgard (registered trademark) 2325) in which a polyethylene sheet is sandwiched between polypropylene sheets was used. As the electrolytic solution, lithium hexafluorophosphate (LiPF₆) (1.2 mol/L) in ethylene carbonate/ethyl methyl carbonate (EC/EMC, mass ratio of 3:7) containing 2 mass % of fluoroethylene carbonate (FEC, Sigma Aldrich) was used. Then, the insulating film and the separator were impregnated with the prepared electrolytic solution in an amount at which 10 g/Ah per unit capacity of the battery is obtained. The electrode body prepared by the above procedure was sealed in an aluminum plastic film to prepare the secondary battery of Example 1.

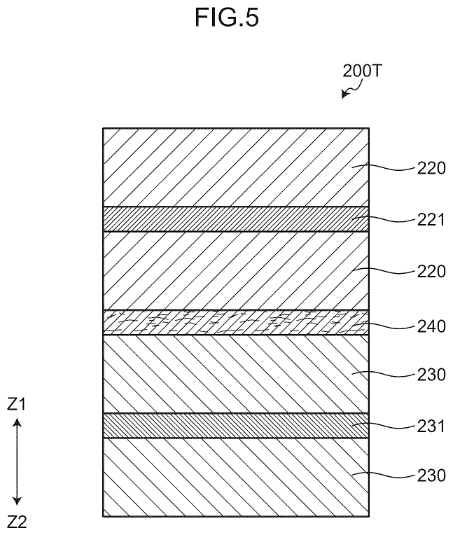

FIG. 5 is an enlarged cross-sectional view illustrating a part of a cross section of an electrode body of a secondary battery according to Comparative Example 1. More specifically, FIG. 5 is a cross-sectional view partially illustrating a set of a cathode and an anode in an electrode body 200T. As illustrated in FIG. 5, the battery of Comparative Example 1 includes the electrode body 200T having a cathode in which a cathode active material layer 220 is formed on both sides of a cathode current collector 221, an anode in which an anode active material layer 230 is formed on both sides of an anode current collector 231, and a separator 240 between the cathode and the anode. A battery of Comparative Example 1 was prepared by the following method. The cathode active material layer 220 was prepared in a similar manner to that of Example 1, and the cathode active material layer 220 was bonded to both sides of an Al foil as the cathode current collector 221 to produce a cathode. The anode active material layer 230 was prepared in a similar manner to that in Example 1, and the anode active material layer 230 as the anode current collector 231 was attached to both sides of a Cu foil to produce an anode. In this example, all the cathode current collectors were connected to an aluminum tab, and all the anode current collectors were connected to a nickel tab. Then, the same separator 240 as that in Example 1 was sandwiched between the prepared cathode and anode, and the separator 240 was impregnated with the same electrolytic solution as that in Example 1 in the same amount as that in Example 1. The electrode body prepared by the above procedure was sealed in an aluminum plastic film to prepare the secondary battery of Comparative Example 1.

The secondary batteries of Example 1 and Comparative Example 1 were subjected to a charge and discharge test. In the charge and discharge test, the secondary batteries were charged and discharged at different charge and discharge rates and charge times for each cycle. First, as preparation for the charge and discharge test, a charge and discharge cycle of performing constant-voltage charge at 4.2 V and constant-current discharge at 0.05 C to 3.0 V was performed for two cycles. Then, as a charging process, constant-current charge was performed up to 4.2 V, and after reaching 4.2 V, constant-voltage charge was performed. In this example, the rate of constant-current charge and discharge and the charge time (total time of constant-current charge and constant-voltage charge) were varied for each cycle as shown in Table 1. Then, as a discharging process, constant-current discharge was performed up to 3.0 V at 1 C. In the charge and discharge test, a resting time of 5 minutes was provided at the end of each of the charging process and the discharging process.

TABLE 1

| Cycle | Discharge rate (C) | Discharge time (min) |
|---|---|---|
| 1-3 | 1 | 60 |
| 4-6 | 2 | 30 |
| 7-9 | 3 | 20 |
| 10-12 | 4 | 15 |
| 13-15 | 5 | 12 |
| 16-18 | 6 | 10 |
| 19-21 | 8 | 7.5 |
| 22-24 | 10 | 6 |

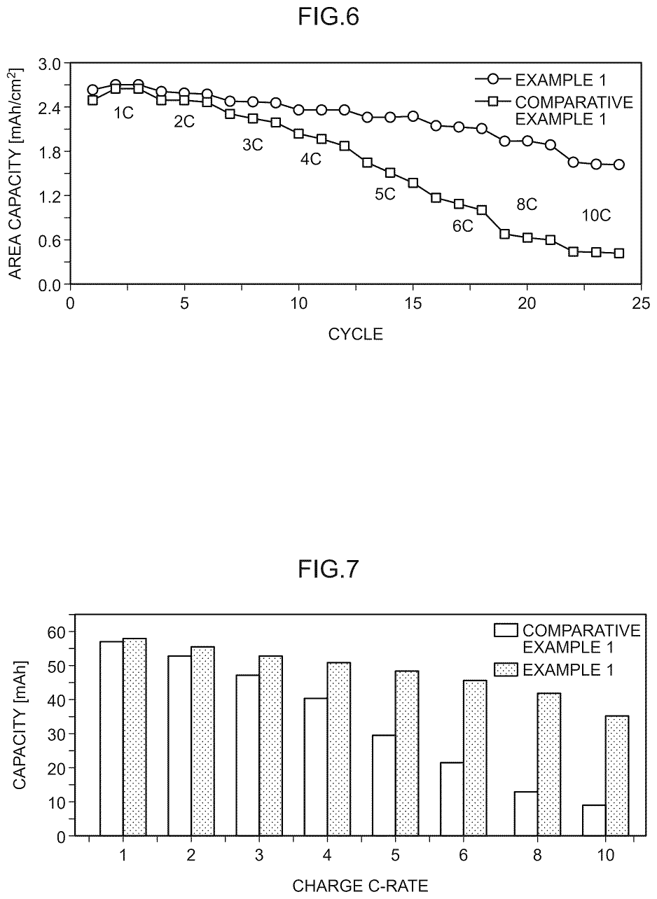

FIG. 6 is a graph illustrating transition of the area capacity of secondary batteries of Comparative Example 1 and Example 1. FIG. 7 is a graph illustrating the capacity with respect to the rate of the secondary batteries of Comparative Example 1 and Example 1. The area capacity illustrated in FIG. 6 is a discharge capacity per unit area of the current collector. The capacity illustrated in FIG. 7 is an average value of the discharge capacity for each charge C-rate. As illustrated in FIGS. 6 and 7, in charging at 1 C, the difference in discharge capacity between Example 1 and Comparative Example 1 was small; however, when the charge C-rate increased, the capacity of the secondary battery of Comparative Example 1 rapidly decreased. In particular, when the charge C-rate was greater than or equal to 3 C, the capacity of the secondary battery of Comparative Example 1 was significantly reduced. Therefore, in Comparative Example 1, it is conceivable that irreversible capacity has been generated due to generation of metallic lithium not contributing to charge-discharge reactions, whereby the available capacity was reduced. On the other hand, in Example 1, a higher capacity was maintained even at a higher charge C-rate than in Comparative Example 1. From this, it can be seen that by using the current collector assembly according to the present disclosure, generation of irreversible capacity is suppressed, and sufficient capacity can be obtained even at a high rate.

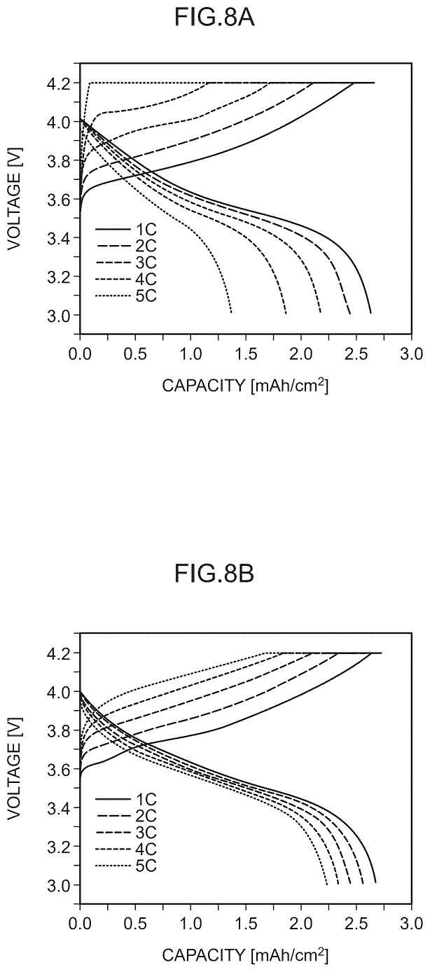

FIG. 8A is a graph illustrating charge and discharge curves of the secondary battery of Comparative Example 1. FIG. 8B is a graph illustrating charge and discharge curves of the secondary battery of Example 1. FIGS. 8A and 8B illustrate the average charge and discharge curves at each of charge and discharge rates from 1 C to 5 C. As illustrated in FIGS. 8A and 8B, the secondary battery of Example 1 has a longer time for constant-current charge in charging than in the secondary battery of Comparative Example 1. Accordingly, in Example 1, the available capacity is considered to be larger than that in Comparative Example 1. As the charge C-rate increased from 1 C to 5 C, the discharge capacity significantly decreased in Comparative Example 1, whereas the decrease in the discharge capacity was suppressed in Example 1. From this, it can be seen that a sufficient capacity can be obtained even at a high rate by using the current collector assembly according to the present disclosure.

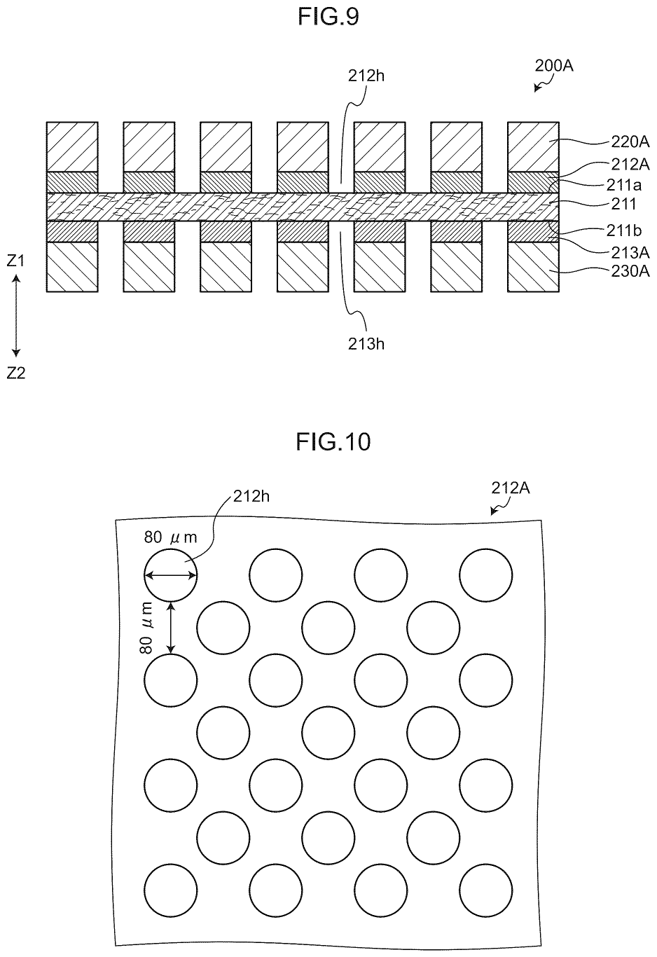

FIG. 9 is a cross-sectional view illustrating an example of an electrode body of a secondary battery according to a second embodiment. As illustrated in FIG. 9, the secondary battery according to the second embodiment is different from that of the first embodiment in that current collectors (a cathode active material layer 220A and an anode active material layer 230A) are porous plates. In the present disclosure, the current collector being a porous plate means that a plate-shaped member made of metal such as stainless steel or copper has a large number of holes and that the porosity is greater than or equal to 10%. In the example of FIG. 9, a cathode current collector 212A and an anode current collector 213A are provided on insulating film 211 sides of the cathode active material layer 220A and the anode active material layer 230A, respectively. That is, an electrode body 200A has a structure in which the cathode active material layer 220A, the cathode current collector 212A, the insulating film 211, the anode current collector 213A, and the anode active material layer 230A are stacked in this order. In the following description, providing current collectors (the cathode active material layer 220A and the anode active material layer 230A) on the insulating film 211 sides of active material layers (the cathode active material layer 220A and the anode active material layer 230A) may be described as a back-to-back method.

FIG. 10 is an enlarged view of a cathode current collector according to the second embodiment. In the second embodiment, the cathode current collector 212A is a porous plate stacked on the cathode active material layer 220A. The cathode current collector 212A contains a porous conductive material, and is, for example, a stainless steel (SS) foil with holes. More specifically, as illustrated in FIG. 10, the cathode current collector 212A has a plurality of holes 212h penetrating in the thickness direction (Z direction). As a result, carrier ions of the secondary battery such as lithium-ions can move in the thickness direction of the cathode current collector 212A, and thus the charge-discharge behavior at a high rate can be improved. Note that, in the example of FIG. 10, circular holes having a diameter of 80 μm are included at intervals of 80 μm in the cathode current collector 212A; however, the shape, the diameter, the intervals, the arrangement, and the like of the holes 212h of the cathode current collector 212A are merely examples, and are not limited thereto. As a result, carrier ions such as lithium-ions can pass through the cathode current collector 212A in the thickness direction.

In the second embodiment, the anode current collector 213A is a porous plate stacked on the anode active material layer 230A. The anode current collector 213A contains a porous conductive material, and is, for example, a copper foil with holes. More specifically, the anode current collector 213A has a plurality of holes 213h penetrating in the thickness direction (Z direction) as in FIG. 10. Note that the shape, the diameter, intervals, the arrangement, and the like of the holes of the anode current collector 213A are not limited to those illustrated in FIG. 10, and may be different from those of the cathode current collector 212A.

In the example of FIG. 10, the cathode active material layer 220A and the anode active material layer 230 are porous, and have a plurality of holes penetrating in the thickness direction (Z direction) as in FIG. 10.

Note that the secondary battery according to the second embodiment is not limited to the secondary battery described above, and may be a secondary battery according to modifications described below.

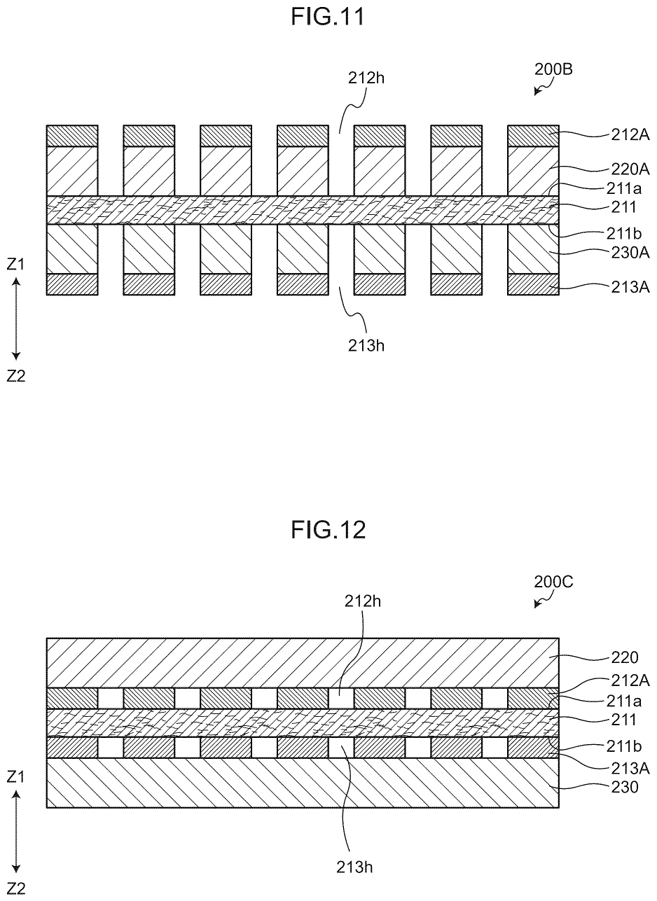

FIG. 11 is a cross-sectional view illustrating an example of an electrode body of a secondary battery according to a fourth modification. As illustrated in FIG. 11, in the secondary battery according to the fourth modification, a cathode current collector 212A and an anode current collector 213A are provided on opposite sides to the insulating film 211 sides of the cathode active material layer 220A and the anode active material layer 230A, respectively. That is, an electrode body 200B according to the fourth modification has a structure in which the cathode current collector 212A, the cathode active material layer 220A, the insulating film 211, the anode active material layer 230A, and the anode current collector 213A are stacked in this order. In the following description, providing current collectors (the cathode active material layer 220A and the anode active material layer 230A) on the opposite sides, to the insulating film 211 sides, of active material layers (the cathode active material layer 220A and the anode active material layer 230A) may be described as a face-to-face method.

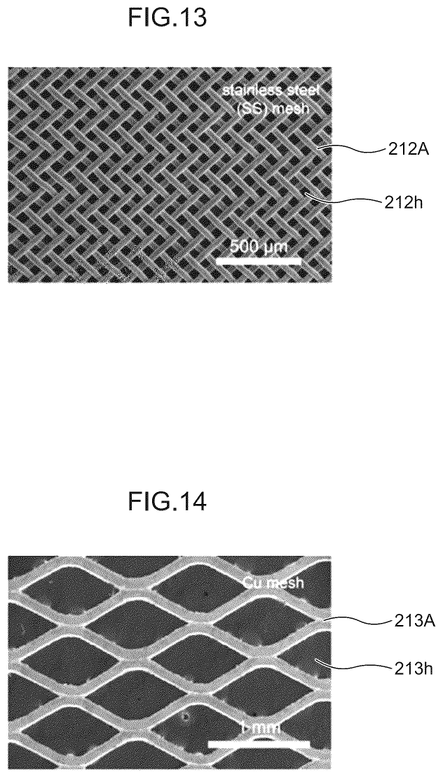

FIG. 12 is a cross-sectional view illustrating an example of an electrode body of a secondary battery according to a fifth modification. As illustrated in FIG. 12, in the secondary battery according to the fifth modification, a cathode current collector 212A and an anode current collector 213A are porous plates which are mesh-shaped metal foils. In the fifth modification, for example, a mesh-shaped SS foil can be used as the cathode current collector 212A, and for example, a mesh-shaped copper foil can be used as the anode current collector 213A. In this example, the mesh-shaped metal foils may be a sheet obtained by knitting line-shaped metal as illustrated in FIG. 13 to be described later, or may be an expanded metal as illustrated in FIG. 14 to be described later. Accordingly, as will be described later, since it is not necessary to form holes in the production of the electrode body of the secondary battery, pores are not included in the cathode active material layer and the anode active material layer in the fifth modification.

As described above, in the secondary battery according to the second embodiment, the cathode current collector 212A is a porous plate provided on the insulating film 211 side of the cathode active material layer 220A. The anode current collector 213A is a porous plate provided on the insulating film 211 side of the anode active material layer 230A. Even in this case, the charge-discharge behavior at a high rate can be improved.

Likewise, in the secondary battery according to the second embodiment, the cathode current collector 212A is a porous plate provided on the opposite side to the insulating film 211 side of the cathode active material layer 220A. The anode current collector 213A may be a porous plate provided on the opposite side to the insulating film 211 side of the anode active material layer 230A. This makes it possible to further improve the charge-discharge behavior at a high rate.

Hereinafter, a manufacturing method of the electrode body of the secondary battery according to the second embodiment will be described. The step of preparing the electrode body of the secondary battery according to the second embodiment includes a step of stacking a current collector on the active material layer, a step of making holes in the current collector, and a step of stacking the current collector on the insulating film 211. In the second embodiment, in the step of making holes in the current collector, pores as illustrated in FIG. 10 are formed in the current collector by performing ultraviolet laser cutting. In this example, since the current collector is stacked on the active material layer, pores are also made in the active material layer. The pores are also made in the active material layer. In this example, as the laser, for example, a diode-pumped solid state (DPSS) laser having an ultraviolet laser with a wavelength of 355 nm can be used.

Note that the step of preparing the electrode body of the secondary battery according to the fifth embodiment includes a step of stacking a mesh-shaped current collector on the active material layer and a step of stacking the current collector on the insulating film 211. That is, in the fifth modification, since there are already gaps in the current collector, it is not necessary to make pores in the current collector. Therefore, in the production of the secondary battery according to the fifth modification, no pores are made in the active material layer.

Examples will be described below according to an embodiment. Note that the secondary battery according to the second embodiment is not limited to the following examples.

A secondary battery according to Example 2 was prepared by the following method. The secondary battery according to Example 2 is the secondary battery according to the second embodiment.

First, as a step of stacking the current collector on the active material layer, an SS foil having a thickness of 12 μm as the cathode current collector was stacked on a cathode active material layer similar to that in Example 1 according to the first embodiment by attaching the SS foil to the cathode active material layer, and a copper foil having a thickness of 8 μm as an anode current collector was stacked on an anode active material layer similar to that in Example 1 according to the first embodiment by attaching the copper foil to the anode active material layer.

Next, as a step of making pores in the current collector, as illustrated in FIG. 10, round pores having a diameter and an interval of 80 μm were formed in each of the cathode current collector and the anode current collector by a diode-pumped solid state (DPSS) laser having an ultraviolet laser with a wavelength of 355 nm. This made the porosity of the cathode current collector and the anode current collector 40%.

Then, as a step of stacking the cathode current collector and the anode current collector on the insulating film 211, the cathode current collector and the anode current collector were stacked in such a manner as to be in contact with the first main surface 211a and the second main surface 211b of the insulating film 211, respectively. Then, a similar electrolytic solution to that in Example 1 of the first embodiment was injected to prepare the secondary battery according to Example 2.

A secondary battery according to Example 3 was prepared in a similar manner to that in Example 2 except that, as a step of stacking the cathode active material layer and the anode active material layer on the insulating film 211, the cathode active material layer and the anode active material layer were stacked in such a manner as to be in contact with the first main surface 211a and the second main surface 211b of the insulating film 211, respectively. The secondary battery according to Example 3 is the secondary battery according to the fourth modification.

FIG. 13 is a diagram illustrating a cathode current collector according to Example 4. FIG. 14 is a diagram illustrating an anode current collector according to Example 4. A secondary battery according to Example 4 was prepared in a similar manner to that in Example 3 except that, as a step of stacking the current collector on the active material layer, the step of making pores in the current collector was not performed, but a knitted sheet made of SS illustrated in FIG. 13 as a cathode current collector was attached and stacked on a cathode active material layer similar to that of Example 1 according to the first embodiment, and an expanded metal made of copper illustrated in FIG. 14 as an anode current collector was attached and stacked on an anode active material layer similar to that of Example 1 according to the first embodiment.

As a first charge and discharge test, the secondary battery according to Example 2 was subjected to charge and discharge cycles. First, as preparation for the charge and discharge test, a charge and discharge cycle of performing constant-voltage charge at 4.2 V and constant-current discharge at 0.05 C to 3.0 V was performed for two cycles. Then, as a charging process, constant-current charge was performed up to 4.2 V at 1 C, and after reaching 4.2 V, constant-voltage charge was performed. Then, as a discharging process, constant-current discharge was performed up to 3.0 V at 1 C. In the first charge and discharge test, a resting time of 5 minutes was provided at the end of each of the charging process and the discharging process.

As a second charge and discharge test, the secondary batteries according to Example 2 and Example 3 were subjected to charge and discharge cycles. First, as preparation for the charge and discharge test, a charge and discharge cycle of performing constant-voltage charge at 4.2 V and constant-current discharge at 0.05 C to 3.0 V was performed for two cycles. Then, as a charging process, constant-current charge was performed up to 4.2 V, and after reaching 4.2 V, constant-voltage charge was performed. In this example, the current in the charging process was 1.25 mA up to the 20th cycle, 2.5 mA from the 21st to 40th cycles, 5 mA from the 41st to 60th cycles, 2.5 mA from the 61st to 80th cycles, and 1.25 mA from the 81st to 100th cycles. Then, as a discharging process, constant-current discharge was performed up to 3.0 V at 1 C. In the second charge and discharge test, a resting time of 5 minutes was provided at the end of each of the charging process and the discharging process.

As a third charge and discharge test, the secondary batteries according to Example 2 and Example 3 were subjected to charge and discharge cycles. First, as preparation for the charge and discharge test, a charge and discharge cycle of performing constant-voltage charge at 4.2 V and constant-current discharge at 0.05 C to 3.0 V was performed for two cycles. Then, as a charging process, constant-current charge was performed up to 4.2 V, and after reaching 4.2 V, constant-voltage charge was performed. In this example, the current in the charging process was 1 C up to 10th cycle, 2 C from 11th to 20th cycles, 3 C from 21st to 30th cycles, and 4 C from 31st to 40th cycles. Then, as a discharging process, constant-current discharge was performed up to 3.0 V at 1 C. In the third charge and discharge test, a resting time of 5 minutes was provided at the end of each of the charging process and the discharging process.

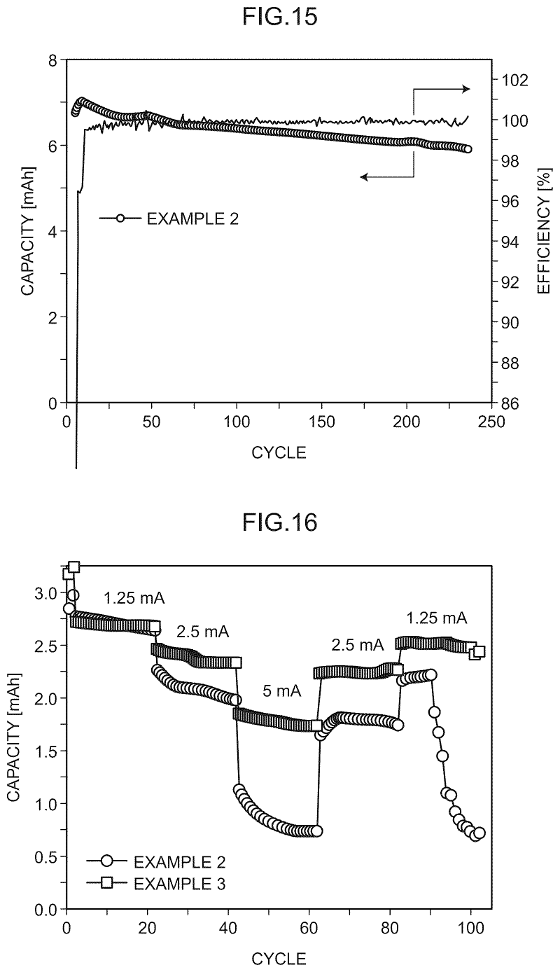

FIG. 15 is a graph illustrating the result of the first charge and discharge test according to Example 2. In this example, the efficiency in FIG. 15 refers to a ratio of the discharge capacity to the charge capacity. As illustrated in FIG. 15, it can be seen that in the secondary battery according to Example 2, deterioration of the capacity is suppressed even at the 200th cycle or later and that high efficiency is maintained successfully.

FIG. 16 is a graph illustrating the result of a second charge and discharge test according to Example 2 and Example 3. As illustrated in FIG. 16, it can be seen that the secondary battery according to Example 3 assembled by the face-to-face method can implement more stable and higher capacity as compared with the secondary battery according to Example 2 assembled by the back-to-back method.

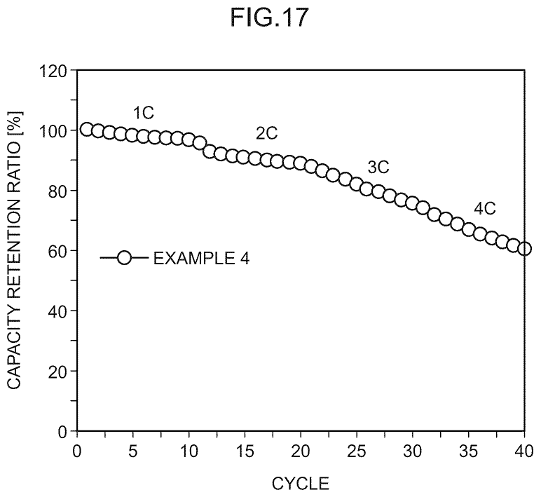

FIG. 17 is a graph illustrating the result of the third charge and discharge test according to Example 4. As illustrated in FIG. 17, the secondary battery according to Example 4 using a net-like current collector can also obtain a high capacity retention ratio.

The above embodiments are intended to facilitate understanding of the present disclosure, and are not intended to interpret the present disclosure in a limiting manner. The present disclosure can be modified and/or improved without departing from the gist thereof, and the present disclosure includes equivalents thereof.

The present disclosure includes the content of U.S. Patent Application No. 63/533,319, filed on Aug. 17, 2023, as described below.

In the following description, a porous current collector (PCC) refers to a current collector assembly according to an example of the present disclosure, and a TCC refers to a current collector according to a comparative example of the present disclosure. That is, PCC is an example of the current collector assemblies according to the embodiments of the present disclosure illustrated in FIGS. 2 and 3. Meanwhile, TCC is an example of the current collector of the metal foil illustrated in FIG. 5. Note that the current collector assembly according to the embodiment of the present disclosure is not limited to the PCC of the following description. In addition, “PCC w/o metal” refers to PCC without metal, namely, PCC in which no cathode conductor layer nor any anode conductor layer is formed, which is the same as “PCC matrix” in meaning. In this example, “PCC cell”, “PCC battery”, “PCC pouch cell”, and “PCC pouch battery” all refer to a battery having PCC, and “TCC cell”, “TCC battery”, “TCC pouch cell”, and “TCC pouch battery” all refer to a battery having TCC. The notation of NMC|graphite indicates that NMC is used as the cathode active material and graphite is used as the anode active material. The notation of Cu|Al indicates that copper (Cu) is used as the anode current collector and aluminum (Al) is used as the cathode current collector. The term “cathode” may be used to mean “positive electrode”, “cathode active material layer” or “cathode current collector”, and the term “anode” may be used to mean “negative electrode”, “anode active material layer” or “anode current collector”. The term “electrode” may be used to mean “active material layer”. The effective Li+ transport distance, the effective Li+ transport length, the length of the effective Li+ pathway, and the effective Li+ transport path length all refer to the same parameter, and are specific examples of the “diffusion distance of carrier ions” described above. “Dead lithium” and “dead Li” refer to lithium that does not contribute to the charge-discharge reactions. The N/P ratio and the negative/cathode capacity ratio refer to the ratio of the capacity of the anode to the capacity of the cathode.

In the field of lithium-ion batteries, it remains a challenge to maintain high energy density while achieving ultrahigh-speed charging. Diffusion limit is one of the major factors limiting the rate performance of a battery. In current batteries, solid metal foil current collectors (e.g., Cu and Al) are electrolyte-impermeable and prevent Li+ exchange between opposite sides of the current collectors. Herein, a porous current collector for a battery having a high energy density and that charges quite rapidly was conceptualized for the first time. This design allows Li ions to pass through both the porous current collector and the separator, thereby reducing the effective Li+ transport distance to ½ and quadrupling the diffusion limited C-rate capability, namely, the ratio of the diffusion limited current value to the capacity without impairing the energy density of the battery. At an areal cathode loading of 3 mAh/cm², a multilayer pouch cell including this new current collector showed a high energy density of about 276 Wh/kg at the full cell level. In addition, these batteries show remarkable quick charging capabilities of 4 C (15 min charge, state of charge of 0% to 78.3%), 6 C (10 min charge, state of charge of 0% to 70.5%), and 10 C (6 min charge, state of charge of 0% to 54.3%). This design of the current collector shows excellent compatibility with the current battery manufacturing processes and other quick charging strategies, thereby opening new possibilities for design of high rate batteries.

### INTRODUCTION

The spread of electric vehicles (EVs) and implementation of electric aircraft are increasing the dependence on lithium ion batteries (LIBs) with high energy density. State-of-the-art LIBs with high energy density (>250 Wh/kg) include a nickel-rich layered oxide cathode and a graphite anode. Although the use of thick electrodes has made it possible to achieve a cruising range of EVs of greater than or equal to 300 miles (about 482 km), the problem of a long charge time still remains a major challenge. As a result, ultra-high-speed charging has become one of the most demanded functions to accelerate the spread of lithium ion batteries and to solve the issue of “cruising range anxiety”. In this ultra-high-speed charging, it is required to set a charge time for reaching a state of charge (SOC) of 0% to 80% to less than 15 minutes.

Diffusion limit is an important factor that interferes with the rate performance of a battery. The length of an effective Li+ pathway in the porous electrode plays an important role and increases as the areal loading increases. Several strategies have been proposed to address the problem of diffusion. Thinning the electrode is the primary means to increase the diffusion limited C-rate capability but at the cost of reducing the energy density of the battery. In addition, other approaches such as electrolyte engineering to improve ionic conduction, thermal modulation to promote Li⁺ transport and tortuosity reduction to shorten the path length at an electrode also suggest to promote Li⁺ transport in a battery. However, these strategies can be a trade-off in terms of electrochemical/thermal stability and the energy density.

Among various approaches, decreasing the effective Li⁺ transport length has the greatest impact on the diffusion limited C-rate. This is because the diffusion limited C-rate (DLC), which represents the maximum rate at which lithium-ions can diffuse through an electrode and electrolyte to participate in the electrochemical reaction, is expressed by Equation (1-1). The charge and discharge C-rate reaching DLC means that the Li⁺ concentration in the vicinity of the current collector reaches 0. DLC is inversely proportional to the square root of the effective electrode thickness (Equation (1-1)). In this example, in Equation (1-1), L denotes the electrode thickness. In addition, all symbols of the Equation (1-1) will be described in Supplementary item 1 described later. Operation beyond DLC results in depletion of Li⁺ at a certain depth in the electrode, and the active material beyond that point becomes unusable. In addition, a high charge and discharge C-rate increases polarization and reduces the anode potential to below the Li⁺/Li⁰ equilibrium potential. This may result in formation of metallic lithium (Li⁰) deposits known as Li⁰ deposition on the anode surface. Even in the best case scenario, these effects impair the deployable energy density, reversibility, and the life of the battery. In the worst case, thermal runaway or explosion of the battery may be caused.

$$DLC = \frac{2 zFDD {ε}^{γ} {c}_{{Li}^{+}}^{0}}{ωρ {Q}_{m} ( 1 - ε ) {L}^{2}} \qquad ( 1 ‐ 1 )$$

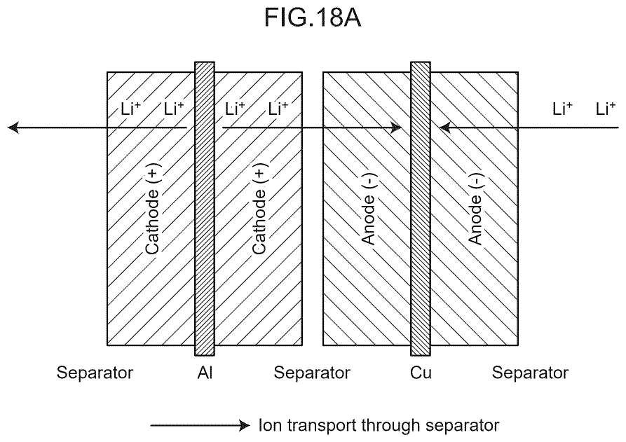

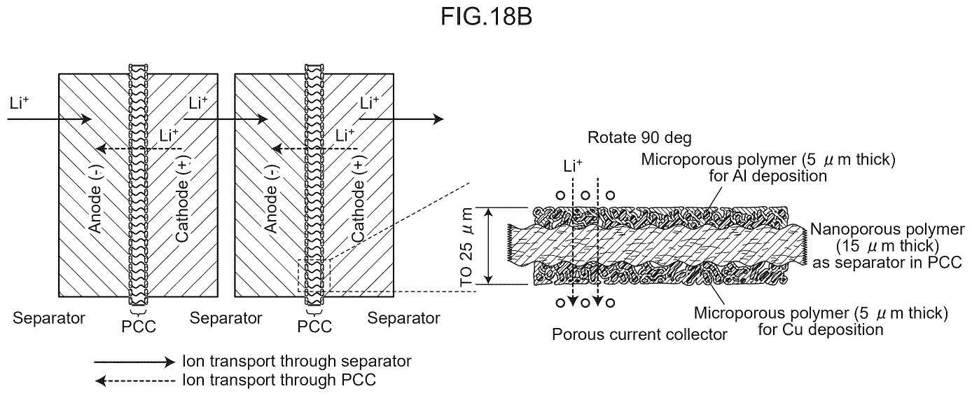

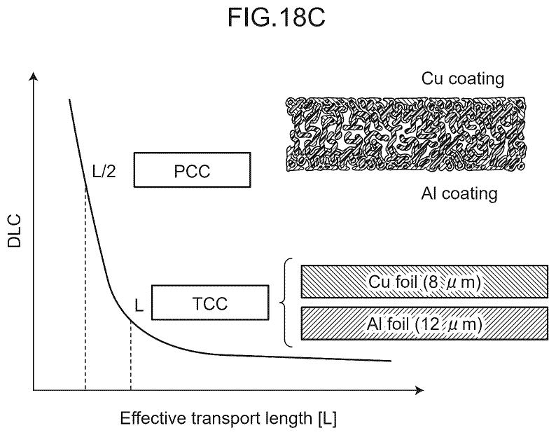

Current collectors (TCCs) such as solid metal foils of Cu or Al lack porosity and do not transport an electrolyte (FIG. 18A). As a result, these TCCs do not contribute to Li⁺ transport and limit Li⁺ transport between electrodes to only one direction.

FIGS. 18A to 18C are diagrams illustrating the design principle of a porous current collector in a battery. FIGS. 18A and 18B are diagrams illustrating multilayer pouch batteries with TCC (FIG. 18A) and PCC. In the case of TCC, the Li⁺ transport between electrodes is restricted to only one direction through the separator, as indicated by the black arrows in FIG. 18A. In the case of PCC, Li⁺ transport occurs simultaneously in both directions through both the PCC and the separator, as indicated by the green and black arrows in FIG. 18B. The enlarged view of FIG. 18B illustrates a schematic view of a PCC. The PCC consists of a stacked body of porous and hierarchical polymers coated with two types of metal on the surfaces, thereby forming a sandwich-like shape. FIG. 18C illustrates a conceptual comparison of diffusion limited C-rate in cells of TCC and PCC. By using the PCC, the effective Li⁺ transport path length becomes half of the TCC, and the diffusion-limited rate capability of the battery becomes four times the TCC.

This time, for a high energy battery (FIG. 18B), a thin (25 μm) porous current collector (PCC) capable of adjusting the transport of Li⁺ in both the current collector and the separator has been conceptualized for the first time. The current collector is composed of a matrix in which a porous and hierarchical polymers coated on both sides with cathode and anode conductive metals, each about 1.5 μm thick, thereby forming a sandwich-like shape. Comparing FIG. 18A and FIG. 18B, it can be seen that there is one important change in the configuration of the battery cells. The thickness of each electrode layer is the same for both TCC and PCC; however, the anode and cathode arrangement is modified from alternating every two layers (cathode/cathode/anode/anode) to alternating every one layer (cathode/anode/cathode/anode). This modification maintains the high energy density of the battery in both TCC and PCC cases. However, in the case of PCC, the effective Li⁺ transport path length is reduced to ½ of that of the battery configuration of TCC. As illustrated conceptually in FIG. 18C, this reduction in the effective diffusion length increases the diffusion limited C-rate by a factor of 4. A multilayer pouch cell with this PCC exhibits a specific energy of about 276 Wh/kg at full cell level with a high cathode areal loading of 3 mAh/cm². In addition, these batteries illustrate excellent diffusion limited C-rates reaching 4 C (15 min charge, SOC of 0 to 78.3%), 6 C (10 min charge, SOC of 0 to 70.5%), and 10 C (6 min charge, SOC of 0 to 54.3%). This new design uses thick electrodes for energy-dense batteries and makes it possible to achieve high diffusion limited C-rates.

### Proof of Concept of PCC by Numerical Simulation

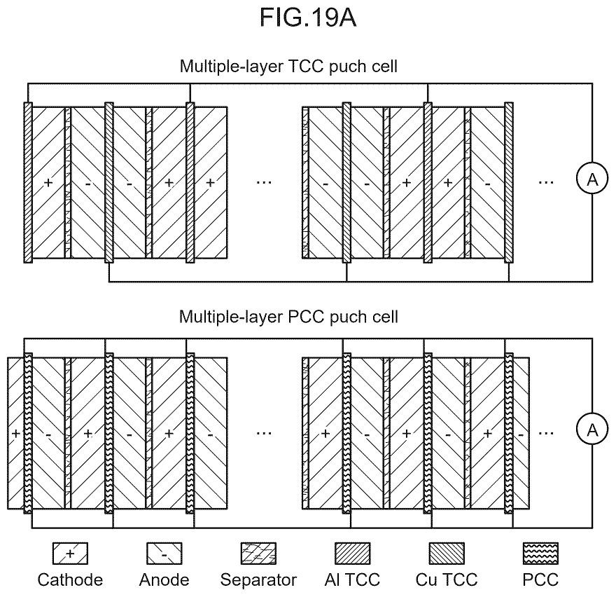

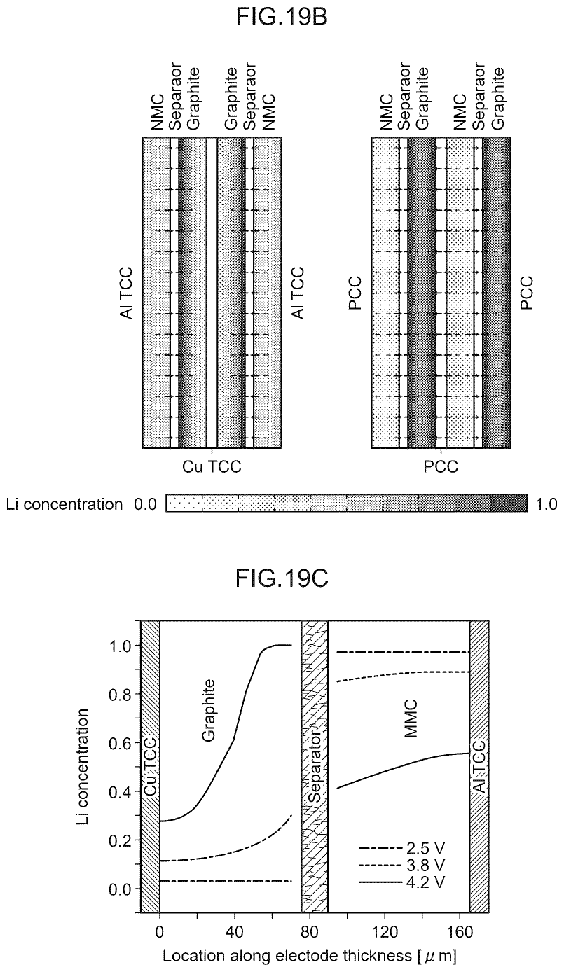

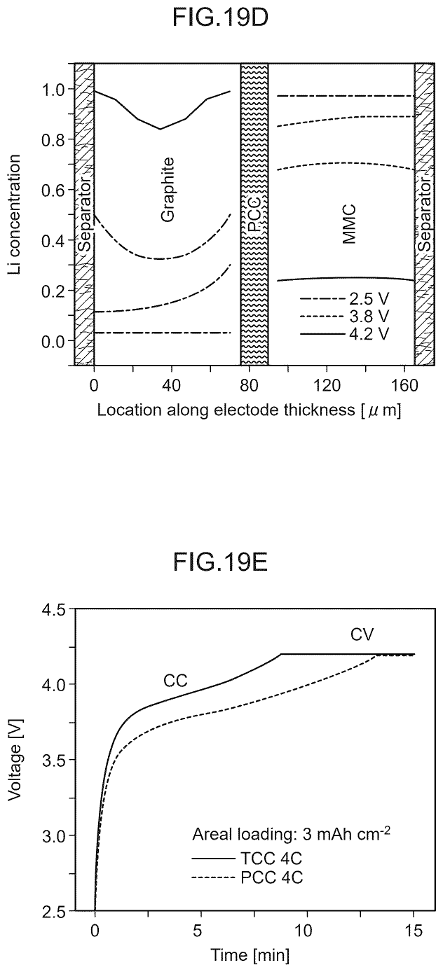

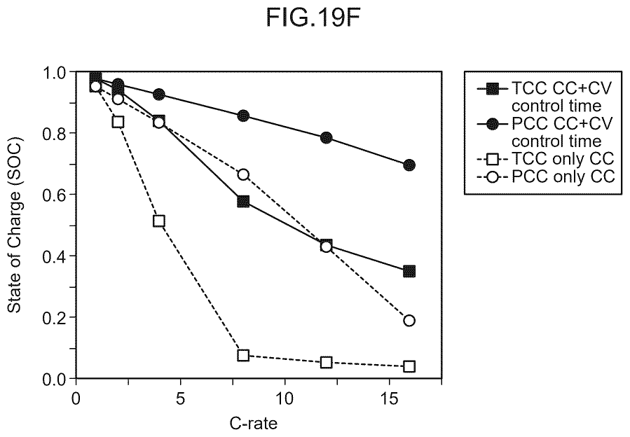

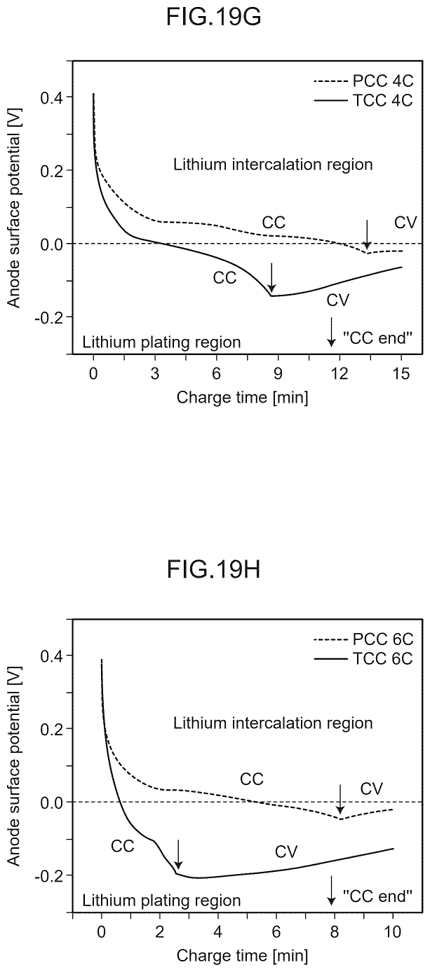

To illustrate the concept of PCC, a high energy battery consisting of lithium nickel manganese cobalt oxide (LiNi_{0.5}Mn_{0.3} Co_{0.2}O₂, NMC) as the anode and graphite as the cathode was selected. In order to better understand the electrochemical process during high-speed charging, first, numerical simulation was performed. In FIG. 19A, multilayer pouch batteries with TCC and PCC are illustrated, which illustrates the battery assembly configuration used in later demonstration and practical applications. In the experiment, constant-current charge at 4 C-rate (12 mA cm⁻², C-rate based on an NMC cathode with an areal loading of 3 mAh cm⁻²) was employed. The battery was charged to a cutoff voltage of 4.2 V and held at 4.2 V until the total charge time reached 15 minutes. FIG. 19B is a diagram illustrating the distribution of lithium concentration in the active material in two different battery configurations. Dark red indicates high lithium concentration, and dark blue indicates low lithium concentration.

In TCC, the lithium concentration of the TCC battery is quite non-uniform across the thickness of the electrode due to Li⁺ transport limitations. In the left diagram of FIG. 19B, it can be seen that the lithium concentration of the graphite particles near the separator is as high as about 1.0 and that the lithium concentration of the graphite particles away from the separator is as low as about 0.3. At the cathode, the NMC particles also exhibit non-uniform lithium concentrations ranging from 0.4 to 0.6. Previous studies (Yang, Y. et al. Adv. Energy Mater. 9, 1900674 (2019) . . . and Xu, R. et al. J. Mech. Phys. Solids 129, 160-183 (2019).) have shown that such non-uniform electrochemical processes in batteries damage the inside and interface of active material particles and irreversibly attenuate capacity in battery cycles.

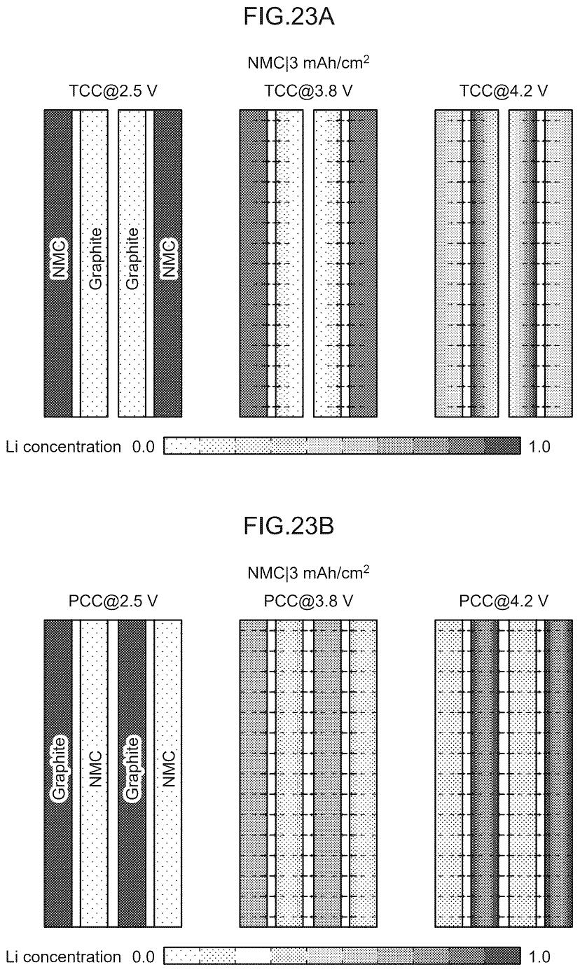

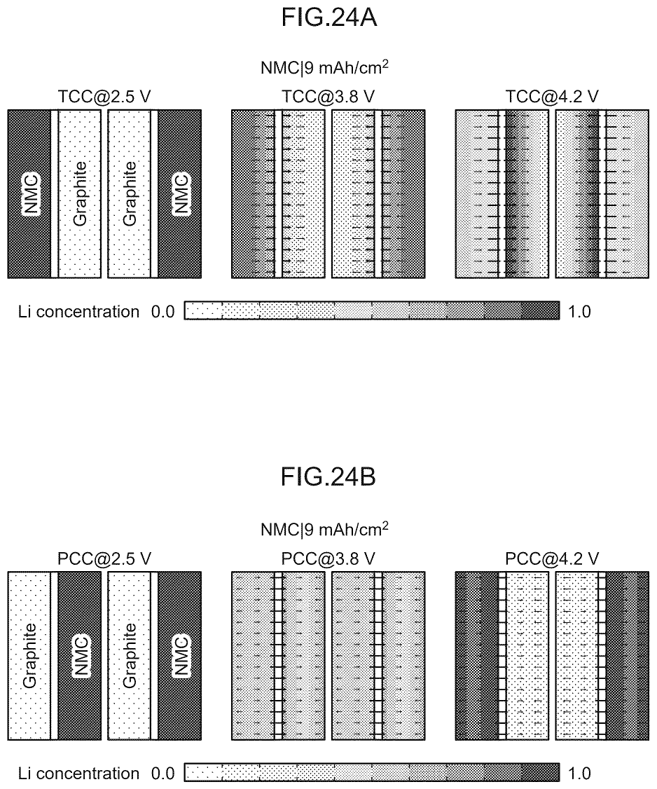

On the other hand, in PCC, Li⁺ ions can be transported through both the separator and PCC, which effectively reduces the effective transport length to ½ and significantly reduces the non-uniformity of lithium distribution. As illustrated in the right diagram of FIG. 19B, the lithium distribution in the graphite anode varies minimally from a fully lithiated state (lithium concentration of 1.0) at a lateral surface of the anode to an 80% lithiated state (lithium concentration of 0.8) at the center of the anode. At the same time, the lithium distribution in the NMC cathode is quite uniform, with a lithium concentration of about 0.34. It is noteworthy that due to the high tortuosity of the graphite anode, the distribution of Li ions in the NMC and graphite is different compared to that in the NMC cathode. As a result, the transport of Li ions is suppressed in the graphite anode, and the gradient of Li ion distribution becomes larger. The more uniform utilization of the active material in the battery with PCC can be observed in different states of charge (e.g.: 2.5 V, 3.8 V, and 4.2 V), as illustrated in FIGS. 19C, 19D, 23A, and 23B. In FIGS. 19C, 19D, 23A, and 23B, the distribution of lithium in the electrodes is plotted in the direction of the electrode thickness. It can be seen that, as a result, the battery with PCC has lower voltage bipolarization and larger available capacity compared to the battery with TCC (FIG. 19E). This difference in bipolarization and available capacity may be greater when charging at higher charge C-rates (FIG. 19F) or with thicker electrodes (9 mAh cm⁻², FIGS. 24A and 24B) is performed. FIG. 19F is a graph illustrating SOC simulations of TCC and PCC batteries in two different charging protocols. (1) When charged at a cutoff voltage of 4.2 V using a simple constant current (CC, dashed line) mode, the PCC battery showed a significantly higher SOC compared to the TCC pouch battery. The SOC of the PCC cell was most improved at a charge rate of 8 C. Above this rate, lithium depletion occurs. This depletion of lithium is similar to that observed for TCC; however, the charge C-rate is much lower than that in PCC. (2) It was observed that the SOC of the PCC battery was significantly higher than the SOC of the TCC battery when charged to a cutoff voltage of 4.2 V until a specific charge time was reached, using a combination of constant current constant voltage (CC-CV, solid line) modes. In the CC-CV charge mode at 4 C, the PCC cell can reach SOC 92.4% within 15 minutes. In the CC-CV charge mode at 8 C, the PCC cell can reach SOC 85.7% within 11.6 minutes.

FIGS. 19A to 19H are diagrams illustrating numerical simulation results of the batteries each having one of TCC and PCC. FIG. 19A illustrates multilayer pouch cell configurations each with one of TCC and PCC. FIG. 19B illustrates a lithium concentration map of electrodes of two battery units each having one of TCC and PCC when charged at a cutoff voltage of 4.2 V. FIGS. 19C and 19D are diagrams illustrating the lithium concentration distribution in the electrode thickness direction at different charging voltages (2.5 V, 3.8 V, and 4.2 V) for a TCC battery. FIG. 19D is a diagram illustrating the lithium concentration distribution in the electrode thickness direction at different charging voltages (2.5 V, 3.8 V, and 4.2 V) for a PCC battery. FIG. 19E is a graph illustrating charging curves of the TCC and PCC batteries at 4 C when the total charge time was adjusted to 15 minutes. FIG. 19F is a graph illustrating the normalized capacity of batteries with TCC and PCC with different charging protocols. FIGS. 19G and 19H are graphs illustrating the change in the electrode potential Ect at the anode surface near the separator when charged at 4 C and 6 C, respectively.

Another challenge in quick charging of batteries is the possibility of occurrence of Li⁰ precipitation, which often starts at the surface of the graphite particles of the anode due to the non-uniform utilization of the graphite of the anode. During quick charging, graphite particles near the separator rapidly reach a high SOC of 1.0, which may lead to early Li⁰ deposition. The anode electrode potential is expressed as E_{ct}=ηᵢₙₜ+E_{eq}. In this example, mint denotes the overvoltage with respect to intercalation of Li⁺ into graphite. E_{eq} denotes the equilibrium potential for Li intercalation into graphite. During high-speed charging, the graphite particles near the separator rapidly reach SOC of 100%, and thus E_{eq} drops to 0, resulting in E_{ct} lower than 0, which can lead to Li⁰ deposition on the surface of the graphite particles.

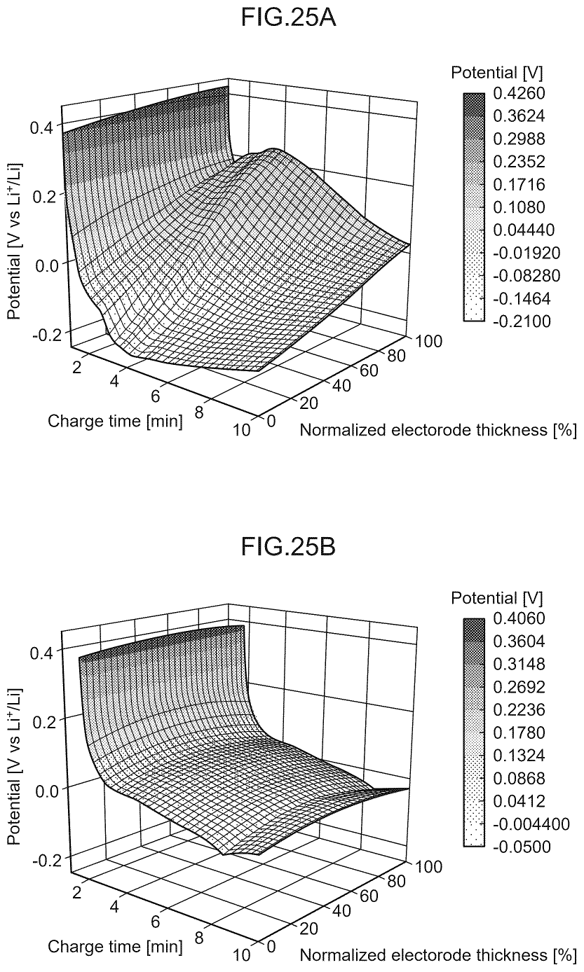

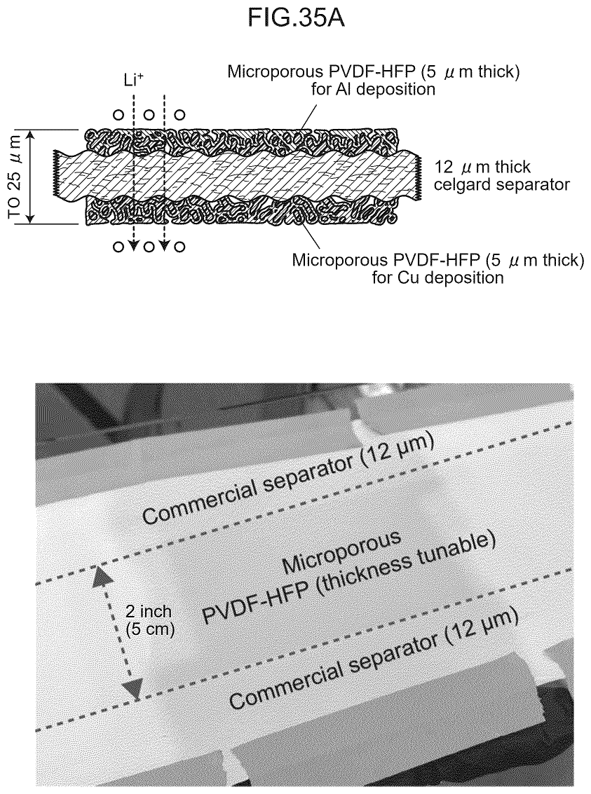

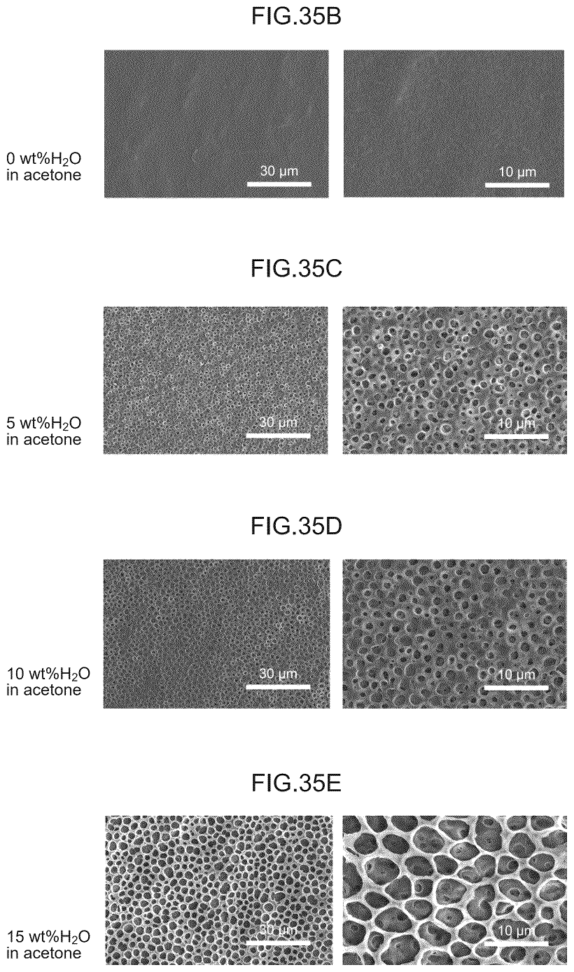

To quantitatively compare the likelihood of Li deposition in batteries with TCC and PCC, the evolution of E_{ct} at the anode surface near the cathode was analyzed (FIGS. 19G and 19H). In both the TCC and PCC batteries, it was observed that E_{ct} gradually decreased to lower values, with the lowest value appearing at the end of CC charging. In the TCC battery, in the cases of charge C-rates of 4 C and 6 C, the lowest values of E_{ct} were about-0.143 V and about-0.209 V, respectively, which indicates that Li⁰ deposition inevitably occurs during quick charging. On the other hand, in the PCC battery, E_{ct} is only −0.029 V at the charge C-rate of 4 C and −0.049 V at 6 C, which is lower than the overvoltage required for nucleation of Li⁰ on the surfaces of the graphite particles. Furthermore, as illustrated in the spatial distribution of the graphite anode potential at the charge rate of 4 C, the anode of the PCC battery shows a more uniform distribution in the thickness direction of the graphite electrode than the TCC battery does (FIGS. 25A and 35B). Therefore, a battery having PCC is expected to have high resistance to Li⁰ deposition and to improve safety during quick charging.

### Design and Manufacture of PCC

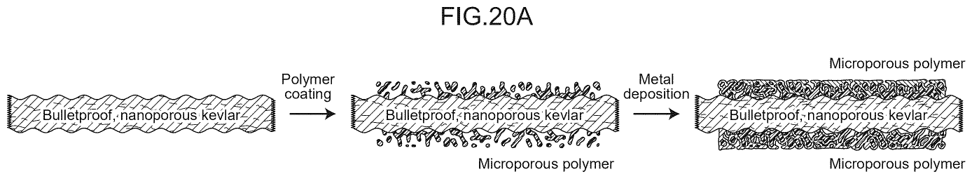

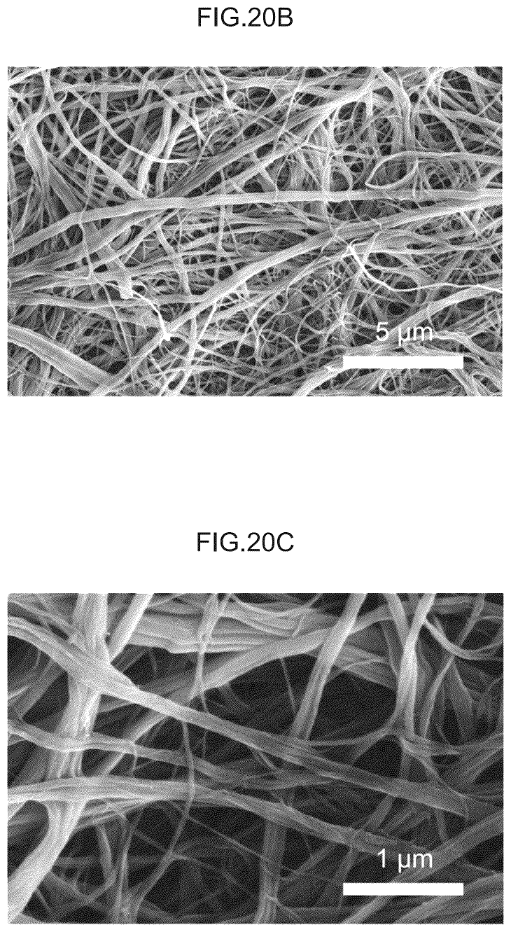

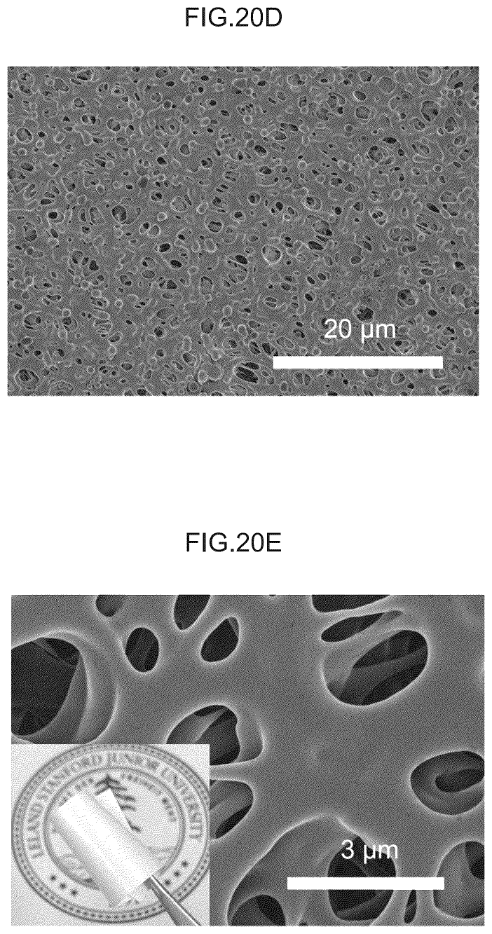

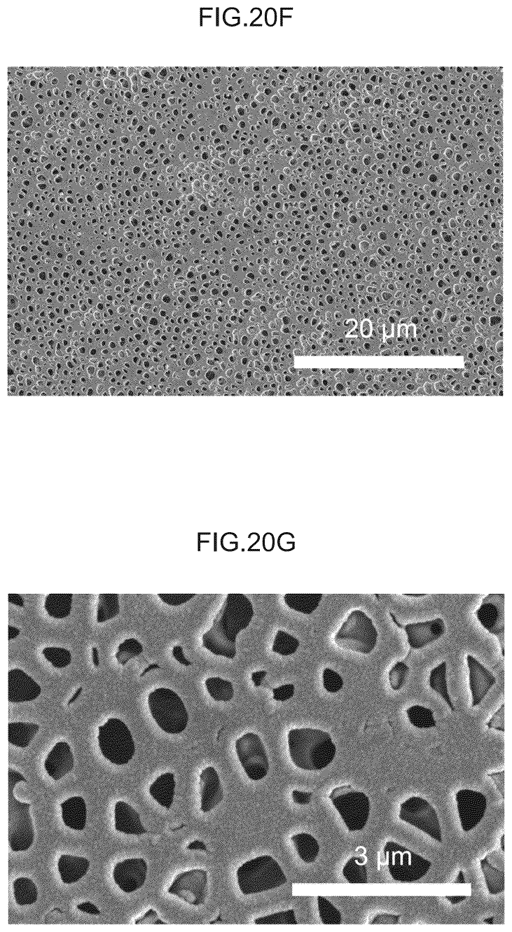

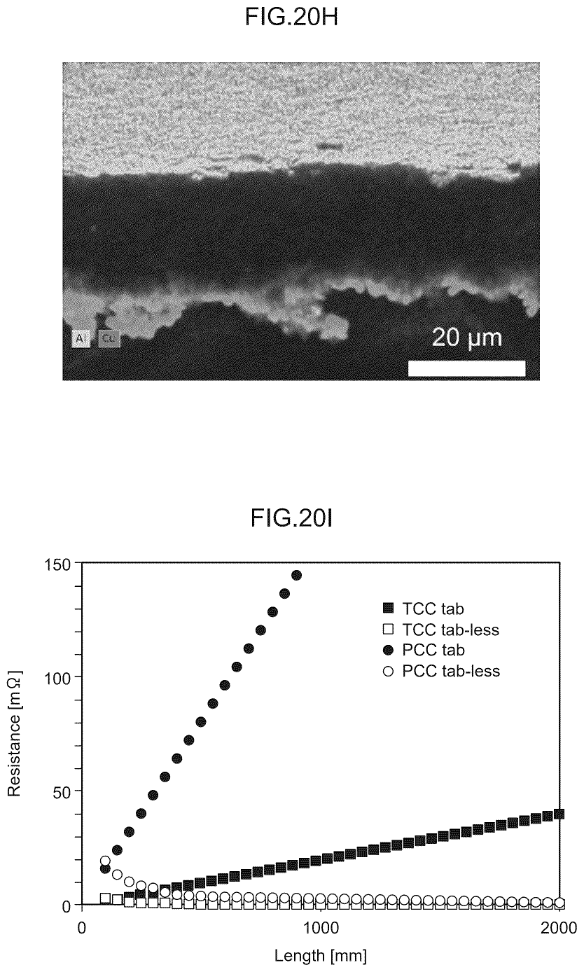

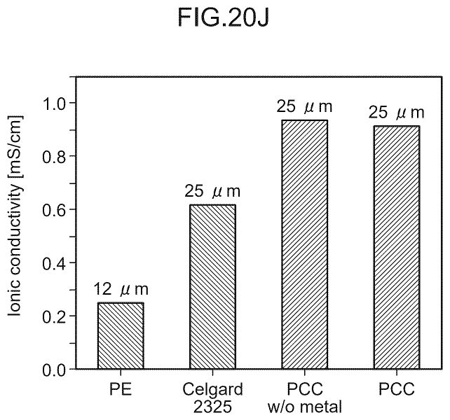

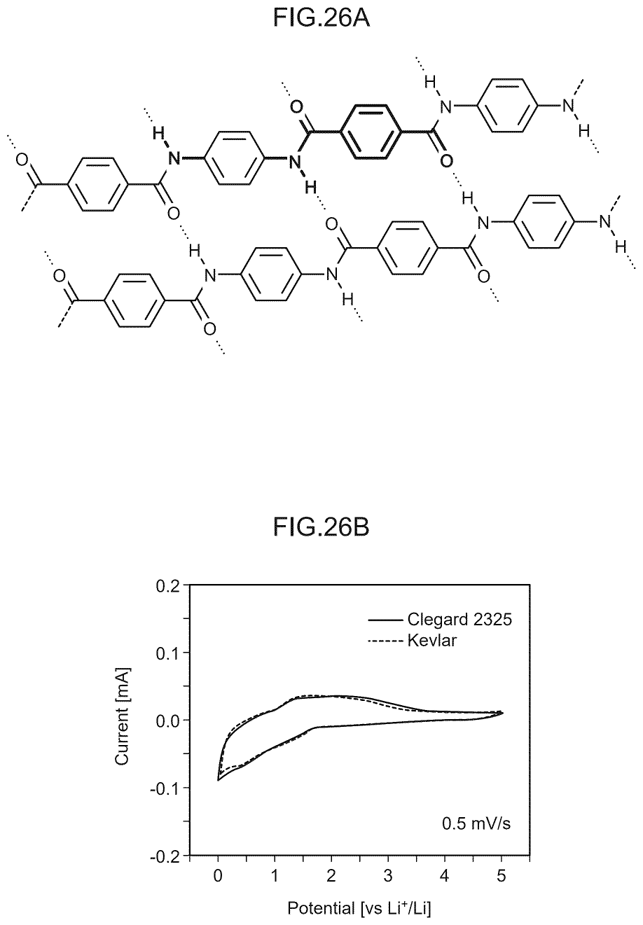

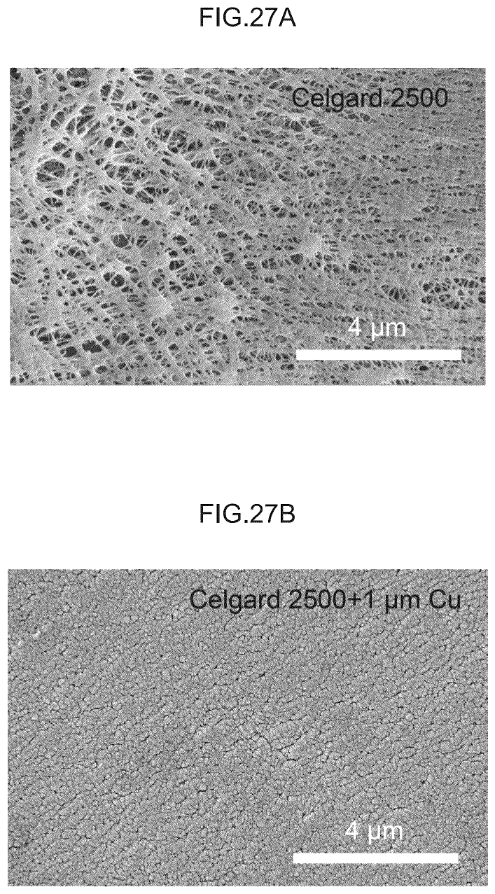

Based on the initial analysis, it was determined that a PCC design with integrated functions of the current collector (both cathode and anode) and the separator was needed to achieve the goal. Therefore, a hierarchical porous PCC (FIG. 20A) having a three-layer structure was developed. In order to ensure excellent electrochemical stability (FIGS. 26A and 26B) and good mechanical properties, a bulletproof, thin, and nanoporous Kevlar film (FIGS. 20B and 20C, average pore diameter: 500 nm, porosity: 65%, thickness: 15 μm) was used as the main substrate of the separator. Kevlar is one of the most potent polymers and is often used as a body armor due to its bulletproof properties and is suitable for use in current collectors. Furthermore, Kevlar separates the two electrodes and prevents potential electrical shorts during battery operation. Then, both sides of the Kevlar film were coated with a microporous polymer layer (about 5 μm) by a phase separation method (see the section of the manufacturing method). The pore diameter of the surface coating layer was optimized to be about 3 μm to 4 μm to meet criteria for both good electrolyte permeability and subsequent thickening of the metal coating (FIGS. 20D and 20E). If the pore diameter is too small, metal coating may block the pore structure and impede the transport of Lit (FIGS. 27A and 27B).

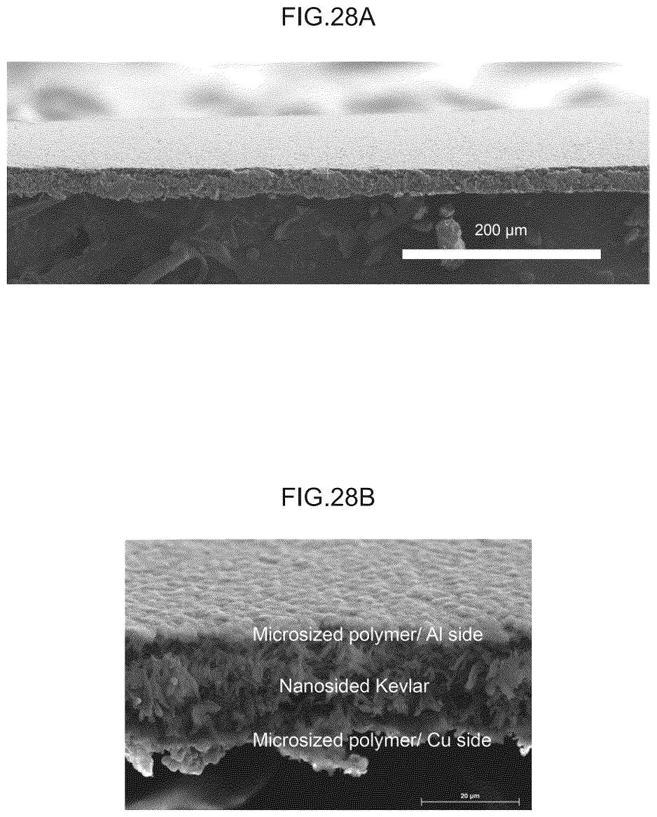

FIGS. 20A to 20J are diagrams illustrating the main design concept of PCC and characteristics thereof. FIG. 20A is a schematic diagram of a PCC manufacturing process. FIGS. 20B to 20G are SEM images. FIGS. 20B and 20C are SEM images illustrating the form of a bulletproof Kevlar film. FIGS. 20D and 20E are SEM images illustrating the form of a PCC matrix. FIGS. 20F and 20G are SEM images illustrating the form of a PCC. The image illustrated in FIG. 20E is a digital image of the PCC matrix. FIG. 20H is an energy dispersive X-ray spectroscopic image illustrating the distribution of metal in the thickness direction of the PCC (SEM images are illustrated in FIGS. 28A and 28B). FIG. 20I is a graph illustrating variations in the current collecting resistance depending on the length. FIG. 20J is a graph illustrating a comparison of ionic conductivities of a commercially available separator, the PCC matrix, and the PCC.

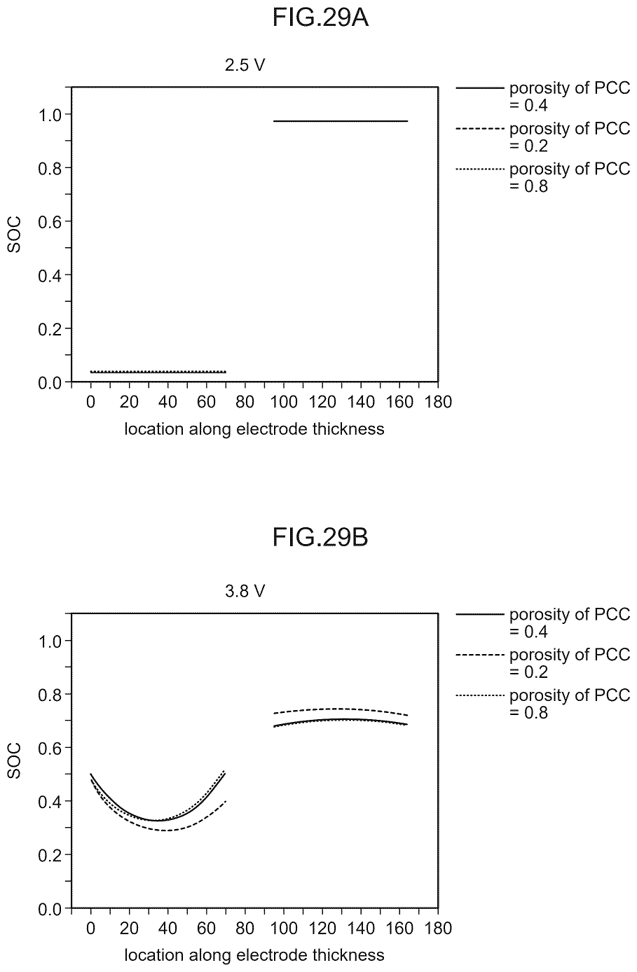

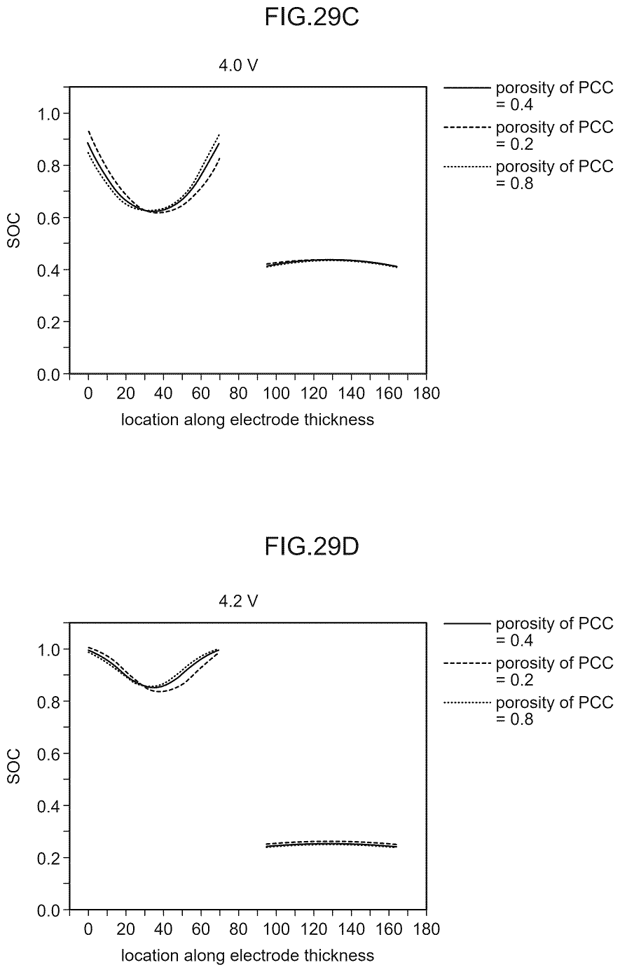

Next, each side of the above-described composite PCC matrix was coated with metal Cu and Al. By applying metal coating having a sufficient thickness, the influence of the electrical conductivity on the cell resistance becomes negligible. The metal coating thickness was optimized to 1.5 μm to ensure high electrical conductivity of the PCC. The metal coating maintains the submicron pore diameter of the surface layer and allows rapid permeation of the electrolyte through the PCC (FIGS. 20F and 20G). Due to the tortuosity of the microporous polymer coated on the Kevlar, the conductive metals cover only the surface layers, as seen in the cross-sectional SEM images (FIGS. 28A and 28B) and the energy dispersive X-ray spectroscopic image (FIG. 20H). Therefore, there is no electronic connection between the electrodes located on both sides of the PCC, and the Kevlar layer in the middle remains unblocked by the metals. The porosity of PCC plays an important role in various aspects of battery performance, such as electron conductivity, ion conductivity, mechanical stability, thermal behavior, and electrochemical performance (FIGS. 29A to 29D).

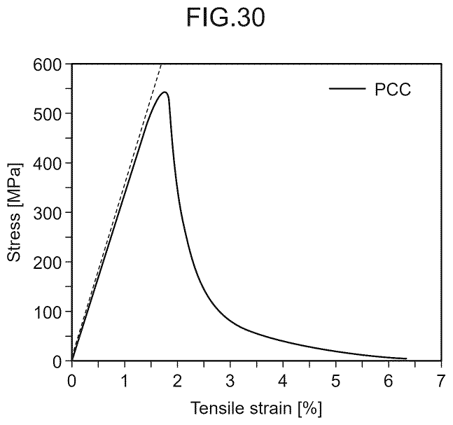

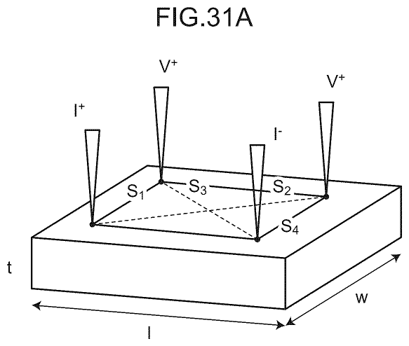

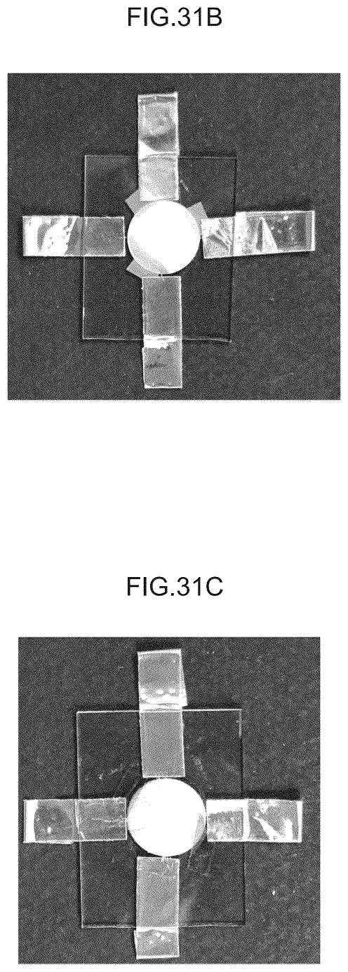

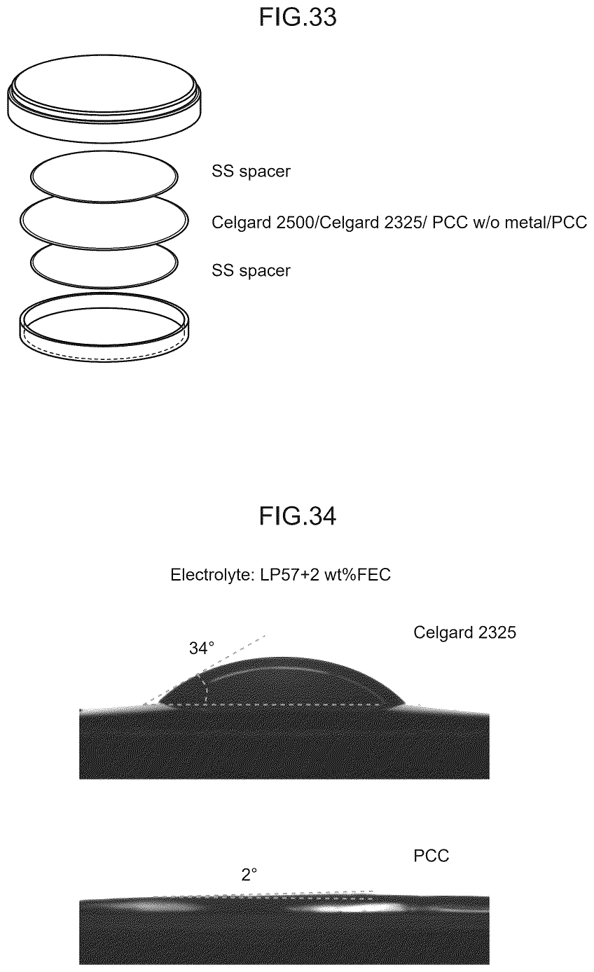

Compared with a TCC using a Cu foil (about 120 GPa) or an Al foil (about 70 GPa), the PCC exhibited a high Young's modulus of 35.3 GPa (FIG. 30) and a high electron conductivity of 4.67×10⁷ S/m (FIGS. 31A to 31C). Electrical calculations of the design of a battery with two PCCs, including welding and tab-less configurations, were also performed (FIGS. 201 and 33). The tab-less configuration effectively reduces the resistance of the current collector in a 18650-type cell (3 Ah). In a PCC cell of tab-less design, it was possible to achieve a resistance of less than or equal to 10 mΩ for a current collector having a length within a practical range (800 nm to 1000 nm).

To evaluate the electrolyte permeability of the PCC, ionic conductivity was compared through a blocking cell obtained by assembling different porous films including polyethylene (PE, Celgard 2500), a three-layer polyolefin separator (Celgard 2325), a three-layer PCC polymer matrix (PCC w/o metal), and a PCC (FIG. 20J and FIG. 33). 1 mol/L of LiPF₆ contained in a mixture of ethylene carbonate and ethyl methyl carbonate (volume ratio 3:7) added with 2 wt % fluoroethylene carbonate was used as an electrolyte. Both PCC w/o metal (0.942 mS/cm) and PCC (0.918 mS/cm) were found to exhibit much higher ionic conductivity compared to the commercially available polyethylene (0.254 mS/cm) and Celgard 2325 (0.62 mS/cm) separators. In the manufacturing of PCCs, the ionic conductivity of the porous current collector was only slightly reduced after metal coating. This is due to several factors. (1) The porosity of the PCC is well retained even after metal coating, which allows high-speed ion transport and ensures high ion conductivity. (2) The metal coating minimizes the impact on the flexibility of the pores, thereby maintaining the ion transport pathway. (3) The electrolyte affinity of the PCC promotes electrolyte redistribution within the PCC and minimizes the reduction in the ionic conductivity. In addition, the contact angle (about) 2° between the PCC and the electrolytic solution is much smaller than the contact angle (about) 34° between the commercially available separator (Celgard 2325) and the electrolytic solution, and the electrolyte affinity of the PCC has been demonstrated (FIG. 34).

Compared to a battery configuration using a solid foil (Cu having a thickness of 8 μm has an areal weight of 7.2 mg/cm², and Al having a thickness of 12 μm has an areal weight of 3.2 mg/cm²) as the current collector, the PCC design can significantly reduce the areal weight of the current collector to 2.2 mg/cm², potentially reducing the “dead weight” of the battery by about 8% at the full cell level. It is also worth mentioning that the new PCC concept is a universal design that can be used with a variety of materials of choice. To configure this hierarchical PCC, it was possible to combine various types of conductive coating (carbon nanotube, porous metal film, etc.) and porous films (such as commercially available separators and poly(vinylidene fluoride-co-hexafluoropropylene)) (FIGS. 35A to 35E).

### Ultra-High-Speed Charging Capability of PCC Multilayer Pouch Cell

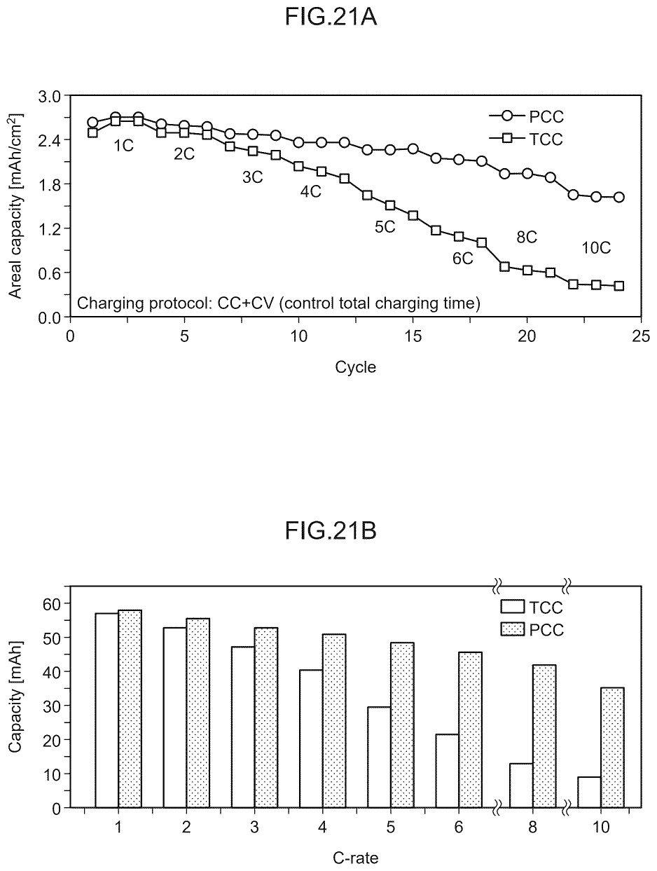

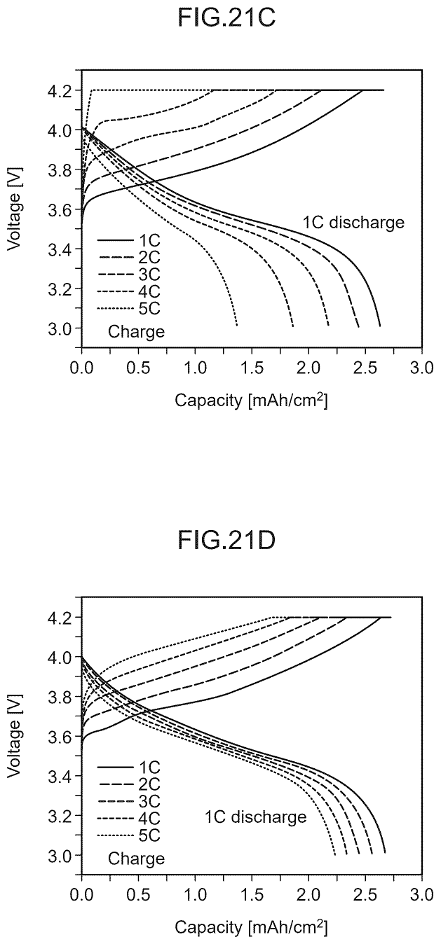

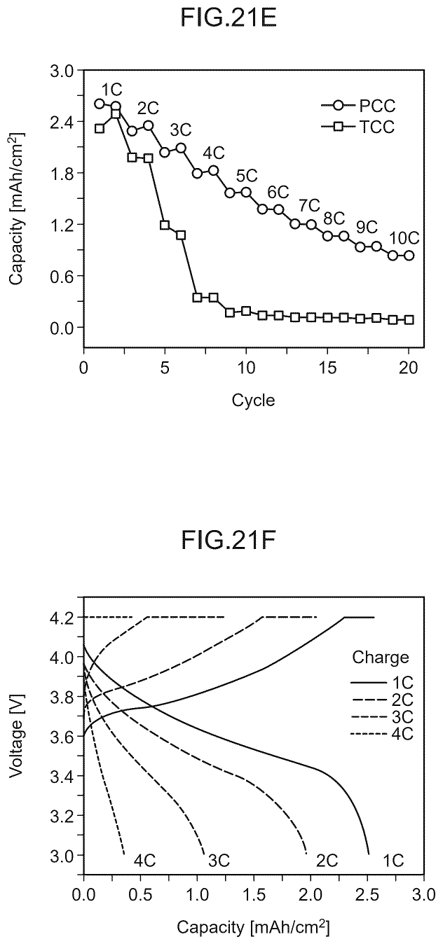

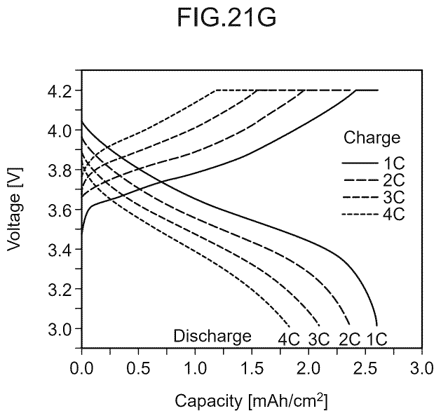

FIGS. 21A to 21G are graphs illustrating electrochemical performance of the multilayer pouch batteries each having one of TCC and PCC. FIG. 21A is a graph illustrating the rate performance of the multilayer pouch batteries each having one of TCC and PCC. FIG. 21B is a graph illustrating a comparison of the available capacity of the pouch batteries after charging in a rate range of 1 C to 10 C by adjusting the overall CC-CV charge time. FIGS. 21C and 21D are graphs illustrating charge and discharge curves of pouch batteries using TCC (FIG. 21C) and PCC (FIG. 21D). In this example, the cells are charged at different rates and discharged at a C-rate of 1 C to a cutoff voltage of 3 V. FIG. 21E is a graph illustrating a comparison of high-speed charge and high-speed discharge capacity of TCC and PCC pouch cells from 1 C to 10 C. FIGS. 21F and 21G are graphs illustrating charge and discharge curves of the pouch cells using TCC (FIG. 21F) and PCC (FIG. 21G) in a high-speed charge and discharge protocol.

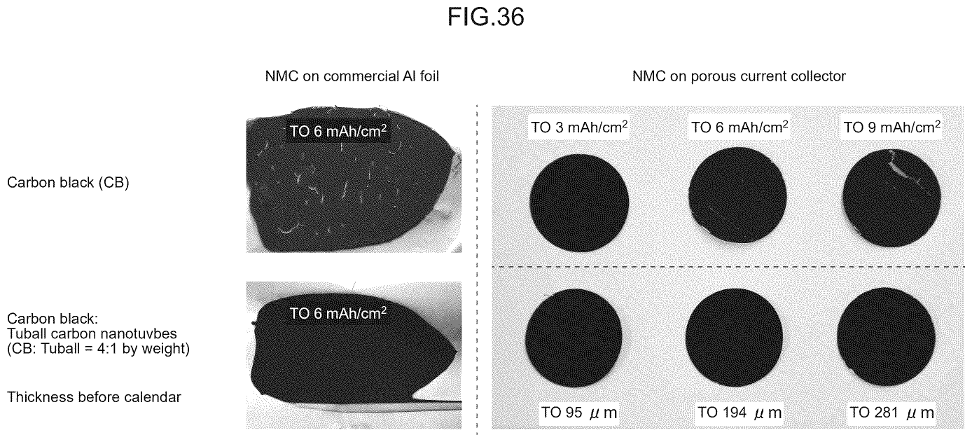

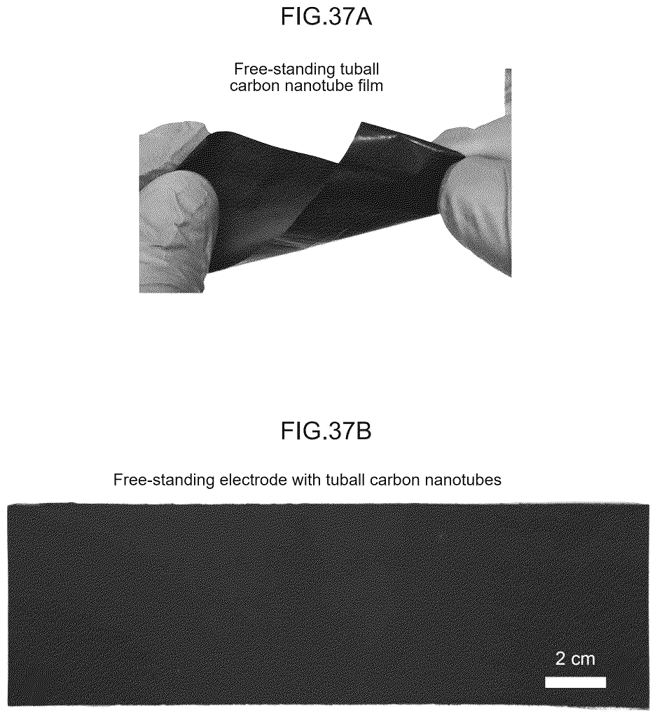

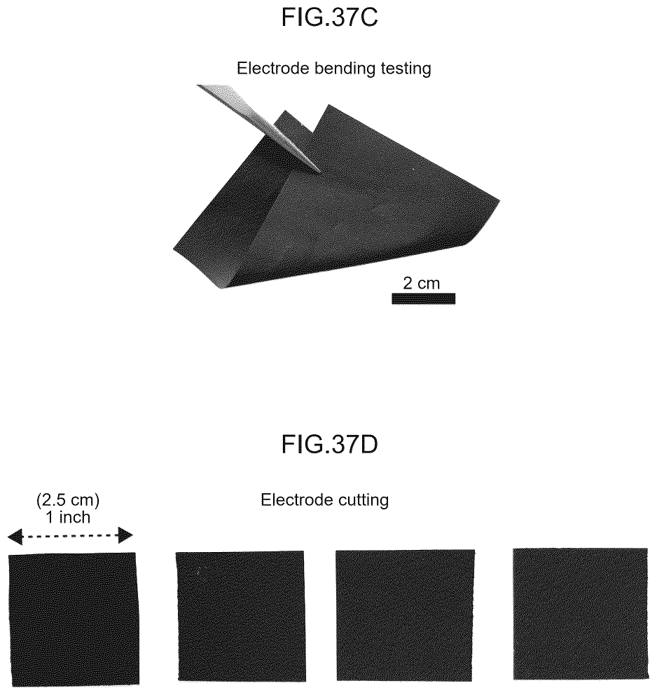

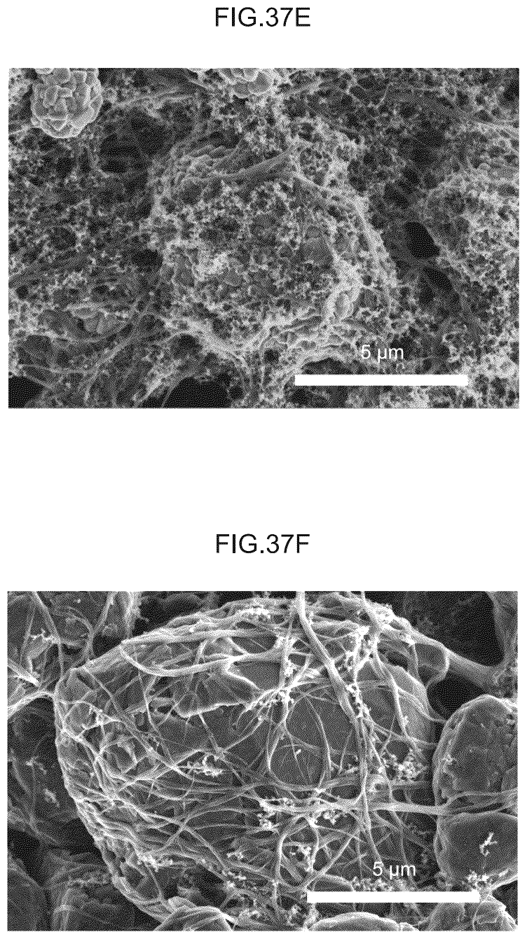

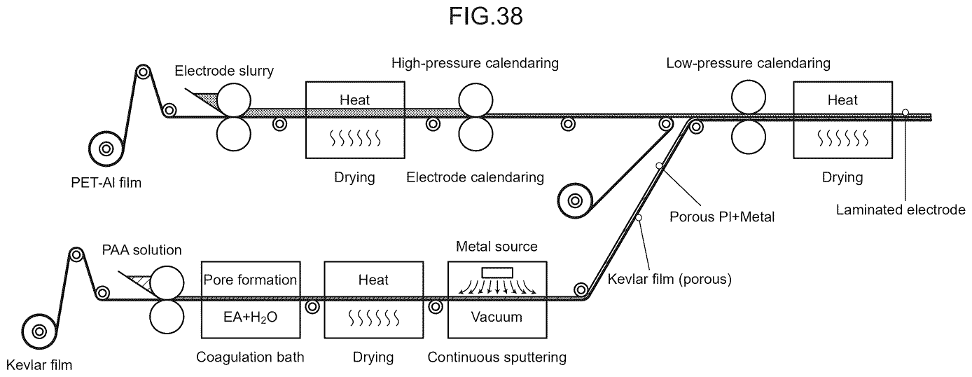

To prepare a pouch battery with PCC, segregated Tuball (registered trademark) carbon nanotubes were incorporated into a thick electrode, whereby high stability was achieved (FIG. 36 and FIG. 37A to FIG. 37F). These segregated mesh-shaped structure contributes to formation of crack-free electrodes with high areal capacities of 3 mAh cm⁻² to 9 mAh cm⁻². Next, the resulting electrodes were subjected to calendaring with either TCC or PCC (FIG. 38) to assemble a multilayer pouch cell. These batteries with a negative/cathode capacity ratio of 1.1 were combined with a Celgard 2325 separator and the aforementioned electrolyte and sealed in an aluminum plastic film. Due to the large areal loading (3 mAh cm⁻²) and the reduced weight of the current collector, large-sized PCC pouch batteries can achieve a specific energy density of about 276 Wh/kg (Supplemental item 2). To evaluate the rate performance, an optimized CC-CV protocol was used in which the total charge time of CC and CV reached a certain value (1 hour for 1 C, 30 minutes for 2 C, etc.) on the basis of the charge rate. This protocol is an alternative to a general charging protocol that uses the CC-CV mode with a cutoff current of 0.5 C held at 4.2 V as discussed in the article (Song, M. & Choe, S.-Y. J. Power Sources 436, 226835 (2019)).

FIG. 21A is a graph illustrating the surface discharge capacity of the pouch cell at 1 C after charging at various C-rates from 1 C (1 hour charge) to 10 C (6 minutes charge). The available capacities after quick charging at different C-rates were examined and the battery was fully discharged to 3.0 V at 1 C to remove the impact of potential “dead capacity”, and the discharge capacities were compared. After charging at 1 C, the deliverable discharge capacities of the TCC and PCC pouch batteries were very similar, indicating that lithium-ion transport is fast enough to participate in the electrochemical reaction in both battery configurations. However, as the charge C-rate increases, the capacity of the TCC pouch cell decreases rapidly. When the charge C-rate is greater than or equal to 3 C (20 minutes charge), consumption of lithium becomes severe, and the capacity significantly decreases. Even with the same high charge C-rate cycles, the available discharge capacity in the case of TCC continues to decrease due to the occurrence of irreversible capacity. This decrease in effective capacity is mainly due to Li⁰ deposition caused by a large overvoltage, generating “dead lithium”, forming reversible SEI, and sacrificing effective capacity. In contrast, the PCC shows much higher and more stable capacity at higher charge C-rates compared to the TCC. As illustrated in FIG. 21B, the capacities of the PCC pouch cell at 4 C (15 min charge), 6 C (10 min charge), and 10 C (6 min charge) were SOCs of 78.3% (62.3% for TCC), 70.5% (33.4% for TCC), and 54.3% (13.8% for TCC), respectively.

FIGS. 21C and 21D are graphs illustrating charge and discharge curves of the multilayer pouch batteries with TCC and PCC. As also confirmed in the numerical simulation of FIG. 19E, the CC charge portion of the pouch battery with PCC is much longer than in the case with TCC due to significant intervention of the polarization of electrolyte concentration. The long CC charge portion is an important indicator of the quick charging capability as it can contribute to a larger capacity. Therefore, the use of the PCC significantly increases the available capacity. As the charge C-rate increases from 1 C to 5 C, the capacity of the TCC pouch battery decreases exponentially, indicating rapid depletion of Li⁺ at a certain electrode, beyond which the active material is no longer available. On the other hand, in the case of the PCC, a substantially linear attenuation tendency is shown, and it is suggested that material transport does not significantly affect the rate behavior at 5 C or lower. However, it is shown that the attenuation rate of the capacity of the PCC cell accelerates and that the depletion level of lithium increases when the charge C-rate exceeds 5 C. At higher charge C-rates (>10 C), it is expected to observe a rapid capacity attenuation due to a variety of factors including, in particular, bipolarization of increased concentration and particle fracture.

Halving the effective Li⁺ transport path length can also be expected for the high-speed discharge capability of the multilayer battery. Therefore, after the above-described optimized CC-CV charging mode, a high-speed discharge performance test with a C-rate range of 1 C to 10 C was performed using a cutoff voltage of 3.0 V. As illustrated in FIG. 21E, the TCC pouch battery can obtain only limited capacity at a high discharge rate of 4 C after full charge (15 min charge) at 4 C. In this process, both the charge resistance and the lithium-ion transport rate contributed to a large overvoltage, sacrificing capacity in the case of the TCC. In contrast, the PCC pouch battery showed a much lower attenuation rate. Even at 5 C discharge, the discharge capacity of the PCC was 52.2% even after 5 C charge (12 minutes charge). FIG. 21F and FIG. 21G are graphs illustrating charge and discharge curves of the multilayer pouch batteries with TCC and PCC in a high-speed discharge scenario. The overvoltage in the case of PCC is much smaller than that in the case of TCC, which is reflected in the position of the charge and discharge plateau at the same charge and discharge C-rate.

### Increase in Li⁰ Deposition Resistance in PCC Pouch Cell Revealed by Differential Pressure Sensing

As described above, when charging at an extremely high rate, the Li⁺ intercalation potential may be lower than the Li/Li⁺ equilibrium potential due to a large overvoltage. As a result, Li⁰ is deposited on the anode surface. The presence of the deposited lithium can react violently with the electrolyte, resulting in formation of “dead lithium”, reduced coulombic efficiency, and rapid loss of the capacity. In addition, Li⁰ dendrite can penetrate the separator to cause internal short circuits, thereby posing a serious safety risk. Note that it has become possible to demonstrate differential pressure sensing technology for accurately monitoring Li⁰ deposition during quick charging. By measuring the real-time change in the cell pressure per unit charge (dP/dQ) and comparing the change to a threshold defined on the basis of the maximum value of dP/dQ during Li⁺ intercalation to the anode, Li⁰ deposition can be captured before it grows extensively. To better understand how the PCC affects Li⁰ deposition during high-speed charging, multilayer NMC/graphite pouch cells were combined with the differential pressure sensing. This makes it possible to monitor Li⁰ deposition in real time during driving.

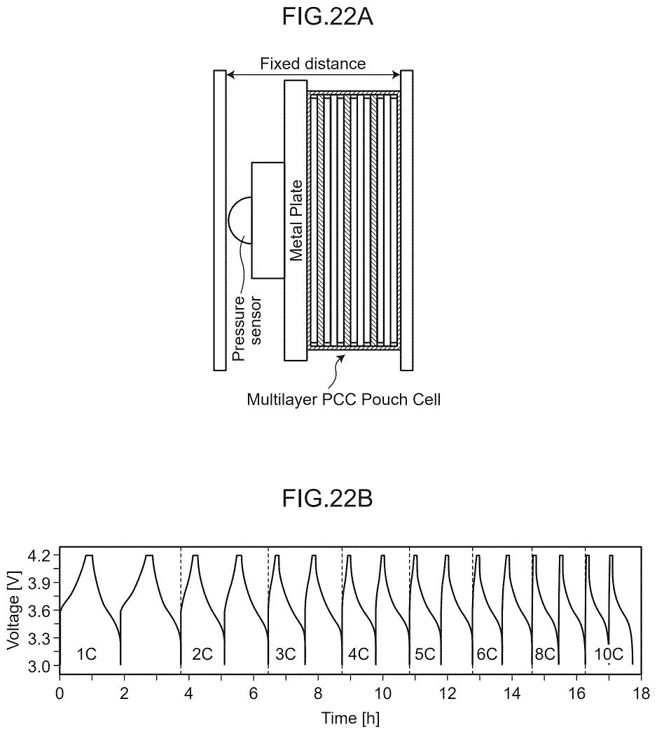

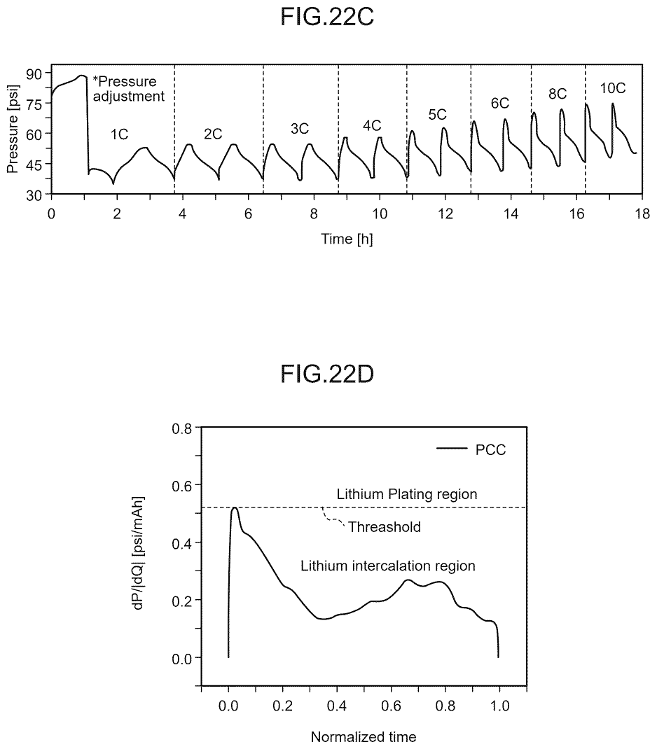

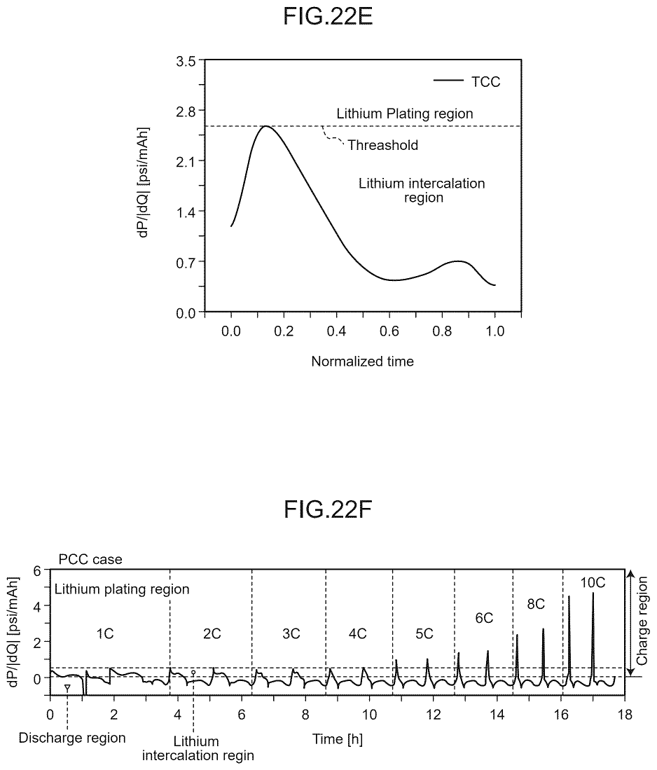

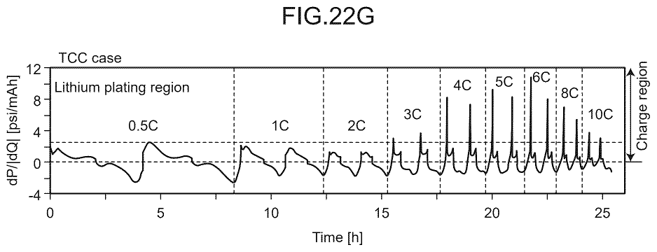

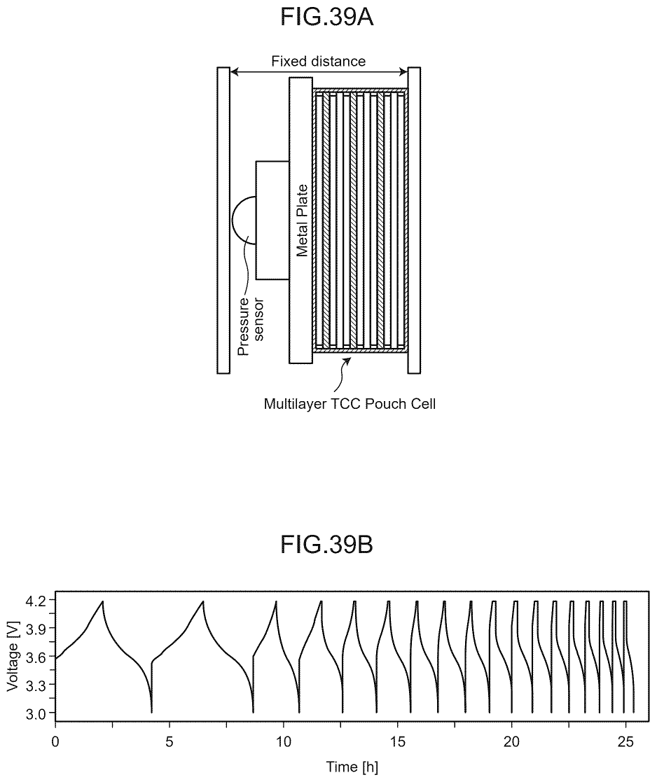

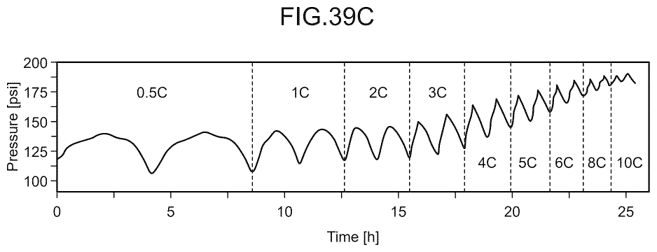

Multi-layered PCC and TCC pouch cells were assembled and activated for two cycles at first at a C/20 rate. Then, the cell was stacked with wooden force distribution plates and a pressure sensor, and clamped by a vise having a fixed thickness (FIG. 22A and FIG. 39A). Then, the total CC-CV time was adjusted to charge the cell using the aforementioned optimal CC-CV protocol, and the cell was discharged at 1 C until a voltage of 3.0 V was reached (FIG. 22B and FIG. 39B). In this process, the real-time cell pressure was recorded simultaneously (FIG. 22C and FIG. 39C). The change in the pressure behavior correlates with the charge and discharge behavior of the pouch battery, and is mainly governed by the volume change of graphite. The base pressure, namely the pressure after complete discharge, serves as an indirect indicator of Li⁰ deposition. The formation of “dead Li” and residual SEI increases the irreversible thickness of the anode, which results in an increase in the residual pressure after each cycle. The base pressures of the TCC and PCC pouch batteries were stable below 2 C and 5 C, respectively, which suggests no Li⁰ deposition. However, as the base pressure increases (>2 C in TCC and >5 C in PCC) as the charge and discharge C-rate further increases, it was shown that residual SEI and “dead lithium” were formed and accumulated as a result of Li⁰ deposition.

FIGS. 22A to 22G are diagrams illustrating differential pressure sensing indicating deposition of Li⁰ during quick charging. FIG. 22A is a diagram illustrating the configuration of operando pressure measurement for a multilayer pouch cell during ultrahigh-speed charging. FIGS. 22B and 22C are graphs illustrating a charge and discharge curve (FIG. 22B) and the pressure change (FIG. 22C) of an NMC|graphite multilayer pouch cell with PCC cycled at charge and discharge C-rates in the range of 1 C to 10 C. The pressure fluctuations in the first cycle are caused by the initial pressure regulation; however, this does not affect the derivative dP/dQ and therefore does not affect the subsequent pressure response. FIGS. 22D and 22E are dP/dQ profiles of batteries charged at a slow charge rate to establish a threshold for Li⁰ deposition in PCC (FIG. 22D) and TCC (FIG. 22E) batteries. The profile exceeded the threshold (broken line), which indicates that Li⁰ was deposited. FIGS. 22F and 22G are dP/dQ profiles of PCC (FIG. 22F) and TCC (FIG. 22G) cells charged at different charge and discharge C-rates. All discharge protocols are set to 1 C with the cutoff voltage of 3.0 V. To process the dP/|dQ| data, the resting time after charge and discharge was excluded from the data analysis.

Further analysis was performed to study the Li⁰ deposition behavior, and the differential pressures dP/|dQ| of the TCC and PCC pouch batteries were plotted (FIGS. 22D and 22E). The threshold at which Li⁰ precipitates was determined by selecting the maximum value of dP/dQ observed at low charge and discharge C-rates. Since the SOCs after charging were similar, the maximum values of dP/dQ determined at 1 C for PCC and 0.5 C for TCC were selected. The resting time after charge and discharge was excluded from the data analysis.

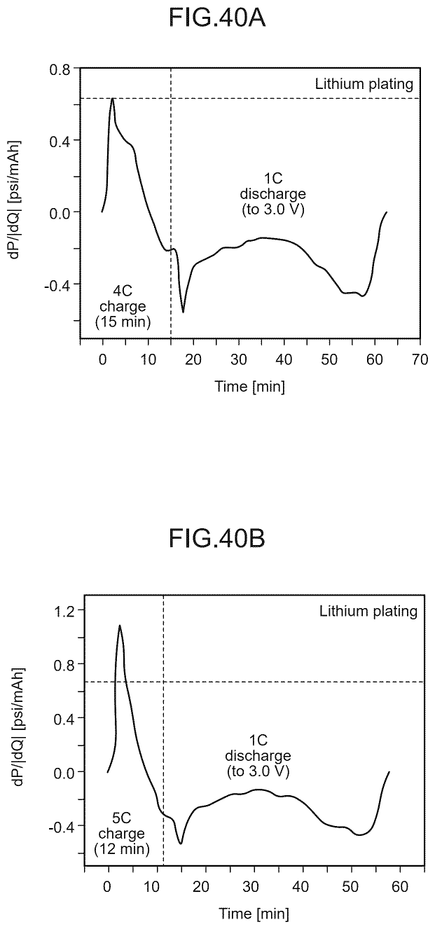

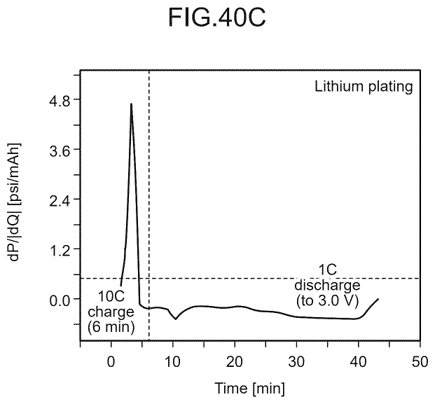

From the charge rates of 1 C (1 h charge) and 4 C (15 min charge), dP/|dQ| in the case of PCC remained in the region at or below the threshold (blue region), indicating that the anode has undergone a Li⁺ intercalation reaction (FIGS. 40A to 40C). However, when the charge rate was increased to 5 C or higher, the dP/|dQ| curve exceeded the threshold and entered the upper region (orange region) where Li⁰ is deposited, which indicated that Li⁰ was deposited. This phenomenon became remarkable at greater than or equal to 10 C (charge for 6 minutes). As illustrated in FIG. 22F, in the case of the PCC, the peak dP/|dQ| at less than or equal to 4 C remains in the Lit intercalation region. In contrast, in the case of the TCC (FIG. 22G), the event of Li⁰ precipitation at a charge rate of 3 C (20 min charge) began to occur much earlier. In the TCC cell, the maximum value of dP/| dQ| increased from 3 C to 6 C and then decreased from 8 C to 10 C, which is mainly due to the charging process proceeding directly to a CV step from 8 C to 10 C, and no CC part of the TCC cell was clearly observed at such high charge and discharge C-rates.

### Extension of PCC

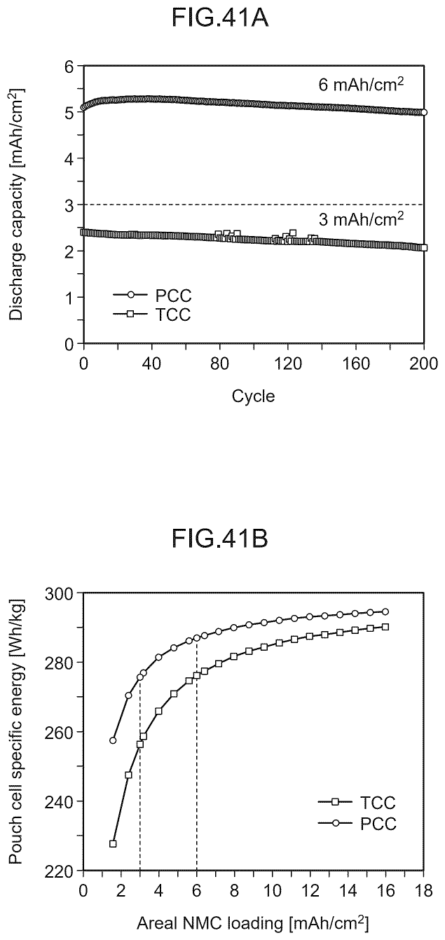

Even with quick charging, the PCC design also has great potential for enhancing the areal loading of the battery, resulting in higher battery energy without compromising rate performance. Notably, the PCC pouch cell shows stable cycling performance of 200 cycles at a charge and discharge rate of 1 C under high cathode (NMC) areal loading of 6 mAh cm⁻² (FIG. 40A). It is thus possible to achieve an energy density of about 287 Wh/kg while maintaining the theoretical charge rate of the battery (FIG. 41B).

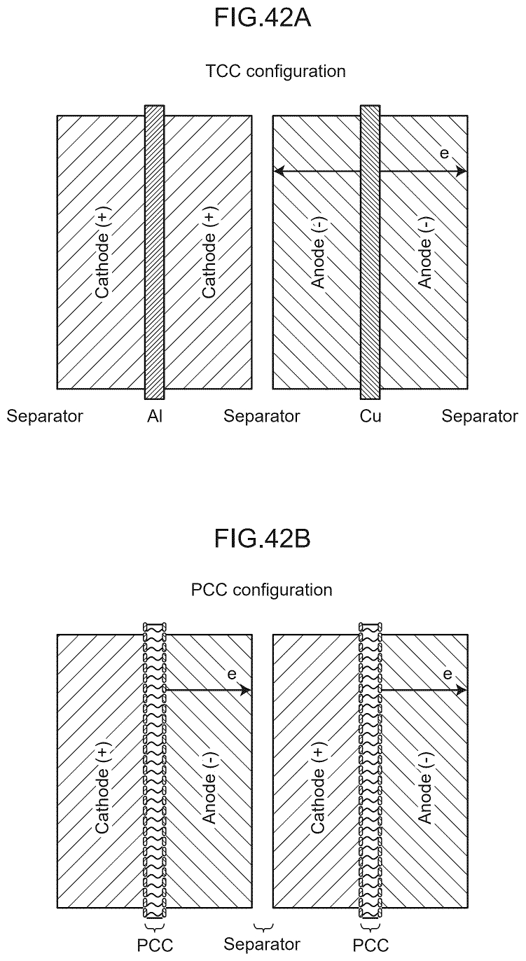

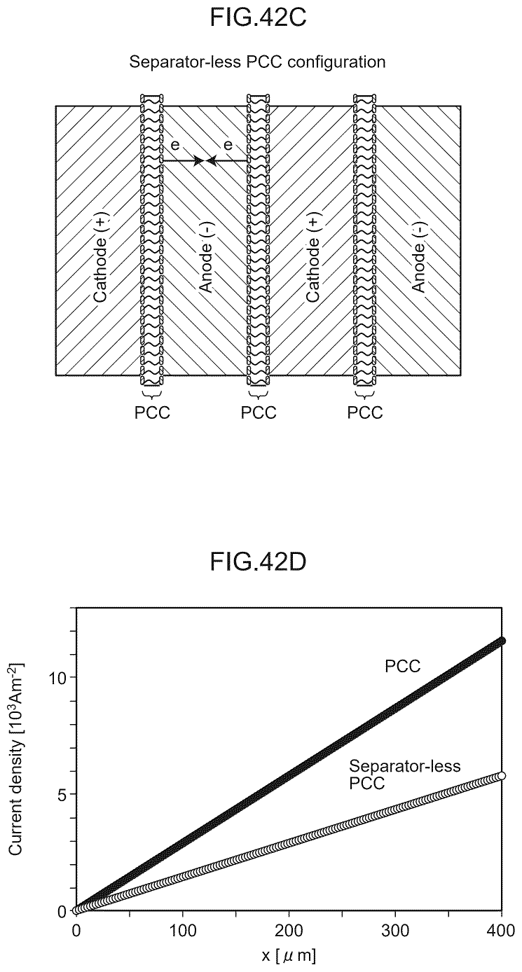

This innovative PCC design offers high energy density and high rate performance and indicates great potential to advance the design of energy storage devices. In the future, the rate performance of this design is expected to be further improved by adopting a tab-less design. By slightly modifying the method of electrode coating, this new battery design maintains maximum compatibility with existing battery manufacturing methods and facilitates the implementation of tab-less designs in the near future. In addition, by introducing PCC instead of the separator, it is made possible to alleviate local current concentration and to uniformize the reaction with the battery system (FIGS. 42A to 42D).

### SUMMARY

In summary, a porous current collector for high-energy and fast-charging batteries was first conceptualized. This design allows Li⁺ ions to the simultaneously pass through both the porous current collector and the separator, thereby reducing the effective Li⁺ transport path length to a half without compromising the electrode thickness. As a result, the diffusion limited C-rate of the high-energy battery can be quadrupled. This porous current collector is formed of a three-layer hierarchical porous polymer matrix which is coated with Cu or Al on either side. Experimental results demonstrated that the multilayer pouch cell including this porous current collector provides significant rate performance of 4 C (15 min charge, SOC of 0 to 78.3%), 6 C (10 min charge, SOC of 0 to 70.5%), and 10 C (6 min charge, SOC of 0 to 54.3%) while maintaining a high areal loading of 3 mAh/cm² and a specific energy of about 276 Wh/kg at all cell levels. In addition, this porous current collector design exhibits improved resistance to Li⁰ deposition up to 5 C, thereby increasing the reversibility and safety of lithium-ion batteries under quick charging. The advantages of porous current collecting devices can have a broad impact on the quick charging capability of next-generation energy storage devices.

### Manufacturing Method

### 1. Manufacturing of Porous Current Collector (PCC)

### 1.1 Manufacturing of Three-Layer and Hierarchical PCC Matrix

A bulletproof porous paper-like aramid film (Kevlar) having a thickness of 15 μm and a high nanosized porosity of 65% was used as the main substrate polymer of PCC. Based on the reverse phase separation, both sides of the Kevlar were coated with microporous polyimide (PI) having an adjustable pore diameter to form a PCC host. Specifically, a PI precursor was prepared on the basis of a pyromellitic dianhydride (PMDA) and 4,4′-oxydianiline (ODA) reaction. In practice, ODA and PMDA were added to dimethylformamide at a molar ratio of 1:1.02 under vigorous stirring. The above reaction was continued overnight to confirm complete polymerization. Subsequently, a separator of Kevlar was coated with the honey-like slurry, immersed in a mixed ethanol:H₂O solution at a volume ratio of 1:1, and then dried at room temperature overnight. Thereafter, the composite was imidized in a box furnace, and a PI-Kevlar film was formed using a step ramping program. Details of the step ramping program will be described in “Supplement to manufacturing method”.

### 1.2 Manufacturing of Alternative PCC Matrix

Poly(vinylidene-co-hexafluoropropene) (PVDF-HFP, weight average molecular weight of about 455000) was first dissolved in acetone (10 wt %), to which various water contents (0 wt %, 5 wt %, 10 wt %, and 15 wt %) were gradually added to prepare a mixed precursor solution. Then, the slurry was then applied to both sides of a commercially available separator or a Kevlar film at room temperature. The sample was used after drying at 60° C. for 2 days in a vacuum oven.

### 1.3 Manufacturing of PCC

The PCC host was pre-treated with O₂ plasma for 5 minutes to increase the surface adhesion of the metal coating. Porous conductive Cu and Al layers were each deposited on both sides of the porous polymer substrate by pulsed DC magnetron sputtering using argon as protective gas at a pressure less than or equal to 10⁶ Torr (1.3×10⁸ Pa).

### 2. Manufacturing Method of Electrode

Both cathode and anode composite electrodes were prepared by a slurry casting method using segregated carbon nanotube (CNT) dispersion (Tuball, OCSiAl) consisting of 0.4 wt % single wall carbon nanotube (SWCNT) and 2 wt % binder (polyvinylidene difluoride) in N-methyl-2-pyrrolidone, a battery active material (NMC or graphite), and carbon black (Timcal, C45 carbon).

For the anode, the CNT dispersion (including the binder) was mixed with graphite powder (Superior Graphite SLC1506T) and carbon black. Since a specific amount of binder is already contained in the CNT dispersion, no additional binder is required. The mass fraction of graphite:CNT:carbon black:binder in the obtained electrode was adjusted to 86%:2%:2%:10% by adjusting the mass ratio. For example, 25 ml of the CNT dispersion was mixed with 4.2 g of graphite, 100 mg of carbon black, and 400 mg of butyl benzyl phthalate (santicizer) to obtain an electrode having 2 mass % of CNT. Next, the slurry was cast on the PET side of a polyethylene terephthalate/aluminum (PET/Al) film. The electrode was then dried in an oven at 70° C. overnight, followed by vacuum drying at 60° C. for 2 days, and then dried in the oven at 120° C. overnight to remove residual solvent. By varying the interval of doctor blades, electrodes of various thicknesses can be obtained. The dried electrode can be peeled off from the PET/Al film by bending. A single electrode can be cut to a specific area size and disposed on the Cu foil (Cu of TCC) or on the Cu side of PCC to be calendared.

For the cathode, LiNi_{0.5}Mn_{0.3} Co_{0.2}O₂(NMC, Toda America, Inc.) was used for mixing with a CNT dispersion and carbon black. The mass fraction of the active material:CNT:carbon black:binder in the obtained electrode was adjusted to 92%:1%:2%:5%. For example, 25 ml of the CNT dispersion was mixed with 9.2 g of NMC, 300 mg of carbon black, and 400 mg of butyl benzyl phthalate (santicizer) to obtain an electrode containing 1.0 wt % of CNT. Next, the slurry was cast as an anode electrode on the PET side of the PET/Al film. The electrode can be peeled from the PET/Al film by bending and drying in the same manner as that for the anode. The single cathode electrode can be cut to a specific area size and disposed on the Al foil (Al of TCC) or the Al side of PCC to be calendared.

### Assembling Battery

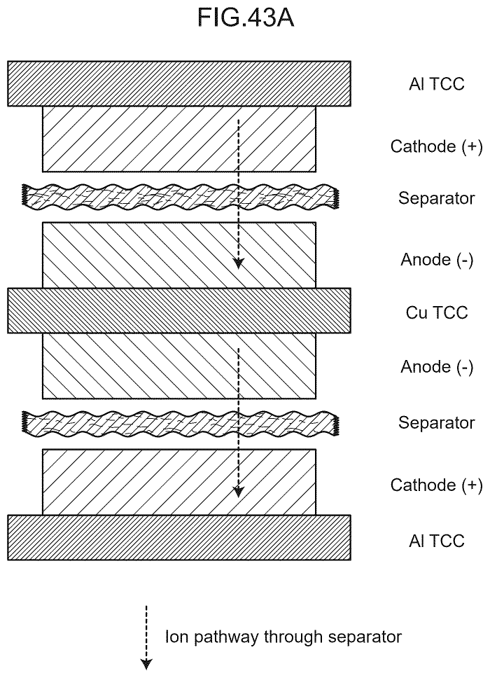

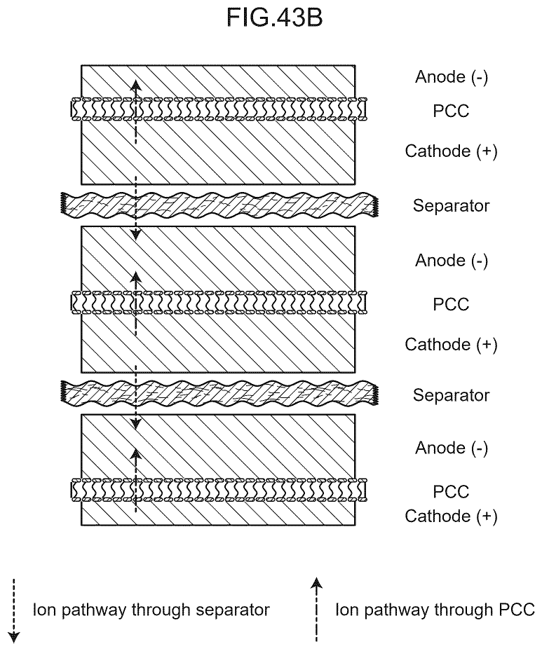

The NMC|graphite multilayer pouch cell was assembled with Cu|Al TCC and the PCC electrodes prepared in the above manner. As illustrated in FIG. 43B, the additional two end electrodes cooperate to balance the capacity of the PCC pouch battery. In the TCC pouch battery, all anode current collectors were connected to a nickel tab, and all cathode current collectors were connected to an Al tab. In the PCC pouch battery, all Cu metal sides of the PCC were connected to a strip of a Cu foil (1 cm wide) by a welder and then connected to a nickel tab, and all Al metal sides of the PCC were connected to a strip of an Al foil (1 cm wide) and then connected to an Al tab. Polypropylene-polyethylene-polypropylene (Celgard 2325) porous films were used as separators for both TCC and PCC pouch cells. Lithium hexafluorophosphate (LiPF₆) (1.2 mol/L) in ethylene carbonate/ethyl methyl carbonate (EC/EMC, weight ratio of 3:7) containing 2 wt % fluoroethylene carbonate (FEC, Sigma Aldrich) was used as an electrolyte for full cell measurement. The electrolyte usage of the pouch battery is 10 g/Ah. The total capacities of the pouch cells with TCC and PCC are adjusted to be the same. Thus, the dimensions of the TCC cathode, TCC anode, PCC cathode, and PCC anode are 1.3 inches×1.3 inches (3.3 cm×3.3 cm), 1.4 inches×1.4 inches (3.6 cm×3.6 cm), 1.15 inches×1.15 inches (2.9 cm×2.9 cm), and 1.25 inches×1.25 inches (3.2 cm×3.2 cm), respectively. The battery cycle was performed at a current up to 5 A. Both the TCC and PCC pouch batteries are first charged and discharged for two cycles by charging to 4.2 V and discharging to 3.0 V at a current density of 0.05 C. The pouch batteries were then charged at a constant current (up to 4.2 V), at a constant voltage (held at 4.2 V), in accordance with the charge rate (1 hour for 1 C, 30 minutes for 2 C, etc.), until the total charge time reaches a certain value, and then discharged at the same C-rate as 1 C. In the case of the high-speed charge and discharge protocol, the charging protocol is the same; however, the discharge rate is set to constant current discharge from 1 C to 10 C until the voltage reaches 3 V. A pause of 5 minutes is added at the end of each charging or discharging step.

### Operando Pressure Test

A wooden block larger than the cell center (length×width×height: 2 inches×2 inches×1 inch (5 cm×5 cm×2.5 cm)) was attached to the pouch cell as a force distribution plate. The multilayer pouch cell charged and discharged for two cycles was clamped by a vise together with a pressure measurement device (LBC-500, Transducer Techniques). Pressure data collection and battery cycles were initiated simultaneously after the mechanism was rested for 6 hours prior to testing.

### Numerical Modeling Simulation

The numerical model is constructed on the basis of the theory according to Ohm's law developed by Newman et al. (Doyle, M., Fuller, T. F. & Newman, J. J. Electrochem. Soc. 140, 1526 (1993).). Specifically, the charge balance in the electrode is represented by the following Equation (2-1).

$$∇ \cdot {i}_{c} = 0 \qquad ( 2 ‐ 1 )$$

Where i_{c} denotes the current density in the electrode defined by the Ohm's law, and is expressed by the following Equation (2-2).

$${i}_{c} = - {K}_{c} ∇ {ϕ}_{s} \qquad ( 2 ‐ 2 )$$

Where K_{c} denotes the electrical conductivity, and φₛ denotes the potential of the NMC cathode or graphite anode.

In order to calculate the solid diffusion of Lit in the active material particles (i.e. NMC and graphite) using Fick's laws of diffusion (Equations (2-3) below), a pseudo 2D (P2D) was used in the phase of a porous electrode.

$$\frac{\partial {C}_{s}}{\partial t} + ∇ \cdot {J}_{s} = 0 \qquad ( 2 ‐ 3 )$$

$${J}_{s} = - {D}_{s} ( ∇ {C}_{s} )$$

Where Jₛ denotes a Li⁺ flux in the active material particles, and Dₛ denotes a Li⁺ diffusion coefficient in the active material particles.

The theory of a concentrated electrolyte was used to describe charge balance and mass transport in the electrolyte. The charge balance in the electrolyte is expressed by the following Equation (2-4).

$$∇ \cdot {i}_{l} = 0 \qquad ( 2 ‐ 4 )$$

The current (iₗ) in the electrolyte is controlled by diffusion and transport of Lit, and can be described by the following Equation (2-5).

$${i}_{l} = ( - {K}_{l} ∇ {ϕ}_{l} ) + \frac{Z {K}_{l} RT}{F} ( 1 + \frac{\partial ln f}{\partial ln {C}_{l}} ) ( 1 - {t}_{+} ) ∇ ln {C}_{l} \qquad ( 2 ‐ 5 )$$

Where φₗ denotes the potential of the electrolyte, Kₗ denotes the ionic conductivity of the electrolyte, Cₗ denotes the Li⁺ concentration in the electrolyte, R denotes the gas constant, T denotes the temperature, F denotes the Faraday constant, t₊ denotes the transference number of Lit, and f denotes the average molar activity coefficient of the electrolyte. The Butler-Volmer equation (Equation (2-6) below) is used to describe the relationship between the charge transfer rate (i) and the overvoltage (η).

$$i = {i}_{0} ( exp ( \frac{{α}_{a} F η}{RT} ) - exp ( - \frac{{α}_{c} F η}{R T} ) ) \qquad ( 2 ‐ 6 )$$

Where αₐ denotes an anode charge transfer coefficient, α_{c} denotes a cathode charge transfer coefficient, i₀ denotes an exchange current density, and n denotes an overvoltage that drives a charge transfer reaction, which is defined by the following equation (2-7).

$$η = {ϕ}_{s} - {ϕ}_{l} - {ϕ}_{eq} \qquad ( 2 ‐ 7 )$$

Where φ_{eg} denotes an equilibrium potential of lithiation or delithiation of the NMC cathode and the graphite anode. The exchange current density i₀ is defined as follows.

$${i}_{0} = {F ( {k}_{c} )}^{{α}_{a}} {( {k}_{a} )}^{{α}_{c}} {( {C}_{s \_ max} - {C}_{s} )}^{{α}_{a}} {( {C}_{s} )}^{{α}_{c}} {( \frac{{C}_{l}}{{C}_{l \_ ref}} )}^{{α}_{a}} \qquad ( 2 ‐ 8 )$$

Where k_{c} denotes a rate constant of an anode reaction, k_{α} denotes a rate constant of a cathode reaction, Cₛ denotes a bulk Li⁺ concentration in the active material, C_{s_max} denotes the maximum Li⁺ concentration in the active material, and C_{l_ref} denotes a reference Li⁺ concentration in the electrolyte.

The mass transfer of Li⁺ in the electrolyte is defined as follows.

$$\frac{\partial {C}_{l}}{\partial t} + ∇ \cdot {J}_{l} = 0 \qquad ( 2 ‐ 9 )$$

$${J}_{l} = - {D}_{l} ∇ {C}_{l} + \frac{{i}_{l} {t}_{+}}{F}$$

Where Jₗ denotes a Li⁺ flux in the electrolyte, and Dₗ represents a Li⁺ diffusion coefficient in the electrolyte.

The effective charge and mass transfer properties in a porous electrode having a liquid electrolyte were corrected using the tortuosity τ and the porosity ε.

$${D}_{eff} = \frac{ε}{τ} {D}_{bulk} \qquad ( 2 ‐ 10 )$$

Where D_{eff} denotes the effective transport property (for example, Li ion diffusion coefficient or ion conductivity) and D_{bulk} denotes a bulk transport coefficient of the electrolytic solution.

All simulations were performed using modeling software (COMSOL Multiphysics (registered trademark)). For details of the modeling, refer to the prior work (Xu, R. et al. Journal of the Mechanics and Physics of Solids 129, 160-183 (2019).). Electrochemical parameters of the numerical model were set to be consistent with an experimental apparatus as shown in Table 2. In the simulation, two battery configurations of 6-layer battery with TCC and PCC were used. In the PCC configuration, six repeating units of separator/anode/PCC/cathode are assembled. The PCC unit was set as having the same porosity of 40% as that of the separator containing an electrolyte. For both TCC and PCC configurations, the cathode thickness was fixed at 70 μm with 3.0 mAh cm⁻² with an N/P ratio of 1.1. The simulation was performed with two area capacities of the cathode of 3.0 mAh cm⁻² and 9.0 mAh cm⁻². The N/P ratio was set to 1.1. The C-rate was calculated on the basis of the cathode area density. Other parameters such as the porosity, the transference number, the diffusion coefficient, and the tortuosity are shown in Table 2. In Table 2, the unit “1” represents a dimensionless number.

TABLE 2

| Parameter (unit) | Value | Parameter (unit) | Value |
|---|---|---|---|
| Electrical conductivity of | 10⁴ | Initial Li ion concentration in | 1000 |
| carbon binder matrix K_{c} (S · | | electrolyte C_{I}_{_{—}}ᵢₙᵢ (mol · m⁻³) | |
| m⁻¹) | | | |
| Electrical conductivity of | 1.147 | Max. Li concentration in NMC | 48700 |
| electrolyte K_{I} (S · m⁻¹) | | C_{NMC}_{_{—}}ₘₐₓ (mol · m⁻³) | |
| Transference number of cation | 0.363 | Max. Li concentration in | 31507 |
| t₊ (1) | | graphite C_{Gr}_{_{—}}ₘₐₓ (mol · m⁻³) | |
| Molar activity coefficient of | 0.43 | Porosity of NMC cathode ε_{NMC} | 0.36 |
| electrolyte ∂Inf/∂InC_{I} | | (1) | |
| Rate constant of cathode | 2 × 10⁻¹¹ | Porosity of graphite anode ε_{Gr} | 0.38 |
| reaction k_{c} (m/s) | | (1) | |
| Rate constant of anode | 2 × 10⁻¹¹ | Porosity of separator ε_{S} (1) | 0.4 |
| reaction kₐ (m/s) | | | |
| Cathode transport coefficient | 0.5 | Porosity of PCC ε_{PCC} (1) | 0.4 |
| a_{c} (1) | | | |
| Anode transport coefficient aₐ | 0.5 | Tortuosity of NMC cathode τ_{NMC} | 4 |
| (1) | | (1) | |
| Li ion diffusion coefficient in | 3.5 × | Tortuosity of graphite anode τ_{Gr} | 4 |
| electrolyte D_{I} (m² · s⁻¹) | 10⁻¹⁰ | (1) | |
| Li diffusion coefficient in NMC | 5 × 10⁻¹³ | Diameter of NMC particles d_{NMC} | 10 |
| D_{NMC} (m² · s⁻¹) | | (μm) | |
| Li diffusion coefficient in | 1.5 × | Diameter of graphite particles | 4 |
| graphite D_{Gr} (m² · s⁻¹) | 10⁻¹³ | d_{Gr} (μm) | |

### Resistance Simulation

Electric resistance was calculated using a 18650 type lithium-ion battery, which is a cylindrical lithium-ion battery, as a model. In the case of TCC, the width and the thickness of the current collector were 54 mm and 12 μm, respectively, for the cathode (Al) and 57 mm and 8 μm, respectively, for the anode (Cu). In the case of PCC, both the cathode and the anode were set to 1.5 μm thick. The measured values of electrical conductivity were 4.67×10⁷ S/m and 5.6×10⁷ S/m for the anode of PCC and TCC, respectively, and 3.14×10⁷ S/m and 3.77×10⁷ S/m for the cathode of PCC and TCC, respectively.

### Characterization of Material

The in-plane electrical conductivity of PCC and TCC was measured using the four-point probe method. Four parallel contact lines were deposited on the electrode surface using a silver conductive paste. The form and microstructure of samples were examined by a field emission type SEM (Apreo S LoVac Scanning Electron Microscope, manufactured by Thermo Fisher Scientific) in a high vacuum mode at an acceleration voltage of 5 keV. Mechanical measurements were performed on a single sample using an Instron 5565 tensile tester (100 N load cell) at a strain rate of 0.5 mm min⁻¹. Contact angle measurements were performed by a contact angle goniometer (Rame-Hart (registered trademark) 290). The ionic conductivity was measured with electrochemical impedance spectroscopy by an electrochemical measurement system (Biologics, VMP3) in a frequency range of 1 MHz to 100 mHz. Cyclic voltammetry was measured with an electrochemical measurement system (Biologic, VMP3) at a scan rate of 0.5 mV s⁻¹ and a voltage window of 0 V to 5 V. The porous current collector on the TCC was prepared with a UV laser cutter having a wavelength of 355 nm (Model 3530-30, built in a diode-pumped solid, Samurai marking System).

### Supplement to Manufacturing Method

The temperature ramping program for PI imidization was set as follows. (1) Ramp up from 25° C. to 100° C. at 3° C. min⁻¹. (2) Leave at 100° C. for 30 minutes. (3) Ramp up to 200° C. at 3° C. min⁻¹. (4) Leave at 200° C. for 30 minutes. (5) Ramp up to 300° C. at 3° C. min⁻¹. (6) Leave at 300° C. for 30 minutes. (7) Cool to room temperature in furnace.

### Supplemental Item 1: Model of Diffusion Limited C-Rate

The “diffusion-limited C-rate” (DLC) indicates a theoretical maximum charge rate when the Li⁺ concentration in the vicinity of the current collector decreases to 0 (Equation (3-1)).

$$DLC = \frac{2 zFD {ε}^{γ} {c}_{l , {i}^{+}}^{0}}{ωρ {Q}_{m} ( 1 - ε ) {L}^{2}} \qquad ( 3 ‐ 1 )$$

Where z, F, ε, γ, c_{Li}⁰, ω, ρ, Qₘ, and L denote the valence, the Faraday constant, the porosity, the tortuosity, the initial Li ion concentration in the electrolyte, the mass fraction of an active material, the apparent density of a composite material, the weight capacity of the active material, and the thickness of an electrode layer, respectively.

### Supplemental Item 2: Battery Weight Energy Density of TCC and PCC Pouch Battery

### Battery Information:

Total capacity: 3 Ah
Electrode size: 100 mm×50 mm
Al current collector: 12 μm (3.24 mg/cm²), Cu current collector: 8 μm (7.2 mg/cm²)
PCC: 25 μm (2.2 mg/cm²)
Separator size: 105 mm×55 mm, 0.5 mg/cm²
Pouch: 110 mm×60 mm, thickness 0.112 mm (18.04 mg/cm²)
NMC cathode (active material 92 wt %, 165 mAh/g_{NMC})
Graphite anode (active material 92 wt %, 300 mAh/g_{graphite})
N/P ratio=1.1, electrolytic solution: 1.2 g/Ah

$$Weight energy density at pouch cell level = battery capacity \times nominal voltage \div weight of pouch cell :$$

The case of TCC is as illustrated in the following Equation (3-2).

$$Gravimetric energy density ( TCC ) = \frac{3000 mAh \times 3.7 V}{\begin{matrix}W electrode + W electrolyte + W current \\ collector + W separator + W pouch\end{matrix}} = \frac{3000 mAh \times 3.7 V}{\begin{matrix}32.3 g + 3.6 g + W current \\ collector + W separator + 1.2 g\end{matrix}} = \frac{11100 mWh}{37.1 g + \frac{3}{x} \times 6.22 g} \qquad ( 3 ‐ 2 )$$

The case of PCC is as illustrated in the following Equation (3-3).

$$Gravimetric energy density ( PCC ) = \frac{3000 mAh \times 3.7 V}{\begin{matrix}W electrode + W electrolyte + W current \\ collector + W separator + W pouch\end{matrix}} = \frac{3000 mAh \times 3.7 V}{\begin{matrix}32.3 g + 3.6 g + W current \\ collector + W separator + 1.2 g\end{matrix}} = \frac{11100 mWh}{37.1 g + \frac{3}{2} \times 3.2 g} \qquad ( 3 ‐ 3 )$$

### Supplementary Drawings

FIG. 23A is a diagram illustrating lithium concentration distribution of NMC|graphite multilayer pouch batteries including TCC at a high NMC areal loading of 3 mAh/cm² and a N/P ratio of 1.1. FIG. 23B is a diagram illustrating lithium concentration distribution of NMC|graphite multilayer pouch batteries including PCC at a high NMC areal loading of 3 mAh/cm² and the N/P ratio of 1.1.

FIG. 24A is a diagram illustrating lithium concentration distribution of NMC|graphite multilayer pouch batteries including TCC at the high NMC areal loading of 9 mAh/cm² and the N/P ratio of 1.1. FIG. 24B is a diagram illustrating lithium concentration distribution of NMC|graphite multilayer pouch batteries including PCC at the high NMC areal loading of 9 mAh/cm² and the N/P ratio of 1.1. The simulation was performed at a charge rate of 1 C (1 h charge). By improving the areal loading, the percentage of “dead weight” in the battery can be reduced and the specific energy of the battery can be increased.

FIG. 25A is a diagram illustrating spatial distribution of the graphite anode potential by TCC at a charge rate of 4 C (15 minutes charge). FIG. 25B is a diagram illustrating spatial distribution of the graphite anode potential by PCC at the charge rate of 4 C (15 minutes charge). In the case of PCC, the lithium concentration distribution in the thickness direction of the graphite electrode was symmetric, whereas the lithium concentration distribution was asymmetric in the case of TCC. Lit transport in both directions in the case of PCC contributes to better uniformity of the anode potential than unidirectional Li⁺ transport in the case of TCC does.

FIGS. 26A and 26B are diagrams for explaining the electrochemical stability of the porous Kevlar (registered trademark) film in a battery. FIG. 26A is a diagram illustrating the chemical structure of the Kevlar film which is the middle layer of PCC. FIG. 26B is a graph illustrating curves of cyclic voltammogram (CV) for one cycle of Li|stainless steel batteries each having one of Celgrad 2325 and Kevlar.

Both curves show a low current response within a wide electrochemical potential window from 0 V to 5 V, which indicates that the Kevlar film has a great electrochemical stability. In addition, the cyclic voltammogram of the Li/stainless steel battery including Kevlar separators was compared to that including polyolefin separators (Celgard 2325). The polyolefin separators are known to have a high degree of saturation and high stability as a battery separator. The two batteries showed quite similar behaviors, which further demonstrated the stability of the Kevlar film in the battery.

FIG. 27A is a diagram illustrating an SEM image of a Celgard 2500 separator before being coated with Cu metal. FIG. 27B is a diagram illustrating an SEM image of the Celgard 2500 separator after being coated with Cu metal. Due to the need for a thick metallic coating, neither the battery separator (Celgard 2500) nor the Kevlar film can be used directly as a substrate for PCC, since their small pore structure (of several hundred nanometers or less) is completely blocked. Furthermore, the low affinity between the coating metal and polyethylene can lead to observable cracking. It is worth mentioning that the chemical bond between the coating metal and the substrate is important for improving the stability of PCC.

FIG. 28A is a diagram illustrating a cross-sectional SEM image of a PCC at a low magnification. FIG. 28B is a diagram illustrating a cross-sectional SEM image of the PCC at a high magnification.

FIGS. 29A to 29D are graphs illustrating lithium distribution in a PCC cell at different porosities.

The porosity of PCC plays an important role in various aspects of battery performance, such as electron conductivity, ion conductivity, mechanical stability, thermal behavior, and electrochemical performance (FIGS. 29A to 29D). In order to better understand the effect of porosity, a study was conducted in which the porosity of a PCC was changed from 0.2 to 0.8 to evaluate the influence on the Li concentration distribution in an electrode (FIGS. 29A to 29D). The distribution of the Li concentration in the electrode became further non-uniform due to a low porosity value (for example, 0.2). On the other hand, a high porosity (e.g., 0.8) did not significantly affect the Li concentration since the transport of Li within the porous electrode was a limiting factor in this situation.

FIG. 30 is a diagram illustrating the mechanical performance of a PCC tested with Instron 5565. The Young's modulus of the PCC was 35.3 GPa, which is comparable to those of current collectors of Al (about 70 GPa) and Cu (about 120 GPa). The bulletproof Kevlar film imparts strong mechanical properties to a PCC and provides sufficient strength in future roll-to-roll applications.

FIG. 31A is a diagram for explaining a four point probe method for measuring electron conductivity of the TCC and PCC. FIG. 31B is a diagram for explaining the four point probe method for measuring the electron conductivity of the TCC. FIG. 31C is a diagram for explaining the four point probe method for measuring the electron conductivity of the PCC. FIG. 31A is a circuit diagram illustrating the mechanism of a 4-terminal electron conductivity test. FIG. 31B is a digital image illustrating a Cu current collector of the TCC. FIG. 31C is a digital image illustrating the PCC. The colors are different depending on the difference in roughness between the solid Cu current collector and the PCC.

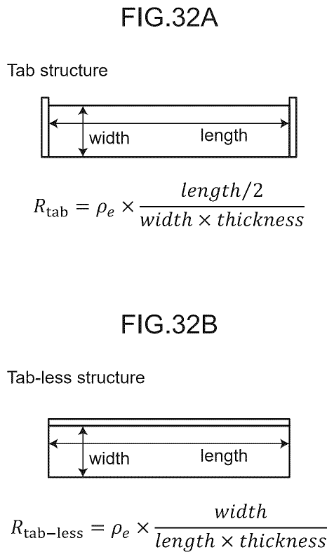

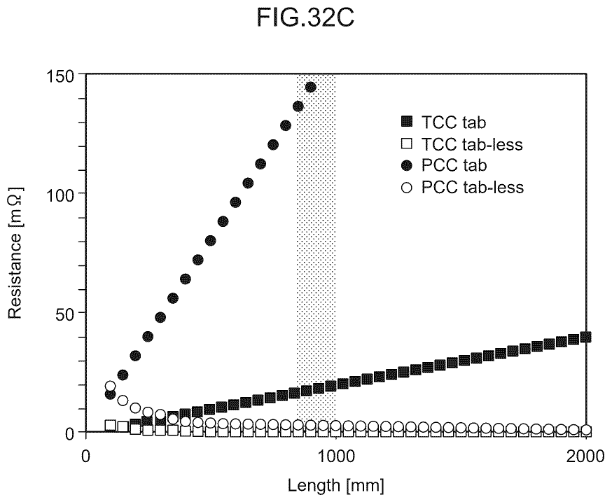

FIGS. 32A to 32C are diagrams for explaining batteries having different tab structures and their current collector resistances. FIG. 32A is a diagram illustrating a both-sided tab structure and a current collector resistance R_{tab} proportional to the length of the current collector. FIG. 32B is a diagram illustrating a tab-less structure and a current collector resistance R_{tab-less} inversely proportional to the length of the current collector. FIG. 32C is a graph illustrating the current collector resistance as a function of the length of the current collector.

The battery illustrated in FIG. 32A includes two metal tabs of positive and negative used to connect to ends of the electrodes. These tabs function as contact points for allowing a current to flow. However, this design makes the electron pathway longer. In contrast, the tab-less battery illustrated in FIG. 32B does not require these tabs. Instead, the electrodes are incorporated directly into the casing of the battery. Electrical connections in tab-less batteries are typically achieved by direct soldering or welding to the integrated electrodes. As a result, the electron pathway is significantly shortened. This reduction in the length of the electron pathway reduces the overall internal resistance of the battery and improves the electrical performance. As a result, as illustrated in FIG. 32C, it was possible to achieve a resistance of less than or equal to 10 mΩ in a practical range (18650 type LIB, 3 Ah, 800 mm to 1000 mm, shaded portion in FIG. 32C) of the current collector length by the PCC incorporating the tab-less structure.

FIG. 33 is a diagram for explaining the arrangement in a blocking cell for an ion conductivity test. Four types of separators of Celgard 2500, Celgard 2325, a PCC matrix, and a PCC were tested under the same conditions.

FIG. 34 is a diagram illustrating the wettability of the PCC with an electrolytic solution as compared with the wettability of Celgard 2325 by contact angle measurement. The contact angle (2°) of the electrolytic solution on the PCC was much smaller than the contact angle) (34°) on the Celgard 2325 separator, which indicates good electrolytic solution wettability of the PCC. The good wettability can increase the diffusion limited C-rate of the PCC pouch battery.

FIGS. 35A to 35E are diagrams illustrating alternative manufacturing of a three-layer polymer matrix as a candidate for the PCC host. FIG. 35A includes a schematic diagram (upper diagram in FIG. 35A) and a digital image (lower diagram in FIG. 35A) of a commercially available Celgard 2500 separator coated with poly(vinylidene fluoride-co-hexafluoropropylene) (PVDF-HFP). FIGS. 35B to 35E illustrate that the pore diameter can be adjusted to vary by adjusting the phase separation solvent concentration in the PVDF-HFP solution from 0 wt % to 15 wt %. PVDF-HFP can be dissolved in acetone, and different proportions of water were added to the slurry. The slurry was applied to the separator by a doctor blade method. Rapid evaporation of acetone prevents the precipitation of PVDF-HFP into the pores of the commercially available separator. Use of a commercially available separator has many advantages such as (1) low cost, (2) high resistance to internal short circuit, and (3) compatibility with current manufacturing steps.

FIG. 36 is a diagram illustrating stability of thick electrodes each using one of carbon black and a separated Tuball carbon nanotube mesh structure as a conductive additive. The Al side of each of a commercially available Al current collector and a PCC of a different thickness was coated with NMC slurry in N-methyl-2 pyrrolidone. All electrodes illustrated here are dry but not calendared.

FIGS. 37A to 37F are diagrams illustrating preparation of an electrode using Tuball carbon nanotubes. FIG. 37A illustrates that segregated tubular nanotubes can be easily obtained from a single electrode by coating an aluminum/polyethylene terephthalate (Al/PET) film with a carbon nanotube dispersion. FIG. 37B is a diagram illustrating a single NMC electrode added with 1 wt % Tuball carbon nanotubes. FIG. 37C is a diagram illustrating a bending test of the NMC electrode using Tuball carbon nanotubes. FIG. 37D illustrates an electrode that can be cut to a specific size for different purposes. FIGS. 37E and 37F are SEM images illustrating Tuball carbon nanotubes encapsulating NMC and graphite particles in the electrode. This contributes to obtaining high electrode stability and electron conductivity even at a high areal loading.

FIG. 38 is a diagram illustrating calendaring and alignment of an electrode to PCC. By optimizing the electrode slurry together with the segregated Tuball carbon nanotube mesh-shaped structure and coating the PET side of the PET/Al substrate, both NMC and the graphite anode can be easily exfoliated with the aid of the calendaring pressure and re-aligned to the PCC. The alignment of the electrodes to the TCC is also similar.

FIGS. 39A to 39C are diagrams illustrating differential pressure sensing indicating Li⁰ deposition during quick charging of the TCC. FIG. 39A is a diagram illustrating the configuration of operando pressure measurement for the multilayer pouch cell during ultrahigh-speed charging. FIGS. 39B and 39C are graphs illustrating a charge and discharge curve (FIG. 39B) and the pressure change (FIG. 39C) of the NMC/graphite multilayer pouch cell with TCC cycled at different charge and discharge C-rates. In the case of TCC, when the charge rate was greater than or equal to 5 C, a clear constant current portion was not observed in the charging process.

FIG. 40A is a graph illustrating the dP/|dQ| curve of a pouch battery having PCC at 4 C. FIG. 40B is a graph illustrating the dP/|dQ| curve of a pouch battery having PCC at 5 C. FIG. 40C is a graph illustrating the dP/|dQ| curve of a pouch battery having PCC at 10 C. The increase in the pressure per capacity caused by lithium deposition is much greater than the increase in the pressure induced by Li⁺ intercalation. The area above the dashed line represents that deposition of Li⁰ occurs during charging.

FIGS. 41A and 41B are graphs illustrating the electrochemical performance of batteries with PCC and TCC. FIG. 41A is a graph illustrating the cycle performance of pouch batteries with PCC and TCC at 1 C at different areal loadings. FIG. 41B is a graph illustrating the calculated weight energy density of large 3 Ah batteries with TCC and PCC. The battery information for calculation is described in Supplemental item 2.

FIG. 42A is a diagram illustrating the TCC cell configuration. FIG. 42B is a diagram for explaining the PCC cell configuration in a case where a separator is included. FIG. 42C is a diagram for explaining the PCC cell configuration without a separator. FIG. 42D is a graph for explaining that the PCC cell configuration without a separator has an effect of lowering the PCC current density. FIGS. 42A and 42B are diagrams illustrating a single-layer TCC (FIG. 42A) and the PCC cell configuration (FIG. 42B) and their current density distributions. FIG. 42C is a diagram illustrating the configuration of a single-layer separator-less PCC cell and its current density distribution on the PCC. FIG. 42D is a graph illustrating the current density profiles of the PCC and the separator-less PCC. The calculation conditions are the same as those illustrated in the center diagram of FIG. 23B, and are conditions of 3 mAh/cm², 4 C, and 3.8 V charging.

In the PCC cell, the TCC in FIG. 41A is replaced with the PCC in FIG. 42B. This design successfully reduced the effective lithium-ion path length to a half.

Furthermore, in a case where the separator of the PCC cell is replaced with a PCC, in particular the PCC of the PCC cell without a separator (FIG. 42C), the replaced PCC can function as an additional current collector layer. As a result, the pathway of electrons in the battery can be further shortened to a half, and the effective current density per unit area can be reduced (FIG. 42D).

FIG. 43A is a diagram illustrating the configuration of a multilayer pouch cell including TCC. FIG. 43B is a diagram illustrating the configuration of a multilayer pouch cell including PCC. The thickness of an end electrode of the PCC cell is set to be half of the thickness of the other electrode in order to prevent over-charge and/or over-discharge during battery cycles.

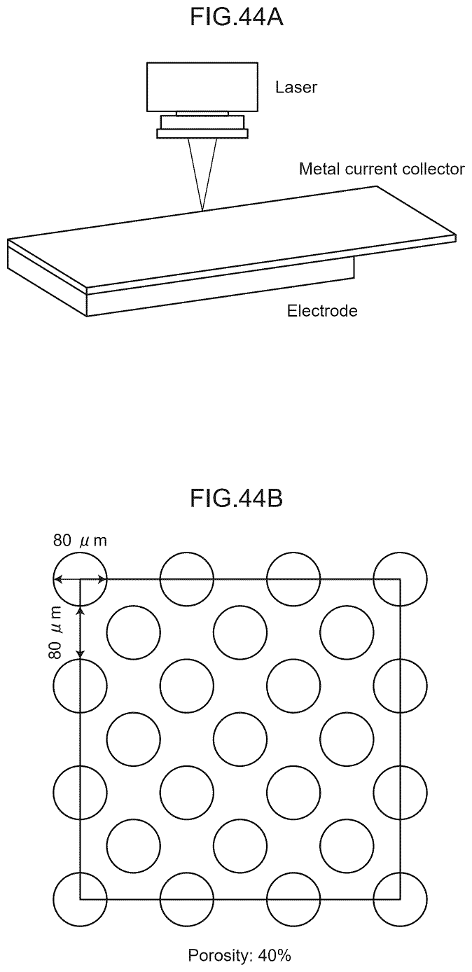

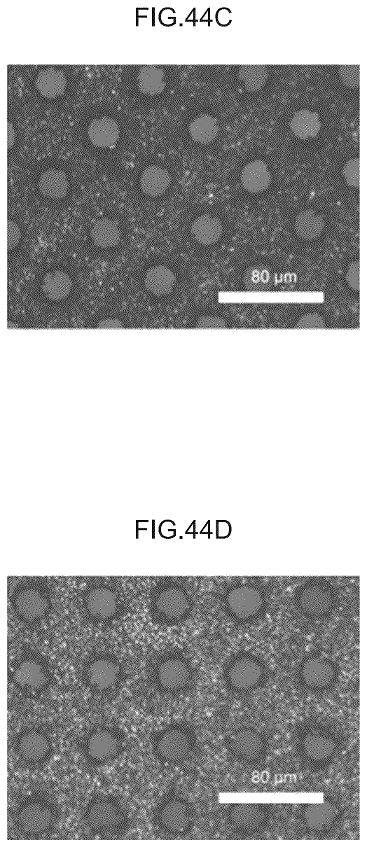

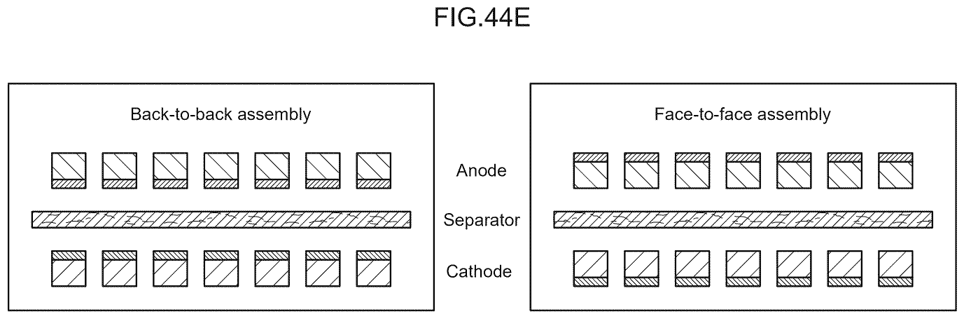

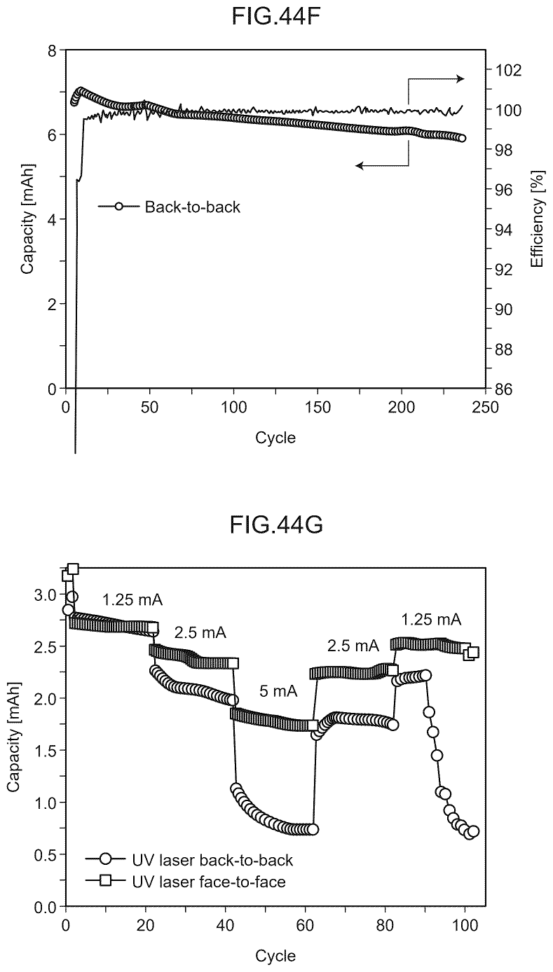

FIG. 44A is a diagram illustrating manufacturing of a proof-of-concept PCC prepared by UV laser cutting. FIGS. 44B to 44E are diagrams illustrating the proof-of-concept PCC prepared by UV laser cutting. FIGS. 44F to 44G are diagrams illustrating the performance of the proof-of-concept PCC prepared by UV laser cutting. FIG. 44A is a diagram illustrating a scheme in which a metal current collector is coated with a standard electrode and then cut by a diode-pumped solid state (DPSS) laser having an ultraviolet (UV) laser at a wavelength of 355 nm. FIG. 44B is a design pattern for electrode cutting illustrating a diameter and intervals of 80 μm and a porosity of 40%. FIGS. 44C and 44D are optical images illustrating the structure of an NMC cathode and a graphite anode after UV laser cutting. FIG. 44E illustrates assembly configurations of batteries to compare the effects of PCC and to verify the design concept of the porous current collector. FIG. 44F is a graph illustrating the cycle performance of the NMC|graphite cell assembled by the back-to-back method. FIG. 44G is a graph illustrating the rate performance of the NMC|graphite cells assembled by the back-to-back and face-to-face methods illustrated in FIG. 44E.

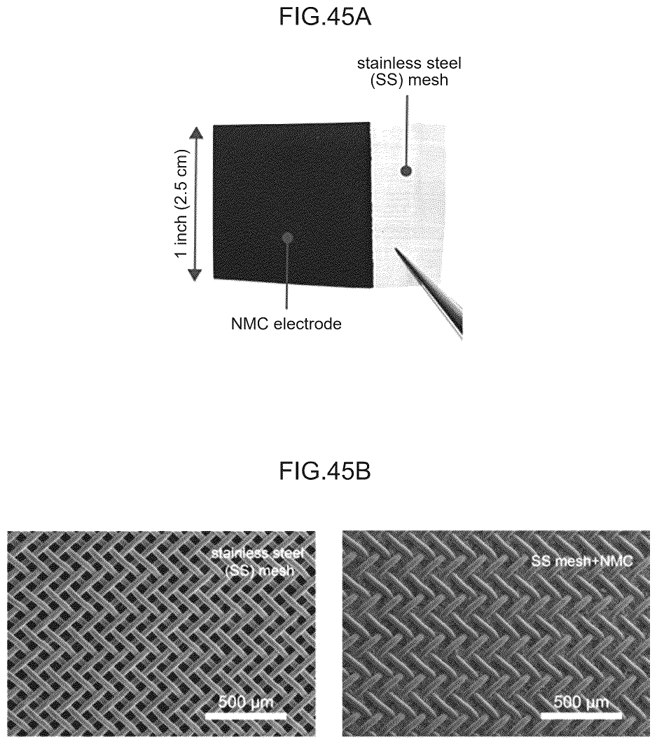

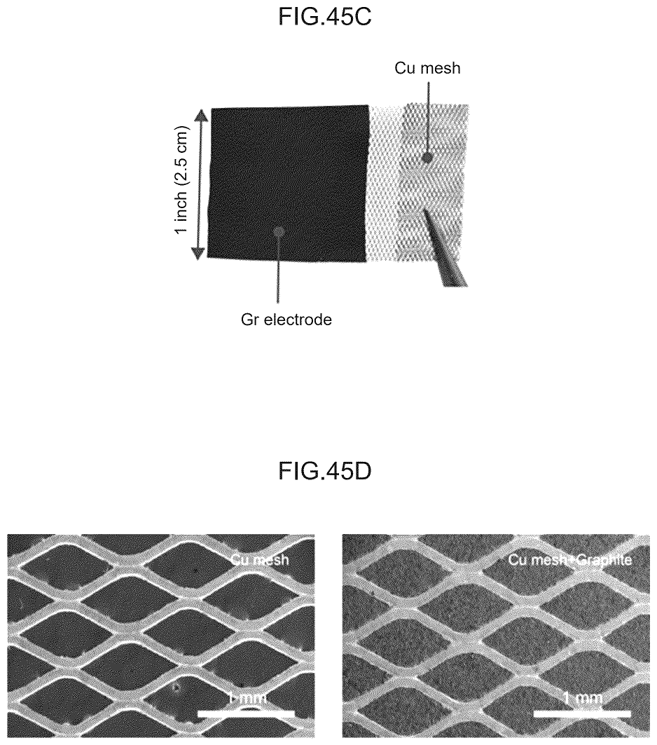

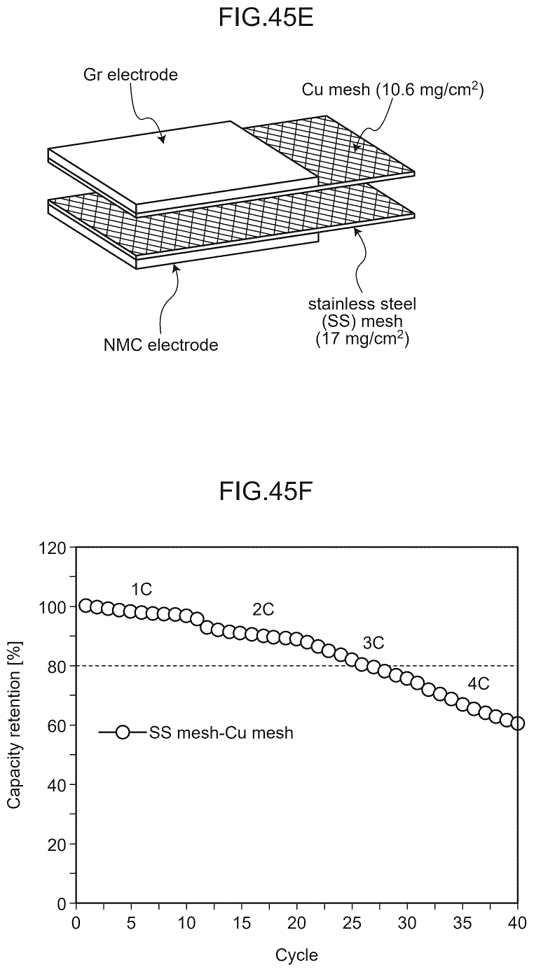

FIGS. 45A and 45B are diagrams illustrating a porous stainless-steel (SS) mesh. FIGS. 45C and 45D are diagrams illustrating a porous copper (Cu) mesh. FIG. 45E is a diagram illustrating a PCC design with a porous stainless-steel (SS) mesh and a porous copper (Cu) mesh. FIG. 45F is a graph illustrating verification of the PCC design by the porous stainless-steel (SS) mesh and the porous copper (Cu) mesh. FIG. 45A is a digital image of an NMC cathode calendared on the porous SS mesh. FIG. 45B is an SEM image illustrating the form of the porous SS mesh before and after calendaring with an NMC electrode. FIG. 45C is a digital image of a graphite (Gr) anode calendared on a porous Cu mesh. FIG. 45D is an SEM image illustrating the form of the porous Cu mesh before and after calendaring with a graphite electrode. FIG. 45E is a diagram illustrating a full cell scheme of NMC/graphite (Gr) with a PCC based on the back-to-back assembling method, and FIG. 45F is a graph illustrating the full cell rate performance of NMC/graphite with the PCC based on the back-to-back assembling method.

In order to verify the feasibility of PCC through experiments, a PCC for ion shunting was prepared using the laser-induced current collector (FIGS. 44A to 44G) and the porous metal mesh (FIGS. 45A to 45F). The porous current collector includes two layers of metal mesh on both sides and a central layer of non-conductive porous polymer.

The above content is intended to facilitate understanding of the present disclosure, and is not intended to interpret the present disclosure in a limiting manner. The present disclosure can be modified and/or improved without departing therefrom, and the present disclosure includes equivalents thereof.

In addition, the present disclosure can adopt the following aspects and including as described herein according to an embodiment.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A current collector assembly comprising:
an insulating film having a first main surface and a second main surface on an opposite side to the first main surface;
a cathode current collector provided on the first main surface; and
an anode current collector provided on the second main surface, wherein
the insulating film, the cathode current collector, and the anode current collector are porous bodies.

2. The current collector assembly according to claim 1, wherein
an average pore diameter of the cathode current collector is within a range of 10 nm to 50 μm, and
an average pore diameter of the anode current collector is within the range of 10 nm to 50 μm.

3. The current collector assembly according to claim 1, wherein
an average pore diameter of the insulating film is within the range of 10 nm to 50 μm.

4. The current collector assembly according to claim 1, wherein
the insulating film includes at least one of polyolefin, polyimide, polyamide, polyester, cellulose, glass, or a metal oxide.

5. The current collector assembly according to claim 1, wherein
the cathode current collector includes a cathode porous body and a cathode conductive layer provided on surfaces of pores of the cathode porous body, and
the anode current collector includes an anode porous body and an anode conductive layer provided on surfaces of pores of the anode porous body.

6. The current collector assembly according to claim 5, wherein
a thickness of the cathode conductive layer is within a range of 100 nm to 10 μm, and
a thickness of the anode conductive layer is within a range of 100 nm to 10 μm.

7. The current collector assembly according to claim 5, wherein
the cathode porous body includes at least one of polyolefin, polyimide, polyamide, polyester, cellulose, glass, or a metal oxide, and
the anode porous body includes at least one of polyolefin, polyimide, polyamide, polyester, cellulose, glass, or a metal oxide.

8. The current collector assembly according to claim 5, wherein
the cathode porous body and the anode porous body includes polyimide, and
the insulating film includes aramid.

9. The current collector assembly according to claim 5, wherein
a thickness of the cathode conductive layer is within a range of 1 μm to 2 μm
a thickness of the anode conductive layer is within a range of 1 μm to 2 μm, and
a thickness of the insulating film is within a range of 10 μm to 20 μm.

10. The current collector assembly according to claim 1, wherein
a tortuosity is more than 1.

11. The current collector assembly according to claim 5, wherein
a porosity of the insulating film is within a range of 40% to 70%, and
an average pore diameter of the insulating film is within a range of 10 nm to 50 μm.

12. A secondary battery comprising:
an insulating film having a first main surface and a second main surface on an opposite side to the first main surface;
a cathode provided on the first main surface; and
an anode provided on the second main surface, wherein
the cathode includes a cathode current collector and a cathode active material layer,
the anode includes an anode current collector and an anode active material layer,
the insulating film is a porous body, and
the cathode current collector and the anode current collector are porous bodies or porous plates.

13. The secondary battery according to claim 12, wherein
the cathode current collector is a porous body provided on the first main surface, the cathode current collector having a cathode porous body and a cathode conductive layer provided on surfaces of pores of the cathode porous body, and
the anode current collector is a porous body provided on the second main surface, the anode current collector having an anode porous body and an anode conductive layer provided on surfaces of pores of the anode porous body.

14. The secondary battery according to claim 13, further comprising:
a plurality of current collector assemblies each including the insulating film, the cathode current collector provided on the first main surface, and the anode current collector provided on the second main surface; and
a separator, wherein
the separator is stacked between the cathode active material layer provided on a first current collector assembly and the anode active material layer provided on a second current collector assembly.

15. The secondary battery according to claim 13, further comprising:
a plurality of current collector assemblies each including the insulating film, the cathode current collector provided on the first main surface, and the anode current collector provided on the second main surface, wherein
a first current collector assembly and a second current collector assembly of the plurality of current collector assemblies are stacked with the cathode active material layer or the anode active material layer interposed between the first current collector assembly and the second current collector assembly.

16. The secondary battery according to claim 13, further comprising:
the electrolytic solution filled in pores in the porous body, wherein
a thickness of the cathode conductive layer is equal to or less than ⅕ times a thickness of the cathode active material layer, and
a thickness of the anode conductive layer is equal to or less than ⅕ times a thickness of the anode active material layer.

17. The secondary battery according to claim 12, wherein
the cathode current collector is a porous plate provided on the insulating film side of the cathode active material layer, and
the anode current collector is a porous plate provided on the insulating film side of the anode active material layer.

18. The secondary battery according to claim 12, wherein
a thickness of the cathode active material layer is within a range of 60 μm to 80 μm.

19. The secondary battery according to claim 12, wherein
a ratio of the capacity of the anode to the capacity of the cathode is 1.1.

20. a method of manufacturing of a secondary battery comprising:
coating a microporous polyimide by a reverse phase separation on both sides of an insulating film which is a bulletproof porous paper-like aramid film to form a cathode porous body and a anode porous body,
depositing a porous cathode conductive layer on the cathode porous body and depositing a porous anode conductive layer on the anode porous body by sputtering to form a cathode current collector and a anode current collector, and
forming a cathode active material layer on the cathode current collector and forming a anode active material layer on the anode current collector by a slurry casting method.
